(19) United States
(12) Patent Application Publication
(10) Pub. No.: US 2024/0386716 A1
(43) Pub. Date: Nov. 21, 2024

(54) TECHNIQUES FOR DETECTING TEXT

(71) Applicant: Apple Inc., Cupertino, CA (US)

(72) Inventors: Allison LETTIERE, San Francisco, CA (US); Christopher B. FLEIZACH, Gilroy, CA (US); Darren C. MINIFIE, Santa Cruz, CA (US); Bianca J. YACOUB, Mountain View, CA (US); Nandini KANNAMANGALAM SUNDARA RAMAN, Sunnyvale, CA (US); Elizabeth A. OTTENS, San Francisco, CA (US); Giuseppe PARZIALE, Cupertino, CA (US)

(21) Appl. No.: 18/596,510

(22) Filed: Mar. 5, 2024

Related U.S. Application Data
(60) Provisional application No. 63/466,715, filed on May 15, 2023.

(51) Int. Cl. G06V 10/94; G06F 3/01; G06F 3/0483; G06F 3/04842; G06F 3/0488; G06F 3/16; G06V 20/62

(52) U.S. Cl. CPC G06V 10/945; G06F 3/0483; G06F 3/04842; G06F 3/0488; G06V 20/62; G06F 3/016; G06F 3/167

(57) ABSTRACT

The present disclosure generally relates to detecting text. The present disclosure describes at least methods for managing a text detection mode, identifying targeted text, and managing modes of a computer system.

### CROSS-REFERENCE TO RELATED APPLICATIONS

The present application claims priority to and/or benefit of U.S. Provisional Patent Application Ser. No. 63/466,715, entitled “TECHNIQUES FOR DETECTING TEXT” filed May 15, 2023, which is hereby incorporated by reference in its entirety for all purposes.

### FIELD

The present disclosure relates generally to computer user interfaces, and more specifically to techniques for detecting text.

### BACKGROUND

Computer systems often provide targeted outputs. Such outputs can indicate the state of the computer systems and/or indicate a state of an environment that surrounds the computer system.

### SUMMARY

Some techniques for detecting text using computer systems, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides computer systems with faster, more efficient methods and interfaces for detecting text. Such methods and interfaces optionally complement or replace other methods for detecting text. Such methods and interfaces reduce the cognitive burden on a user and produce a more efficient human-machine interface. For battery-operated computing devices, such methods and interfaces conserve power and increase the time between battery charges.

In some examples, a method that is performed at a computer system that is in communication with one or more output devices is described. In some examples, the method comprises: while detecting image data that includes a first portion of text and a second portion of text, detecting a first input at a respective location; and in response to detecting the first input at the respective location: in accordance with a determination that the computer system is in a first state, providing, via the one or more output devices, first output corresponding to the first portion of text without providing first output corresponding to the second portion of text; and in accordance with a determination that the computer system is in a second state different from the first state, providing, via the one or more output devices, the first output corresponding to the second portion of text without providing the first output corresponding to the first portion of text.

In some examples, a non-transitory computer-readable storage medium storing one or more programs configured to be executed by one or more processors of a computer system that is in communication with one or more output devices is described. In some examples, the one or more programs includes instructions for: while detecting image data that includes a first portion of text and a second portion of text, detecting a first input at a respective location; and in response to detecting the first input at the respective location: in accordance with a determination that the computer system is in a first state, providing, via the one or more output devices, first output corresponding to the first portion of text without providing first output corresponding to the second portion of text; and in accordance with a determination that the computer system is in a second state different from the first state, providing, via the one or more output devices, the first output corresponding to the second portion of text without providing the first output corresponding to the first portion of text.

In some examples, a transitory computer-readable storage medium storing one or more programs configured to be executed by one or more processors of a computer system that is in communication with one or more output devices is described. In some examples, the one or more programs includes instructions for: while detecting image data that includes a first portion of text and a second portion of text, detecting a first input at a respective location; and in response to detecting the first input at the respective location: in accordance with a determination that the computer system is in a first state, providing, via the one or more output devices, first output corresponding to the first portion of text without providing first output corresponding to the second portion of text; and in accordance with a determination that the computer system is in a second state different from the first state, providing, via the one or more output devices, the first output corresponding to the second portion of text without providing the first output corresponding to the first portion of text.

In some examples, a computer system that is in communication with one or more output devices is described. In some examples, the computer system that is in communication with one or more output devices comprises one or more processors and memory storing one or more program configured to be executed by the one or more processors. In some examples, the one or more programs includes instructions for: while detecting image data that includes a first portion of text and a second portion of text, detecting a first input at a respective location; and in response to detecting the first input at the respective location: in accordance with a determination that the computer system is in a first state, providing, via the one or more output devices, first output corresponding to the first portion of text without providing first output corresponding to the second portion of text; and in accordance with a determination that the computer system is in a second state different from the first state, providing, via the one or more output devices, the first output corresponding to the second portion of text without providing the first output corresponding to the first portion of text.

In some examples, a computer system that is in communication with one or more output devices is described. In some examples, the computer system that is in communication with one or more output devices comprises means for performing each of the following steps: while detecting image data that includes a first portion of text and a second portion of text, detecting a first input at a respective location; and in response to detecting the first input at the respective location: in accordance with a determination that the computer system is in a first state, providing, via the one or more output devices, first output corresponding to the first portion of text without providing first output corresponding to the second portion of text; and in accordance with a determination that the computer system is in a second state different from the first state, providing, via the one or more output devices, the first output corresponding to the second portion of text without providing the first output corresponding to the first portion of text.

In some examples, a computer program product is described. In some examples, the computer program product comprises one or more programs configured to be executed by one or more processors of a computer system that is in communication with one or more output devices. In some examples, the one or more programs include instructions for: while detecting image data that includes a first portion of text and a second portion of text, detecting a first input at a respective location; and in response to detecting the first input at the respective location: in accordance with a determination that the computer system is in a first state, providing, via the one or more output devices, first output corresponding to the first portion of text without providing first output corresponding to the second portion of text; and in accordance with a determination that the computer system is in a second state different from the first state, providing, via the one or more output devices, the first output corresponding to the second portion of text without providing the first output corresponding to the first portion of text.

In some examples, a method that is performed at a computer system that is in communication with one or more output devices is described. In some examples, the method comprises: while detecting image data that includes text, detecting an object relative to the text; and in response to detecting the object relative to text: in accordance with a determination that that the object is in a first position relative to the text and the computer system is in a first state, providing, via the one or more output devices, an output corresponding to the text; in accordance with a determination that the object is in a second position relative to the text and the computer system is in the first state, forgoing providing, via the one or more output devices, the output corresponding to the text; and in accordance with a determination that the object is in the second position relative to the text and the computer system is in a second state different from the first state, providing, via the one or more output devices, the output corresponding to the text.

In some examples, a non-transitory computer-readable storage medium storing one or more programs configured to be executed by one or more processors of a computer system that is in communication with one or more output devices is described. In some examples, the one or more programs includes instructions for: while detecting image data that includes text, detecting an object relative to the text; and in response to detecting the object relative to text: in accordance with a determination that that the object is in a first position relative to the text and the computer system is in a first state, providing, via the one or more output devices, an output corresponding to the text; in accordance with a determination that the object is in a second position relative to the text and the computer system is in the first state, forgoing providing, via the one or more output devices, the output corresponding to the text; and in accordance with a determination that the object is in the second position relative to the text and the computer system is in a second state different from the first state, providing, via the one or more output devices, the output corresponding to the text.

In some examples, a transitory computer-readable storage medium storing one or more programs configured to be executed by one or more processors of a computer system that is in communication with one or more output devices is described. In some examples, the one or more programs includes instructions for: while detecting image data that includes text, detecting an object relative to the text; and in response to detecting the object relative to text: in accordance with a determination that that the object is in a first position relative to the text and the computer system is in a first state, providing, via the one or more output devices, an output corresponding to the text; in accordance with a determination that the object is in a second position relative to the text and the computer system is in the first state, forgoing providing, via the one or more output devices, the output corresponding to the text; and in accordance with a determination that the object is in the second position relative to the text and the computer system is in a second state different from the first state, providing, via the one or more output devices, the output corresponding to the text.

In some examples, a computer system that is in communication with one or more output devices is described. In some examples, the computer system that is in communication with one or more output devices comprises one or more processors and memory storing one or more program configured to be executed by the one or more processors. In some examples, the one or more programs includes instructions for: while detecting image data that includes text, detecting an object relative to the text; and in response to detecting the object relative to text: in accordance with a determination that that the object is in a first position relative to the text and the computer system is in a first state, providing, via the one or more output devices, an output corresponding to the text; in accordance with a determination that the object is in a second position relative to the text and the computer system is in the first state, forgoing providing, via the one or more output devices, the output corresponding to the text; and in accordance with a determination that the object is in the second position relative to the text and the computer system is in a second state different from the first state, providing, via the one or more output devices, the output corresponding to the text.

In some examples, a computer system that is in communication with one or more output devices is described. In some examples, the computer system that is in communication with one or more output devices comprises means for performing each of the following steps: while detecting image data that includes text, detecting an object relative to the text; and in response to detecting the object relative to text: in accordance with a determination that that the object is in a first position relative to the text and the computer system is in a first state, providing, via the one or more output devices, an output corresponding to the text; in accordance with a determination that the object is in a second position relative to the text and the computer system is in the first state, forgoing providing, via the one or more output devices, the output corresponding to the text; and in accordance with a determination that the object is in the second position relative to the text and the computer system is in a second state different from the first state, providing, via the one or more output devices, the output corresponding to the text.

In some examples, a computer program product is described. In some examples, the computer program product comprises one or more programs configured to be executed by one or more processors of a computer system that is in communication with one or more output devices. In some examples, the one or more programs include instructions for: while detecting image data that includes text, detecting an object relative to the text; and in response to detecting the object relative to text: in accordance with a determination that that the object is in a first position relative to the text and the computer system is in a first state, providing, via the one or more output devices, an output corresponding to the text; in accordance with a determination that the object is in a second position relative to the text and the computer system is in the first state, forgoing providing, via the one or more output devices, the output corresponding to the text; and in accordance with a determination that the object is in the second position relative to the text and the computer system is in a second state different from the first state, providing, via the one or more output devices, the output corresponding to the text.

In some examples, a method that is performed at a computer system that is in communication with one or more cameras and one or more output devices is described. In some examples, the method comprises: detecting, via the one or more output devices, a first input relative to a first portion of text in the field of view of the one or more cameras; in response to detecting the first input relative to the portion of text in the field of view of the one or more cameras, providing, via the one or more output devices, an output corresponding to the first portion of text; while providing the output corresponding to the first portion of text, detecting, via the one or more output devices, a second input; and in response to detecting the second input: in accordance with a determination that a set of one or more lock criteria was satisfied before detecting the second input and after detecting the first input, continuing to provide the output; and in accordance with a determination that the set of one or more lock criteria was not satisfied before detecting the second input and after detecting the first input, ceasing to provide the output.

In some examples, a non-transitory computer-readable storage medium storing one or more programs configured to be executed by one or more processors of a computer system that is in communication with one or more cameras and one or more output devices is described. In some examples, the one or more programs includes instructions for: detecting, via the one or more output devices, a first input relative to a first portion of text in the field of view of the one or more cameras; in response to detecting the first input relative to the portion of text in the field of view of the one or more cameras, providing, via the one or more output devices, an output corresponding to the first portion of text; while providing the output corresponding to the first portion of text, detecting, via the one or more output devices, a second input; and in response to detecting the second input: in accordance with a determination that a set of one or more lock criteria was satisfied before detecting the second input and after detecting the first input, continuing to provide the output; and in accordance with a determination that the set of one or more lock criteria was not satisfied before detecting the second input and after detecting the first input, ceasing to provide the output.

In some examples, a transitory computer-readable storage medium storing one or more programs configured to be executed by one or more processors of a computer system that is in communication with one or more cameras and one or more output devices is described. In some examples, the one or more programs includes instructions for: detecting, via the one or more output devices, a first input relative to a first portion of text in the field of view of the one or more cameras; in response to detecting the first input relative to the portion of text in the field of view of the one or more cameras, providing, via the one or more output devices, an output corresponding to the first portion of text; while providing the output corresponding to the first portion of text, detecting, via the one or more output devices, a second input; and in response to detecting the second input: in accordance with a determination that a set of one or more lock criteria was satisfied before detecting the second input and after detecting the first input, continuing to provide the output; and in accordance with a determination that the set of one or more lock criteria was not satisfied before detecting the second input and after detecting the first input, ceasing to provide the output.

In some examples, a computer system that is in communication with one or more cameras and one or more output devices is described. In some examples, the computer system that is in communication with one or more cameras and one or more output devices comprises one or more processors and memory storing one or more program configured to be executed by the one or more processors. In some examples, the one or more programs includes instructions for: detecting, via the one or more output devices, a first input relative to a first portion of text in the field of view of the one or more cameras; in response to detecting the first input relative to the portion of text in the field of view of the one or more cameras, providing, via the one or more output devices, an output corresponding to the first portion of text; while providing the output corresponding to the first portion of text, detecting, via the one or more output devices, a second input; and in response to detecting the second input: in accordance with a determination that a set of one or more lock criteria was satisfied before detecting the second input and after detecting the first input, continuing to provide the output; and in accordance with a determination that the set of one or more lock criteria was not satisfied before detecting the second input and after detecting the first input, ceasing to provide the output.

In some examples, a computer system that is in communication with one or more cameras and one or more output devices is described. In some examples, the computer system that is in communication with one or more cameras and one or more output devices comprises means for performing each of the following steps: detecting, via the one or more output devices, a first input relative to a first portion of text in the field of view of the one or more cameras; in response to detecting the first input relative to the portion of text in the field of view of the one or more cameras, providing, via the one or more output devices, an output corresponding to the first portion of text; while providing the output corresponding to the first portion of text, detecting, via the one or more output devices, a second input; and in response to detecting the second input: in accordance with a determination that a set of one or more lock criteria was satisfied before detecting the second input and after detecting the first input, continuing to provide the output; and in accordance with a determination that the set of one or more lock criteria was not satisfied before detecting the second input and after detecting the first input, ceasing to provide the output.

In some examples, a computer program product is described. In some examples, the computer program product comprises one or more programs configured to be executed by one or more processors of a computer system that is in communication with one or more cameras and one or more output devices. In some examples, the one or more programs include instructions for: detecting, via the one or more output devices, a first input relative to a first portion of text in the field of view of the one or more cameras; in response to detecting the first input relative to the portion of text in the field of view of the one or more cameras, providing, via the one or more output devices, an output corresponding to the first portion of text; while providing the output corresponding to the first portion of text, detecting, via the one or more output devices, a second input; and in response to detecting the second input: in accordance with a determination that a set of one or more lock criteria was satisfied before detecting the second input and after detecting the first input, continuing to provide the output; and in accordance with a determination that the set of one or more lock criteria was not satisfied before detecting the second input and after detecting the first input, ceasing to provide the output.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for detecting text, thereby increasing the effectiveness, efficiency, and user satisfaction with such devices. Such methods and interfaces may complement or replace other methods for detecting text.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some examples.

FIG. 1B is a block diagram illustrating exemplary components for event handling in accordance with some examples.

FIG. 2 illustrates a portable multifunction device having a touch screen in accordance with some examples.

FIG. 3 is a block diagram of an exemplary multifunction device with a display and a touch-sensitive surface in accordance with some examples.

FIG. 4A illustrates an exemplary user interface for a menu of applications on a portable multifunction device in accordance with some examples.

FIG. 4B illustrates an exemplary user interface for a multifunction device with a touch-sensitive surface that is separate from the display in accordance with some examples.

FIG. 5A illustrates a personal electronic device in accordance with some examples.

FIG. 5B is a block diagram illustrating a personal electronic device in accordance with some examples.

FIGS. 6A-6T illustrate exemplary user interfaces for managing a text detection mode in accordance with some examples.

FIG. 7 is a flow diagram illustrating a method for managing a text detection mode in accordance with some examples.

FIGS. 8A-8R illustrate exemplary user interfaces for identifying targeted text in accordance with some examples.

FIG. 9 is a flow diagram illustrating a method for identifying targeted text in accordance with some examples.

FIG. 10 is a flow diagram illustrating a method for managing modes of a computer system in accordance with some examples.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for detecting text. For example, text can be detected via the detection of an object (e.g., a hand of a user and/or a stylus). Further, targeted text can be identified as targeted text via the detection of an object. Additionally, a computer system can activate and/or deactivate certain text detection modes in response to detecting an input. Such techniques can reduce the cognitive burden on a user who reads and evaluates portions of text, thereby enhancing productivity. Further, such techniques can reduce processor and battery power otherwise wasted on redundant user inputs.

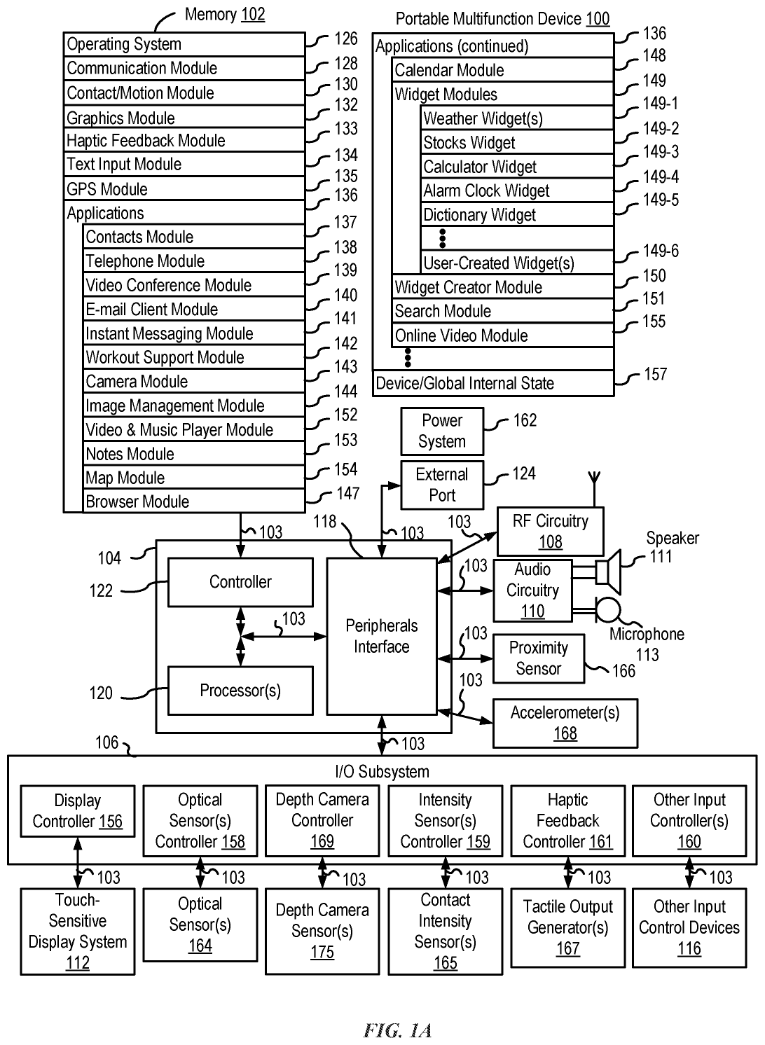

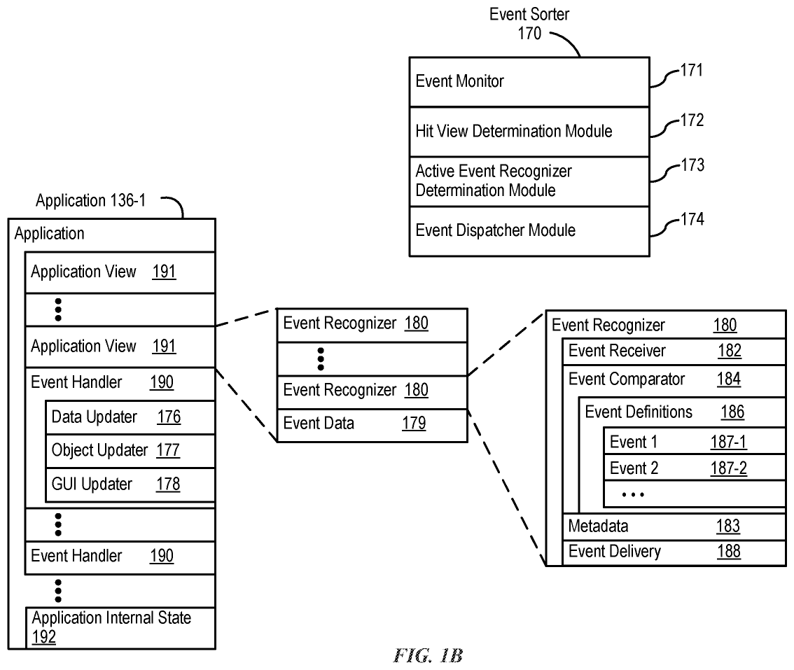

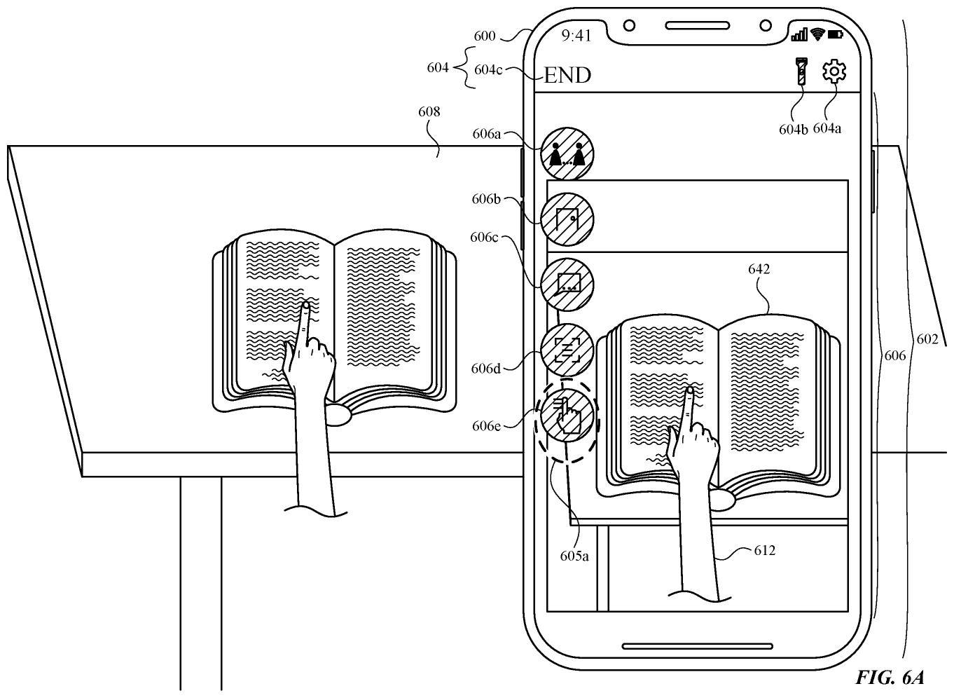

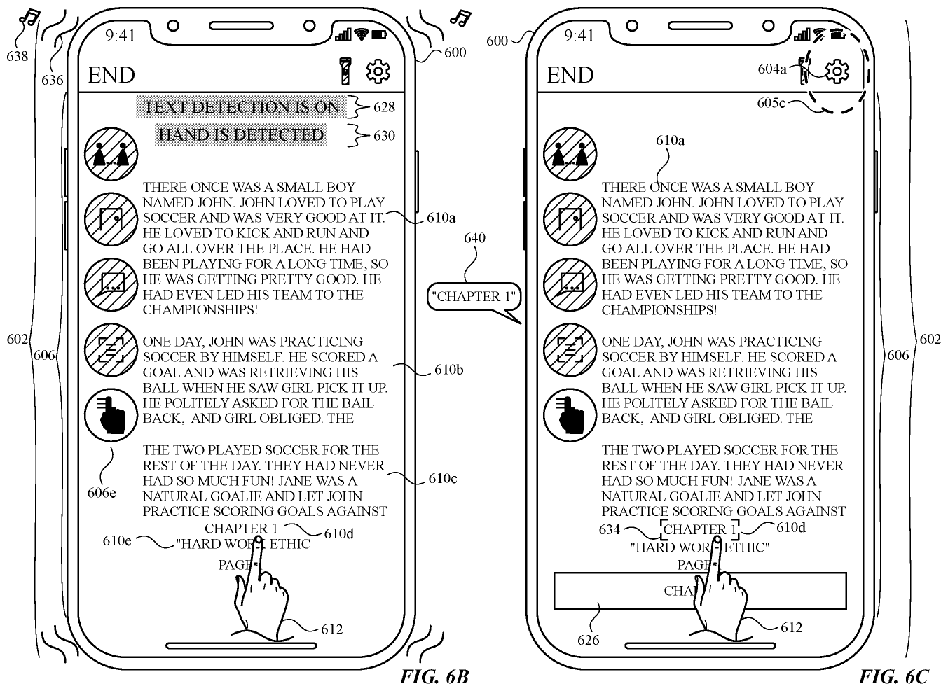

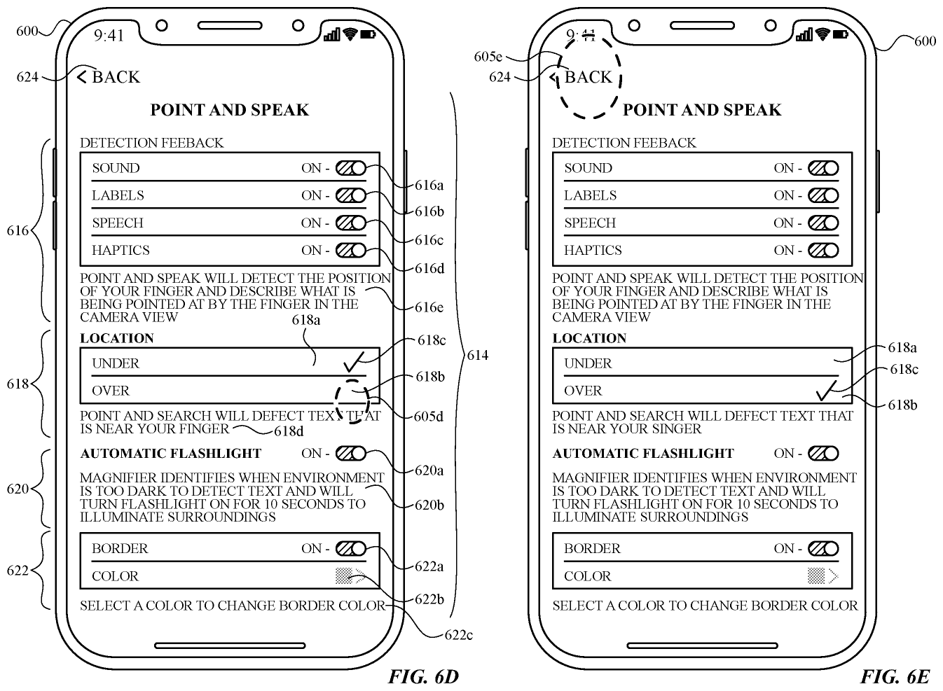

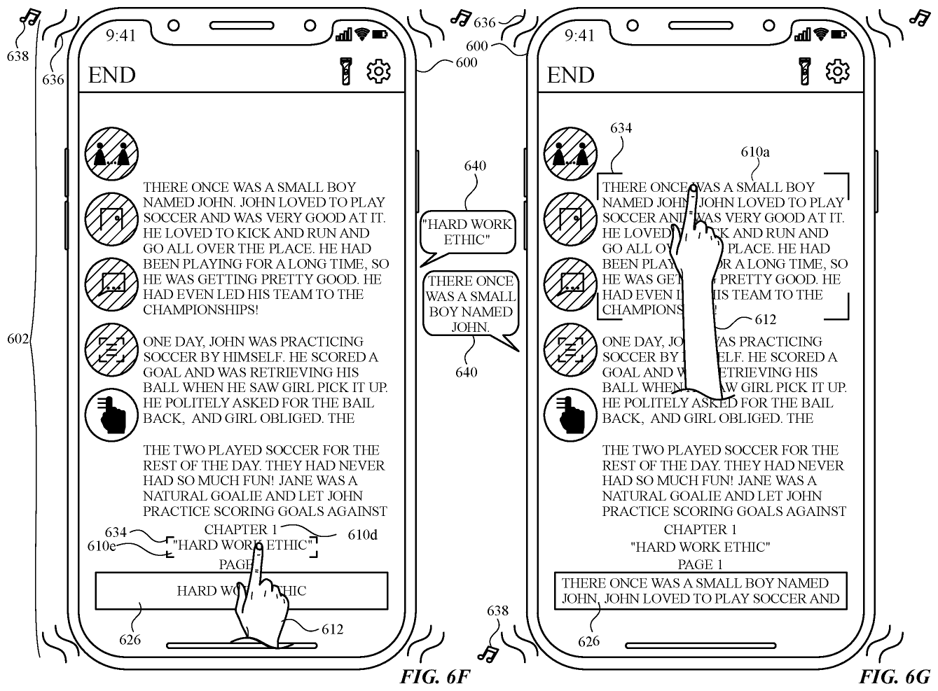

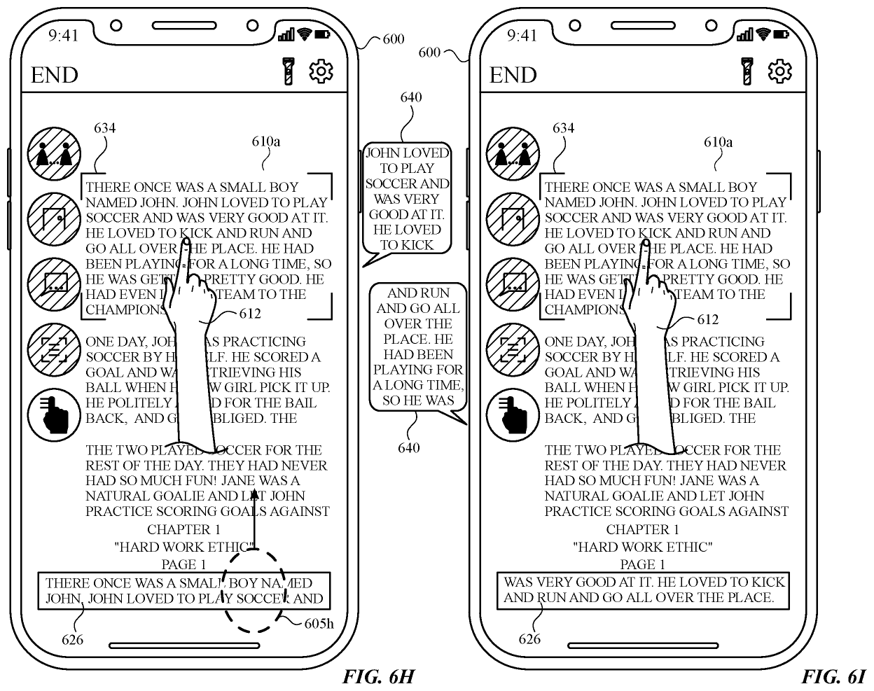

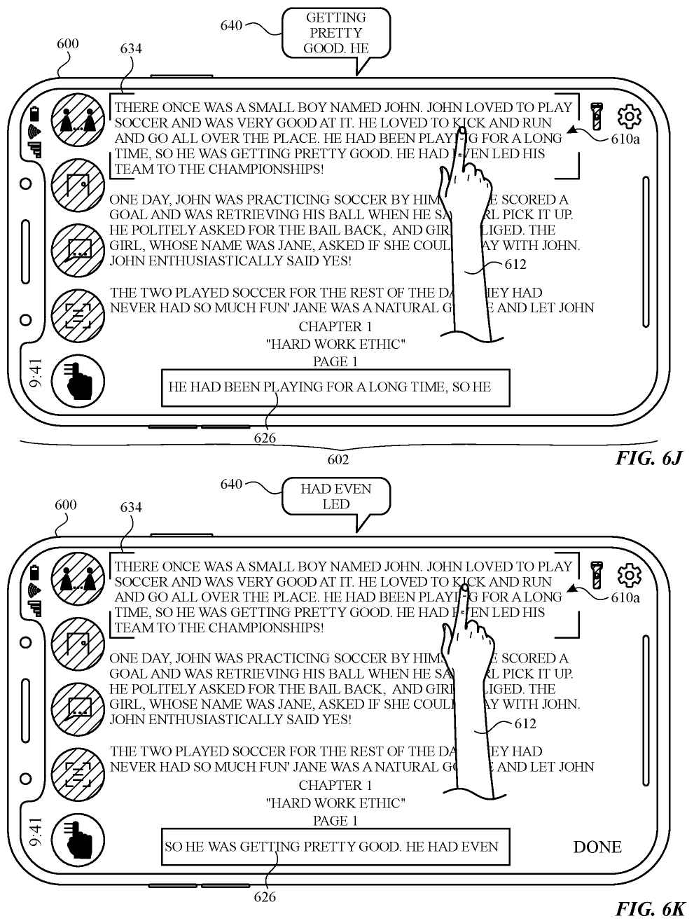

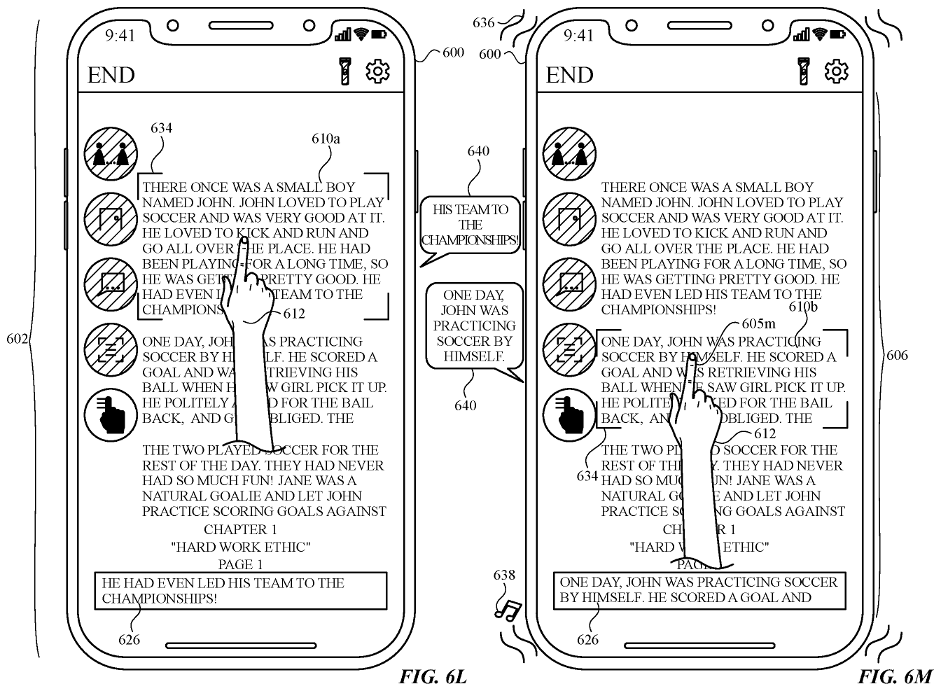

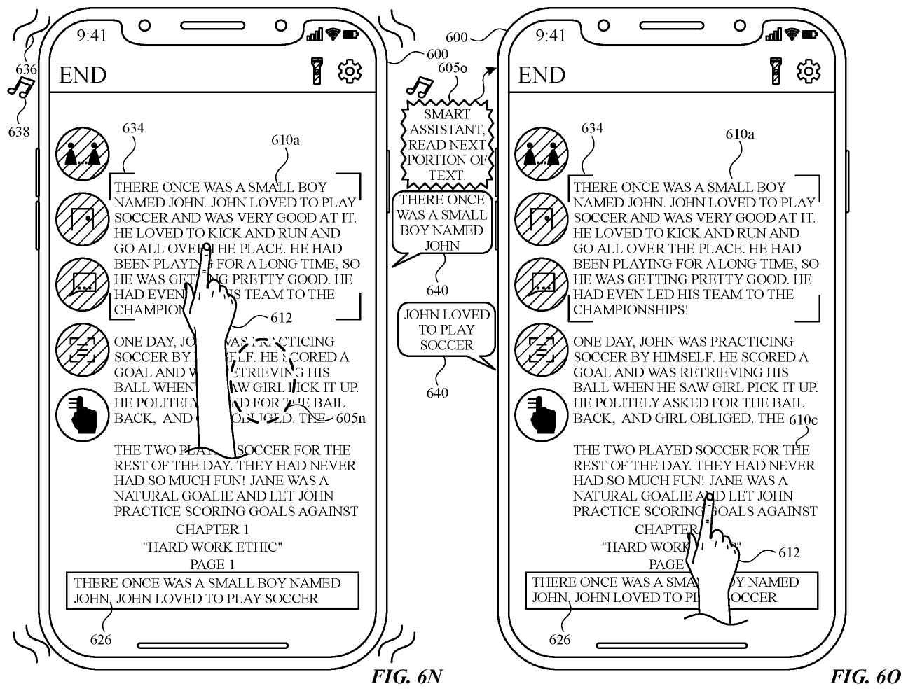

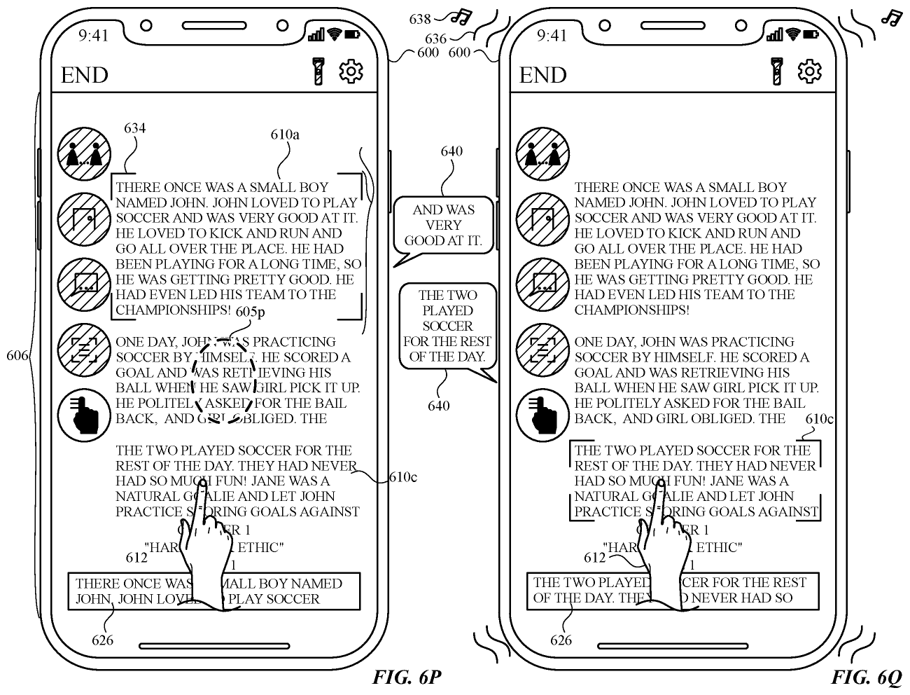

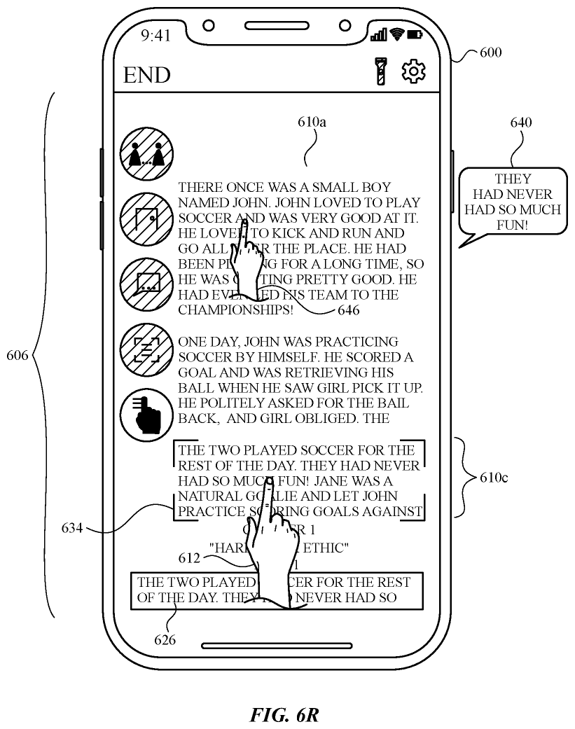

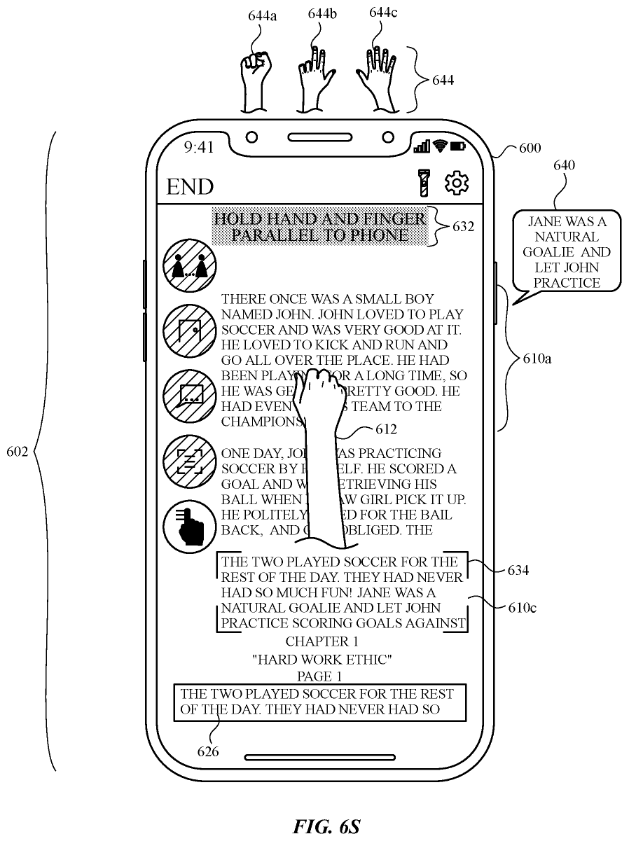

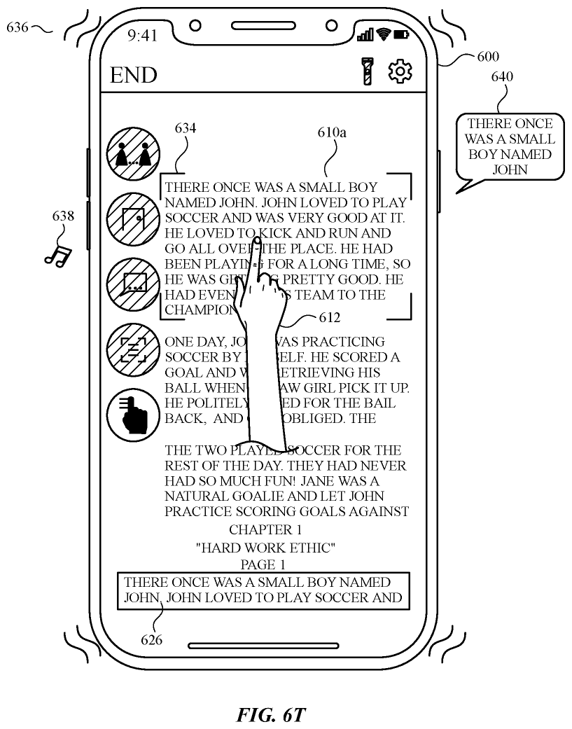

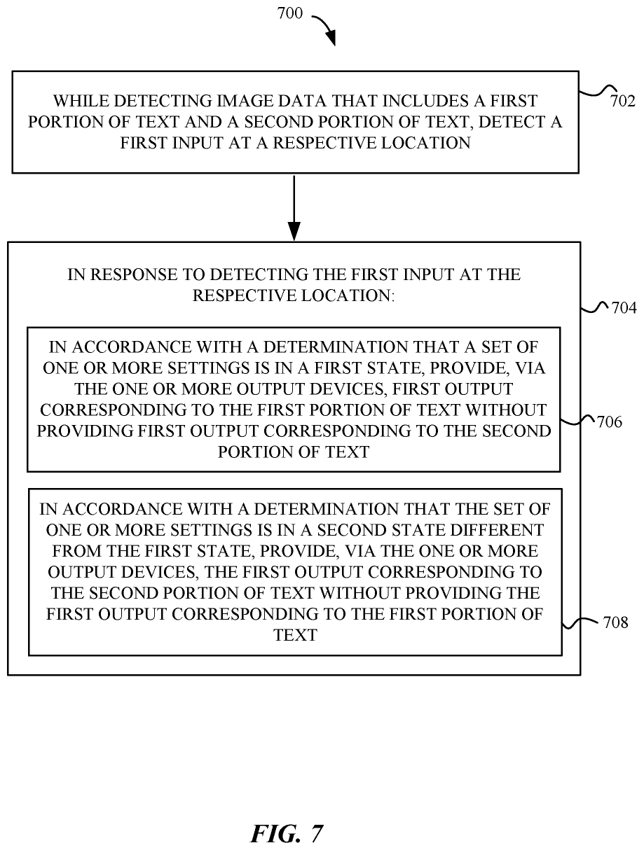

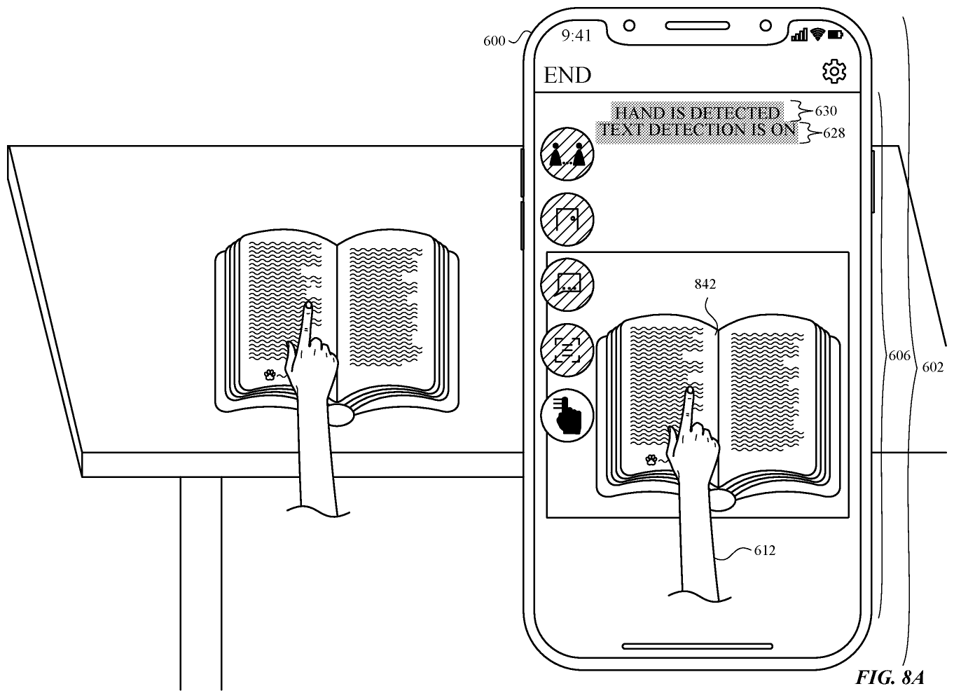

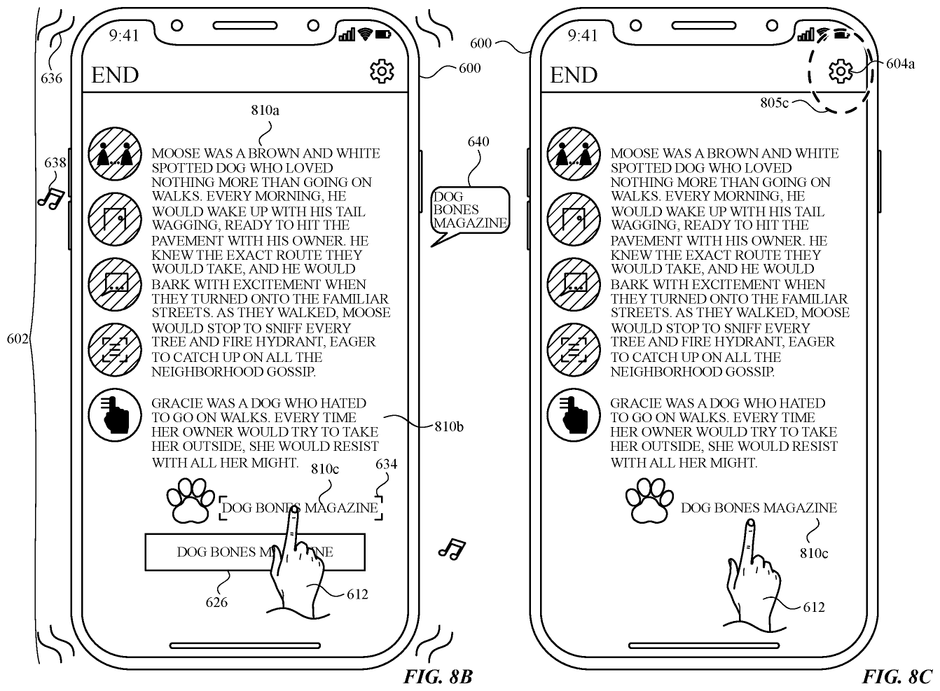

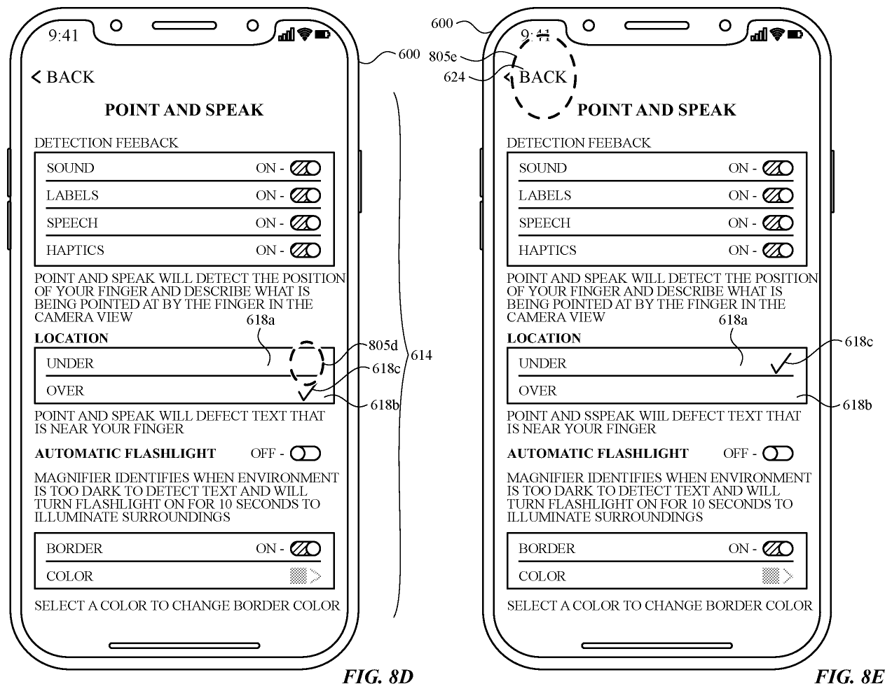

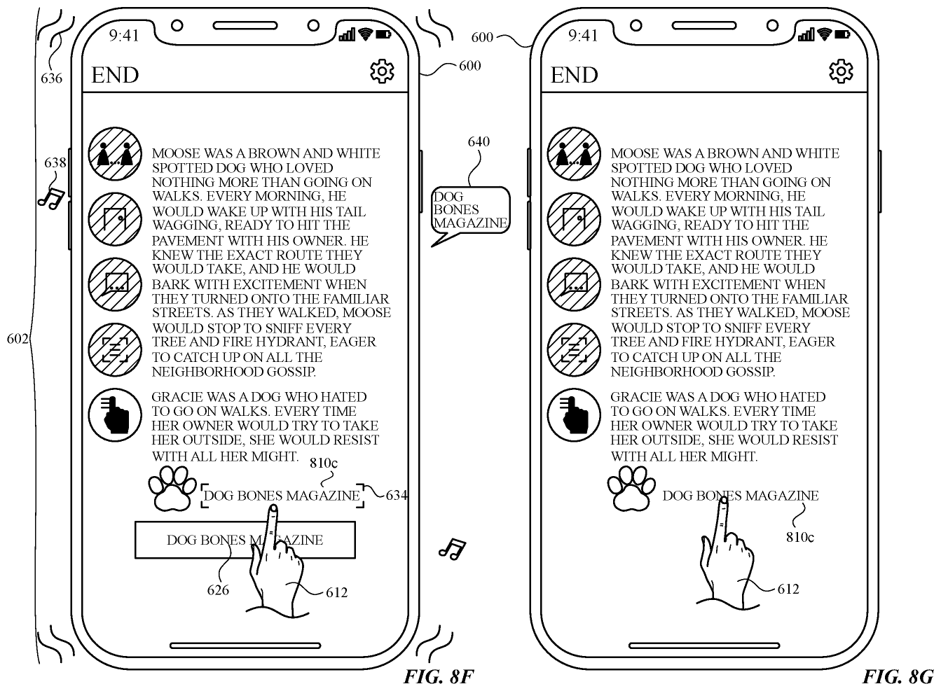

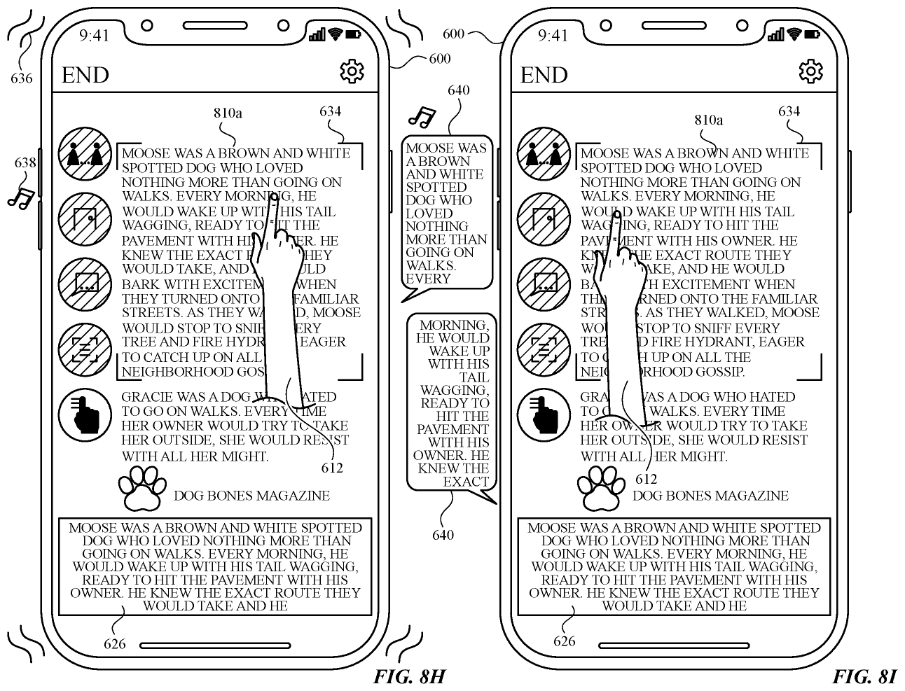

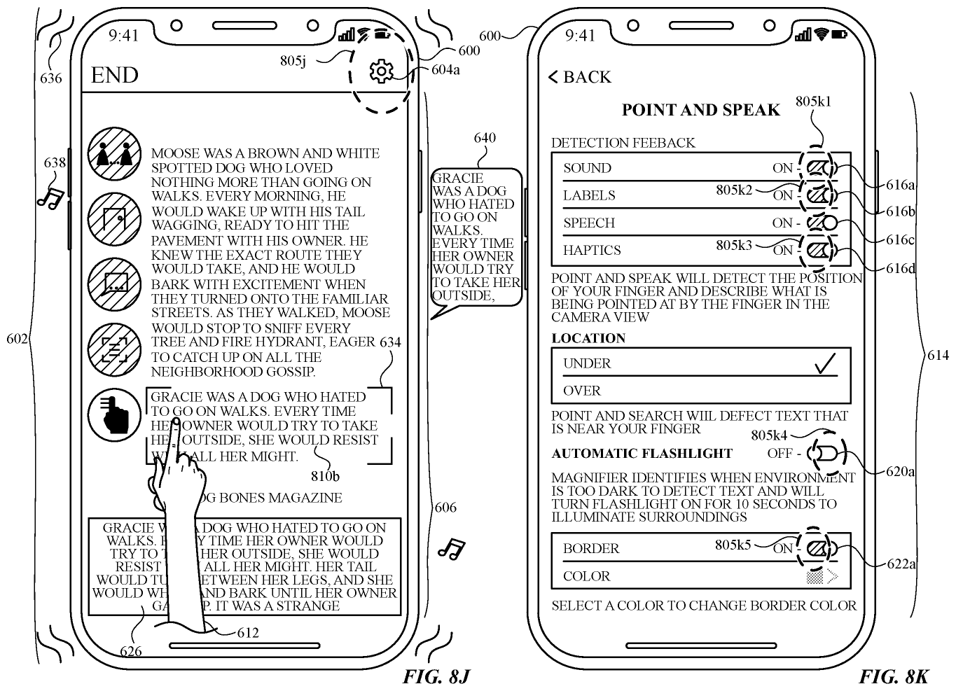

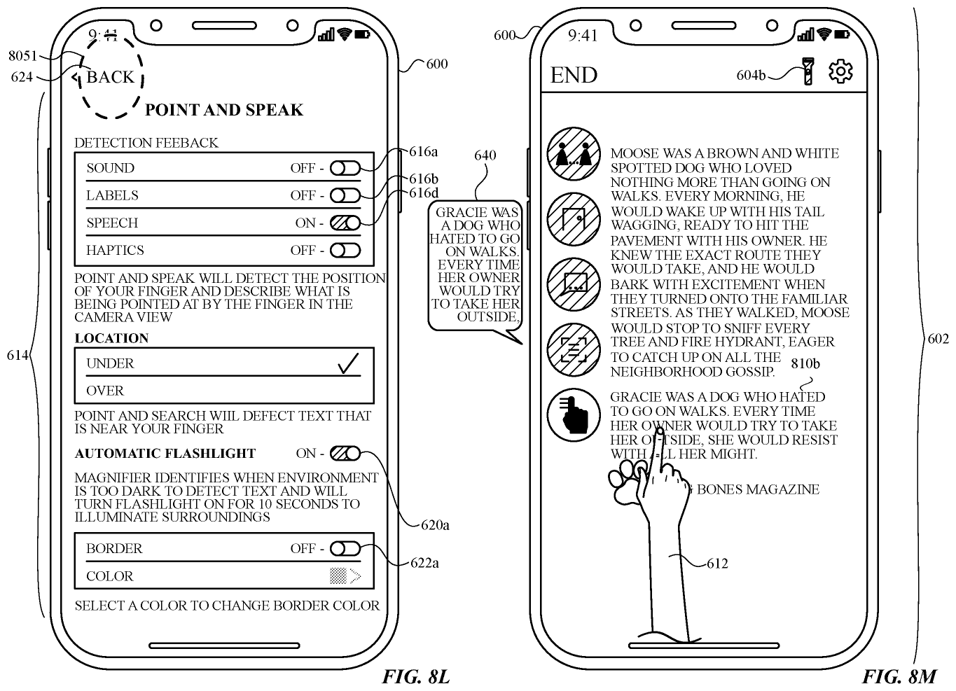

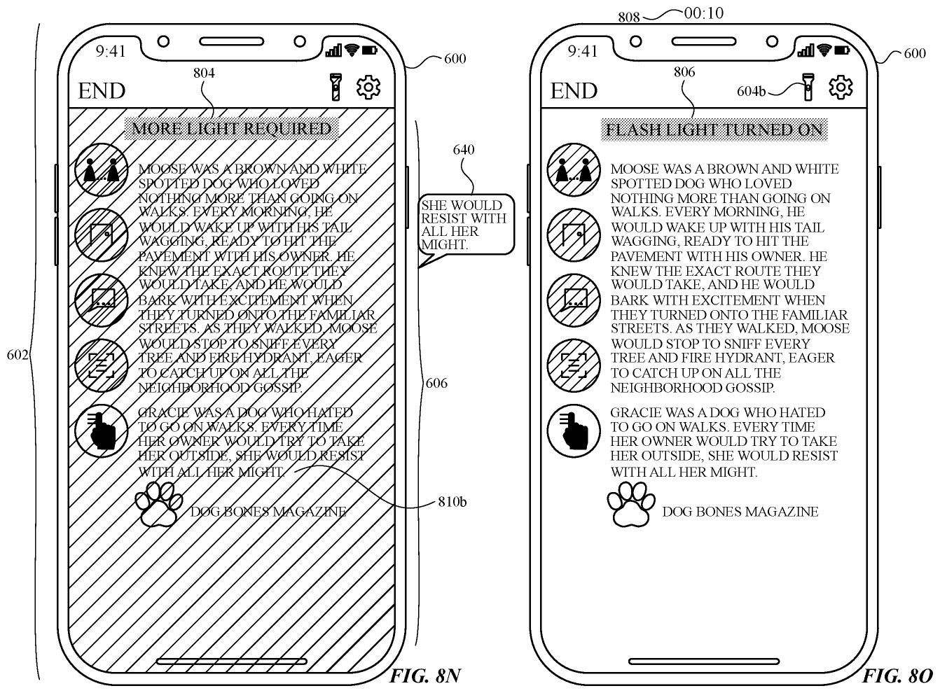

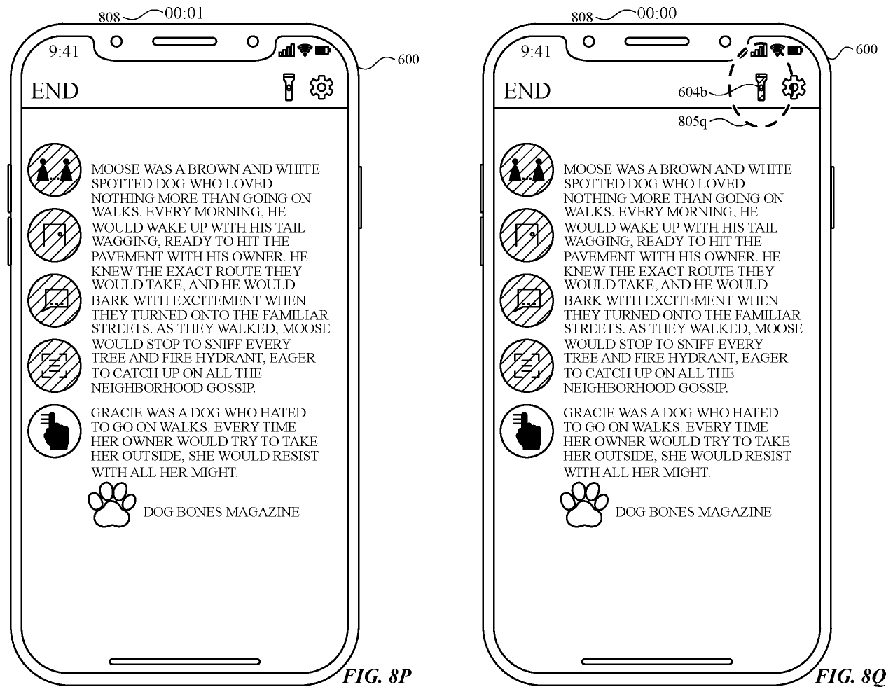

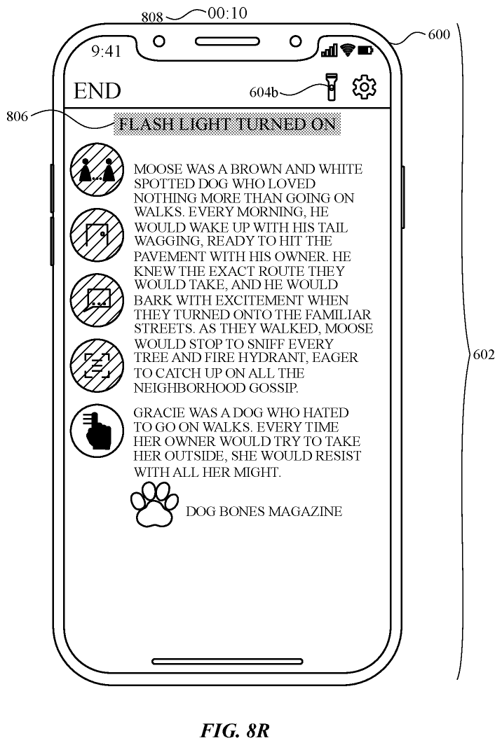

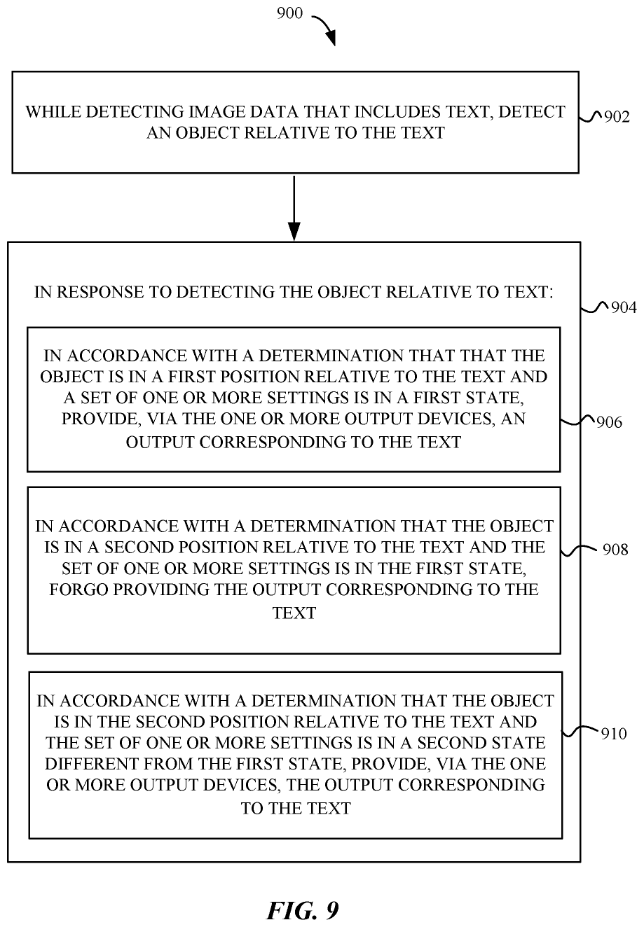

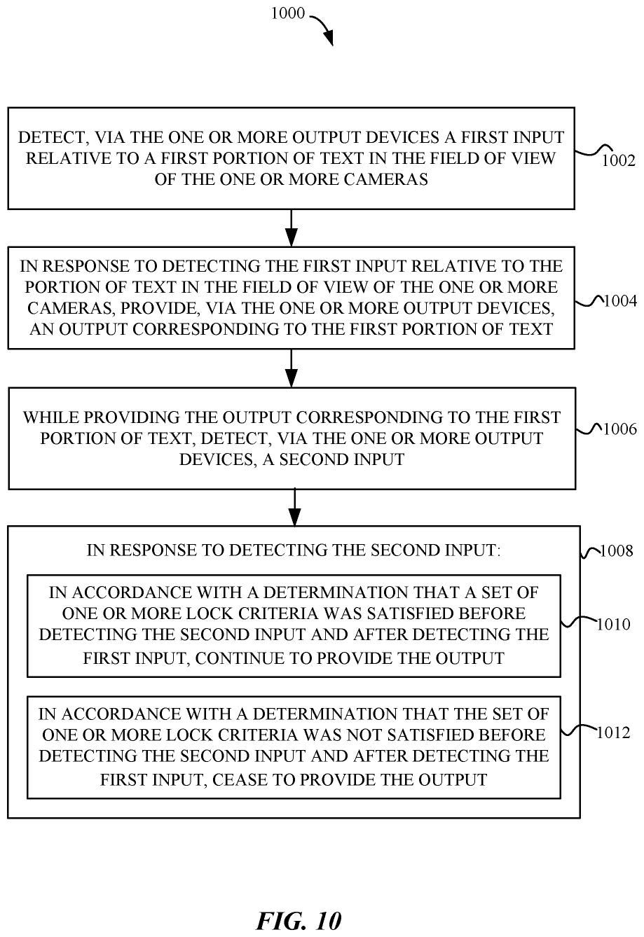

Below, FIGS. 1A-1B, 2, 3, 4A-4B, and 5A-5B provide a description of exemplary devices for performing the techniques for detecting text. FIGS. 6A-6T illustrate exemplary user interfaces for managing a text detection mode in accordance with some examples. FIG. 7 is a flow diagram illustrating methods of managing a text detection mode in accordance with some examples. FIG. 10 is a flow diagram illustrating methods for managing modes of a computer system in accordance with some examples. The user interfaces in FIGS. 6A-6T are used to illustrate the processes described below, including the processes in FIGS. 7 and 10. FIGS. 8A-8R illustrate exemplary user interfaces for identifying targeted text in accordance with some examples. FIG. 9 is a flow diagram illustrating methods of identifying targeted text in accordance with some examples. The user interfaces in FIGS. 8A-8R are used to illustrate the processes described below, including the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improved security, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

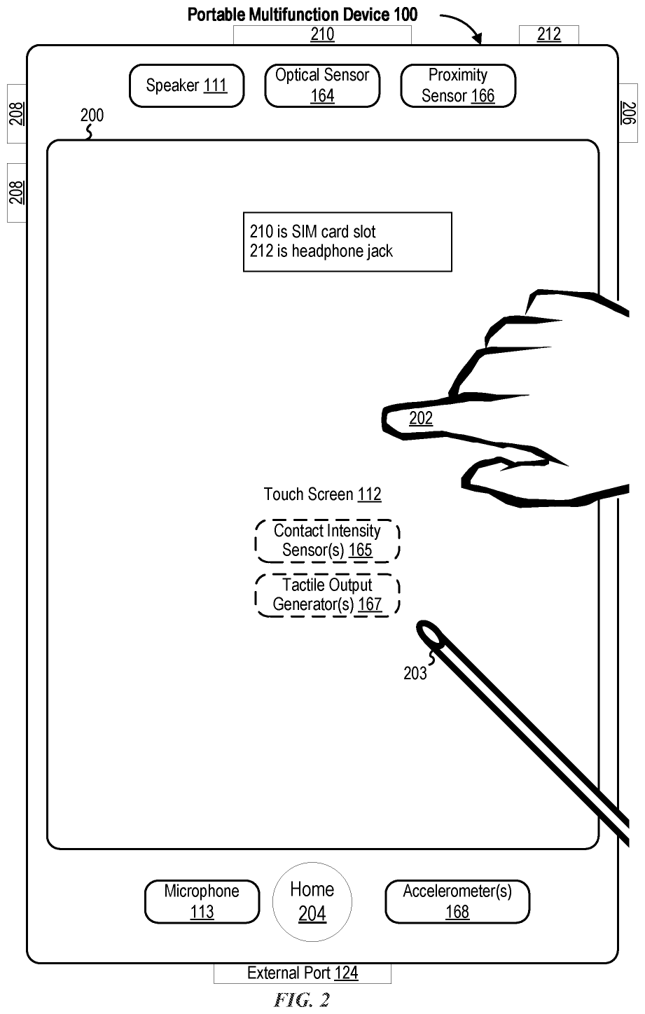

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. Nos. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “O” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

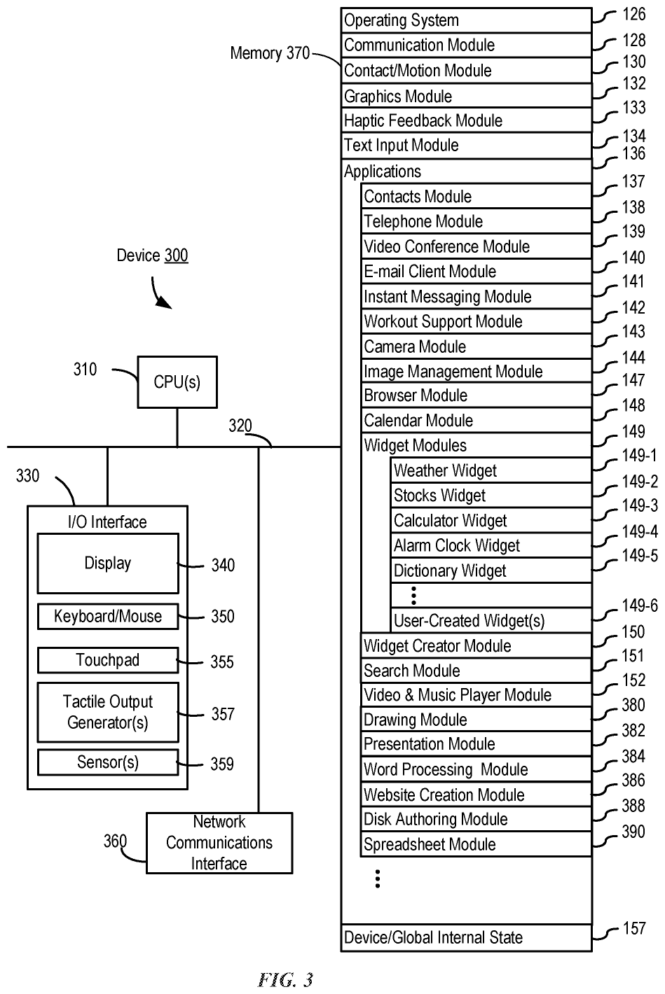

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as V×Works) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

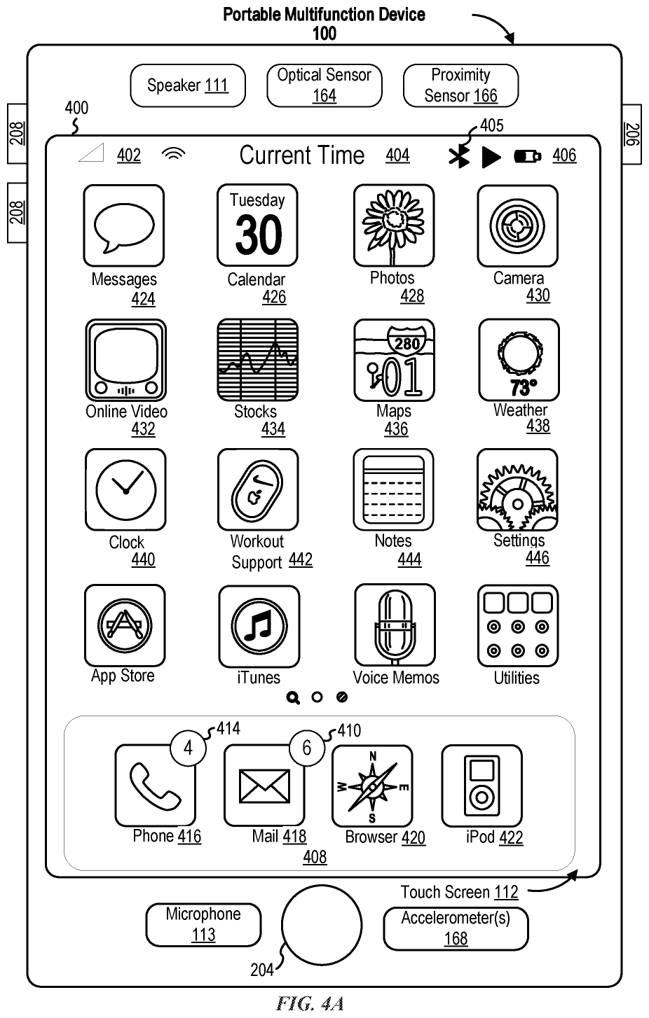

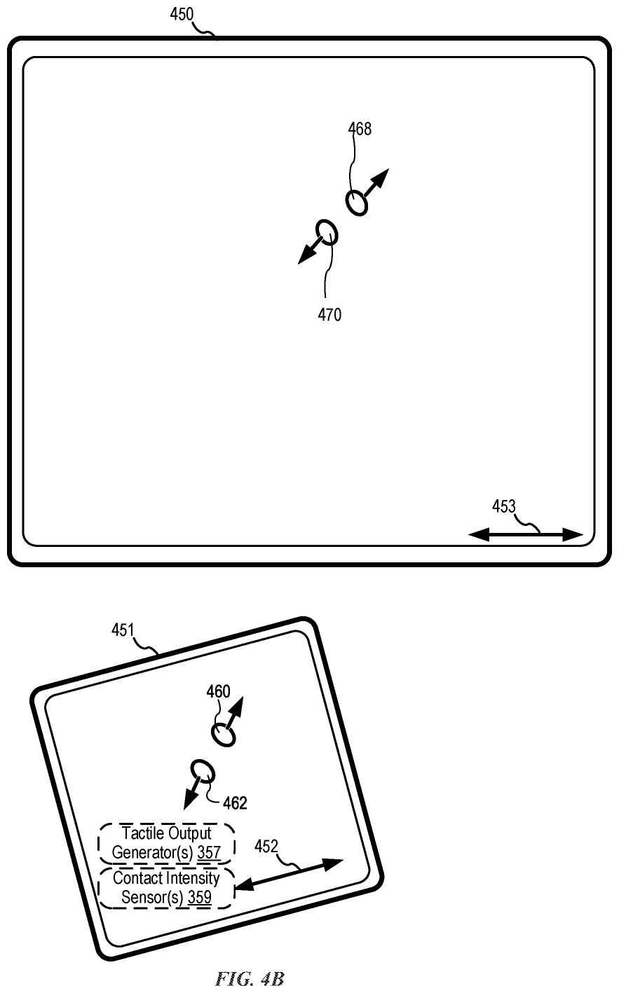

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

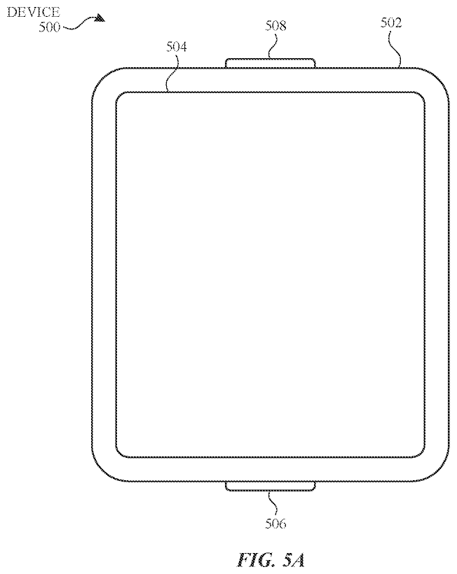

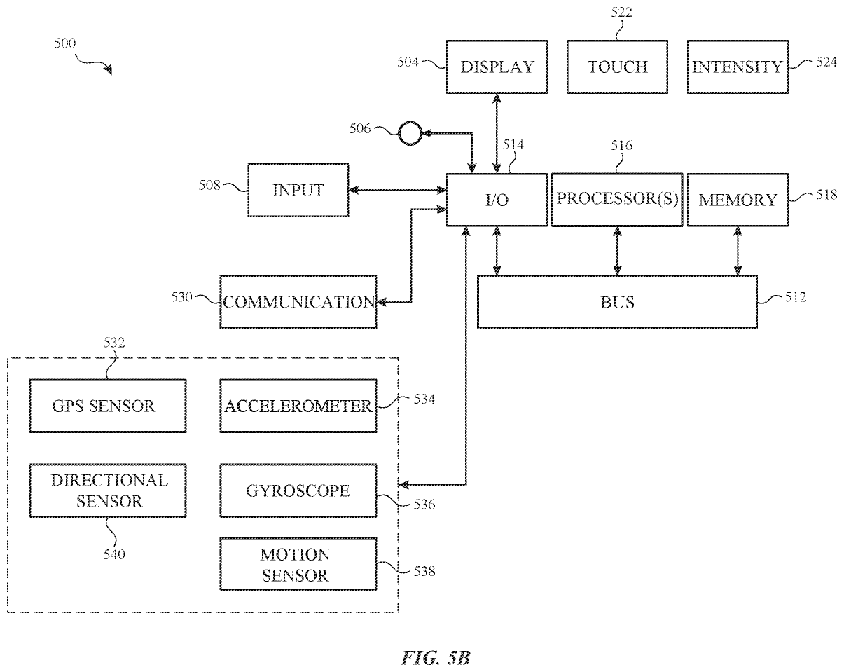

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, and 1000 (FIGS. 7, 9, and 10). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards examples of user interfaces (“UI”) and associated processes that are implemented on an electronic device, such as portable multifunction device 100, device 300, or device 500.

FIGS. 6A-6T illustrate exemplary user interfaces for managing a text detection mode using a computer system in accordance with some examples. The user interfaces in these figures are used to illustrate the processes described below, including the processes in FIGS. 7 and 10.

FIG. 6A illustrates computer system 600. At FIG. 6A, computer system 600 is depicted as a smartphone. It should be recognized that this is merely an example and techniques described here can work with other types of computer systems such as a fitness tracking device, smartwatch, a smart speaker, a head mounted display, and/or a tablet. As illustrated in FIG. 6A, computer system 600 displays viewer user interface 602. Viewer user interface 602 includes control region 604 and live feed 606. Live feed 606 is a representation of the field of view of one or more cameras that are in communication with computer system 600. At FIG. 6A, a hand of a user (e.g., a primary user) and a book are within the field of view of the one or more cameras. Accordingly, as illustrated in FIG. 6A, computer system 600 displays book 642 and hand 612 within live feed 606, where book 642 and hand 612 are currently in the field of view of the one or more cameras.

As illustrated in FIG. 6A, computer system 600 overlays display of person detector control 606a, doorway detector control 606b, image detector control 606c, character detector control 606d, and text detector control 606e on top of live feed 606. Each of person detector control 606a, doorway detector control 606b, image detector control 606c, character detector control 606d, and text detector control 606e correspond to a respective mode of computer system 600, where a particular object (e.g., an individual, a door, an image, and/or text) is detected within the field of view of the one or more cameras of computer system 600 while computer system 600 is operating in a particular mode. As illustrated in FIG. 6A, control region 604 includes settings control 604a, illumination source control 604b, and end control 604c. At FIG. 6A, computer system 600 detects input 605a that corresponds to selection of text detector control 606c. In some examples, an input described herein, such as input 605a and/or another input, is a tap input, a long press, a swipe input, a voice command, and/or a hand input (e.g., an air tap and/or an air swipe). In some examples, an input described here can be replaced with and/or added with another type of input than the type of input described herein with respect to the input.

FIG. 6B illustrates a detailed view of viewer user interface 602 and the portions of text included in book 642. At FIG. 6B, the one or more cameras are capturing text portion 610a, text portion 610b, text portion 610c, text portion 610d, and text portion 610e. Each of text portion 610a, text portion 610b, text portion 610c, text portion 610d, and text portion 610e are portions of text included in a book (e.g., book 642) being captured by the one or more cameras. Accordingly, both the book and the respective text portions are positioned at a location within an environment that is within in the field of view of the one or more cameras. At FIG. 6B, in response to detecting input 605a, computer system 600 activates (e.g., initializes and/or starts) a text detection mode of computer system 600. As illustrated in FIG. 6B, computer system 600 displays text detection mode notification 628 within live feed 606 as part of activating the text detection mode. Text detection mode notification 628 includes an indication that the text detection mode of computer system 600 is active and reads “TEXT DETECTION IS ON.” While the text detection mode is active, computer system 600 identifies targeted text relative to an input (e.g., hand 612 of FIG. 6B, an air gesture, a mouse, and/or a stylus) (e.g., text that is of interest to a user and/or text that the user wishes to have read) based on a location setting of the text detection mode and the positioning of hand 612 (and/or another type of input and/or object) relative to a respective portion of text within the field of view of the one or more cameras.

At FIG. 6B, a determination is made that hand 612 is within the field of view of the one or more cameras that are in communication with computer system 600. As illustrated in FIG. 6B, because a determination is made that hand 612 within the field of view of the one or more cameras, computer system 600 displays hand detected notification indicator 630. Hand detected notification indicator 630 indicates that computer system 600 has detected hand 612 within the field of view of the one or more cameras (e.g., “HAND IS DETECTED”). In some examples, computer system 600 displays hand detected notification indicator 630 when a determination is made that hand 612 transitions from being out of the field of view of the one or more cameras to being within the field of view of the one or more cameras, when computer system 600 initiates the text detection mode, and/or a determination is made that hand 612 within the field of view of the one or more cameras for a predetermined period of time (e.g., a non-zero period of time). In some examples, the text portions discussed throughout FIGS. 6A-6T are text portions captured by the one or more cameras, where a representation is displayed via computer system 600. In some examples, the one or more text portions are physical portions of text. In some examples, the one or more text portions are virtual text.

At FIG. 6B, in response to detecting input 605a, computer system 600 darkens the appearance of text detection control 606e. That is, computer system 600 displays text detection control 606e with a lighter appearance when a determination is made that the text detection mode of computer system 600 is inactive (e.g., as illustrated in FIG. 6A), and computer system 600 displays text detection control 606e with a darker appearance when a determination is made that the text detection mode of computer system 600 is active. In some examples, the appearance of text detection control 606e is not based on whether the text detection mode is active or inactive.

At FIG. 6B, a location setting of the text detection mode is set to “under” (e.g., as further discussed in relation to FIG. 6D). While the location setting of the text detection mode is set to “under,” computer system 600 identifies text that hand 612 (and/or a portion of hand 612, such as the end of finger) is positioned directly under as targeted text. As illustrated in FIG. 6B, hand 612 is positioned between text portion 610d (e.g., “CHAPTER 1”) and text portion 610e (e.g., “HARD WORK ETHIC”). At FIG. 6B, a determination is made that hand 612 is under text portion 610d (e.g., “CHAPTER 1”) (e.g., because the location setting of the text detection mode is set to “under”). Because a determination is made that hand 612 is under (e.g., below) text portion 610d (e.g., “CHAPTER 1”) while the location setting of the text detection mode is set to “under,” computer system 600 identifies text portion 610d (e.g., “CHAPTER 1”) as the targeted text. In response to identifying text portion 610d (e.g., “CHAPTER 1”) as the targeted text relative to an input (e.g., hand 612 of FIG. 6B, an air gesture, a mouse, and/or a stylus), computer system 600 outputs a set of outputs that correspond to text portion 610d (e.g., “CHAPTER 1”) (e.g., as further discussed below in relation to FIG. 6B). In some examples, computer system 600 identifies text portion 610d (e.g., “CHAPTER 1”) as the targeted text as a part of making the determination that hand 612 is under (e.g., below) text portion 610d. In some examples, while the location setting of the text detection mode is set to “under,” computer system 600 identifies text portion 610d as the targeted text when a determination is made that text portion 610d (e.g., “CHAPTER 1”) is positioned above hand 612. In some examples, after identifying text portion 610d (e.g., “CHAPTER 1”) as the targeted text, computer system 600 identifies text portion 610e (e.g., “HARD WORK ETHIC”) as the targeted text (e.g., and provides a set of outputs that correspond to text portion 610e (e.g., “HARD WORK ETHIC”)) in response to detecting that hand 612 moves underneath (e.g., below) text portion 610e (e.g., “HARD WORK ETHIC”) (e.g., and/or in response to detecting that hand 612 is under (e.g., below) text portion 610e (e.g., “HARD WORK ETHIC”)).

At FIG. 6B, as part of outputting the set of outputs, computer system 600 outputs haptic output 636 and audio output 638. In some examples, haptic output 636 and audio output 638 indicate that computer system 600 has identified text that is within the field of view of the one or more cameras as targeted text. In some examples, computer system 600 outputs both haptic output 636 and audio output 638 at the same time. In some examples, computer system 600 outputs both haptic output 636 before audio output 638, and vice versa. In some examples, haptic output 636 is a series of discrete haptic alerts or haptic output 636 is one continuous haptic alert. In some examples, while the text detection mode of computer system 600 is inactive, computer system 600 does not output a set of outputs that corresponds to a respective portion of text and/or does not identify targeted text.

At FIG. 6C, computer system 600 continues to provide the set of outputs that corresponds to the identified targeted text. More specifically, as illustrated in FIG. 6C, computer system 600 displays border indicator 634 and current text indicator 626 within viewer user interface 602. As illustrated in FIG. 6C, because computer system 600 identified text portion 610d (e.g., “CHAPTER 1”) as the targeted text, computer system 600 displays border indicator 634 around text portion 610d (e.g., and not around other portions of text included in live feed 606). Further, as illustrated in FIG. 6C, because computer system 600 identified text portion 610d (e.g., “CHAPTER 1”) as the targeted text, computer system 600 displays a representation of text portion 610d (e.g., “CHAPTER 1”) within current text indicator 626. Additionally, as part of providing the set of outputs, computer system 600 outputs speech output 640 (e.g., “CHAPTER 1”). At FIG. 6C, speech output 640 corresponds to a reading (e.g., that is output by computer system 600) of a portion of text 610d (e.g., “CHAPTER 1”). In some examples, audio output 638 of FIG. 6B is not the same audio as speech output 640 of FIG. 6C. In some examples, audio output 638 of FIG. 6B does not include any speech and/or language output whereas speech output 640 of FIG. 6C does. In some examples, audio output 638 of FIG. 6B does not include audio related to the characteristics and/or information for text portion 610 whereas speech output 640 of FIG. 6C does. In some examples, while computer system 600 is operating in a respective mode (e.g., full screen reader mode, a text detection mode, and/or voice over mode), the set of outputs corresponds to two or more portions of text (e.g., text portion 610a and text portion 610d (e.g., “CHAPTER 1”)).

As discussed above, in response to identifying targeted text relative to an input (e.g., hand 612, an air gesture, a mouse, and/or a stylus), computer system 600 outputs a set of outputs that correspond to the targeted text. The set of outputs includes outputting haptic output 636, outputting audio output 638, displaying border indicator 634, outputting speech output 640, and/or displaying current text indicator 626. In some examples, computer system 600 outputs each respective output included in the set of outputs at the same time. In some examples, computer system 600 outputs each respective output included in the set of outputs at a respective time. In some examples, computer system 600 outputs a subset of the outputs included in the set of outputs. In some examples, computer system 600 outputs speech output 640 in a looping pattern (e.g., while computer system 600 continues to detect hand 612 under text portion 610d (e.g., “CHAPTER 1”) and/or while computer system 600 is operating in a certain mode discussed in relation to FIGS. 6N-6P). In some examples, speech output 640 includes a translation of the targeted text. In some examples, computer system 600 outputs speech output 640 with a user defined voice (e.g., a voice of a user and/or a voice that is selected based on a language setting and/or the language of a respective text portion that computer system 600 detects). In some examples, computer system 600 outputs speech output 640 with a voice based on the language of the identified targeted text. In some examples, the text detection mode is a feature of an application that is installed on computer system 600. In some examples, when the text detection mode is a feature of an application that is installed on computer system 600, the location setting of the text detection mode remains the same after the application is closed and reopened. At FIG. 6C, computer system 600 detects input 605c directed to (e.g., at a location corresponding to, in a direction corresponding to, and/or with an input corresponding to a request to select) settings control 604a. In some examples, input 605c is a tap input, a long press, a swipe input, a voice command, and/or a hand input (e.g., an air tap and/or an air swipe).

As illustrated in FIG. 6D, in response to detecting input 605c, computer system 600 displays text detection settings user interface 614. Text detection user interface 614 includes detection feedback controls region 616, location controls region 618, automatic flashlight control region 620, and border controls region 622. As illustrated in FIG. 6D, detection feedback controls region 616 includes sound control 616a, label control 616b, speech control 616c, haptics control 616d, and detection feedback summary indicator 616e. While sound control 616a is active (e.g., “ON”), computer system 600 provides an audible output (e.g., audio output 638) (e.g., a clicking sound, a bell sound, and/or a whistle sound) in response to computer system 600 identifying targeted text relative to an input (e.g., hand 612, an air gesture, a mouse, and/or a stylus). While labels control 616b is active, computer system 600 displays a representation of the targeted text (e.g., current text indicator 626) in response to computer system 600 (and/or another computer system) identifying targeted text relative to an input. While speech control 616c is active, computer system 600 outputs a voice that reads targeted text (e.g., speech output 640) in response to computer system 600 (and/or another computer system) identifying targeted text relative to an input. While haptic control 616d is active, computer system 600 outputs haptic alerts (e.g., haptic outputs 636) in response to computer system 600 (and/or another computer system) identifying targeted text relative to an input. Detection feedback summary indicator 616c provides an explanation of the functionalities of text detection mode.

Location controls region 618 includes under location setting 618a, over location setting 618b, location selection indicator 618c, and location summary indicator 618d. Under location setting 618a corresponds to a setting of the text detection mode that, when active, allows computer system 600 to identify a respective portion of text as targeted text when a determination is made that hand 612 is positioned beneath the respective text. Over location setting 618b corresponds to a setting of the text detection mode that, when active, allows computer system 600 to identify respective text as targeted text when a determination is made that hand 612 as positioned over (e.g., at, a pad of a finger is over, and/or on top of) the respective text. In some examples, under location setting 618a corresponds to a setting of the text detection mode that, when active, allows computer system 600 to identify a respective portion of text as targeted text when a determination is made that the respective portion of text is above hand 612. In some examples, over location setting 618b corresponds to a setting of the text detection mode that, when active, allows computer system 600 to identify a respective portion of text as targeted text when a determination is made the respective portion of text is under (e.g., beneath) hand 612.

Location selection indicator 618c indicates whether the location setting of the text detection mode is set to over location setting 618b or under location control 618a. As illustrated in FIG. 6C, computer system 600 displays location selection indicator 618c within under location setting 618a. Accordingly, at FIG. 6C, the location setting of the text detection mode is set to “under.” Location summary indicator 618d provides an explanation of the location setting of the text detection mode. In some examples, the content included in location summary indicator 618d changes based on whether over location setting 618b is active or inactive and/or whether under location setting 618a is active or inactive.

Automatic flashlight controls region 620 includes automatic flashlight control 620a and automatic flashlight summary indicator 620b. As discussed in greater detail below at FIGS. 8N-8O, while automatic flash control 620a is active, computer system 600 is configured to automatically (e.g., without intervening user input) activate a light source (e.g., a light source that is coupled to computer system 600 or a light source that is external to computer system 600) when a set of respective criteria is satisfied. In some examples, the set of respective criteria includes at least one or more criterion that is satisfied based on the ambient light (0-50 lux) in the current environment surrounding computer system 600. Automatic flashlight summary indicator 620b provides an explanation of the criteria that cause computer system 600 to activate the light source.

Border controls region 622 includes border control 622a, border color control 622b, and border summary indicator 622c. While border control 622a is active, computer system 600 displays a visual border (e.g., border indicator 634) around targeted text in response to identifying targeted text relative to an input (e.g., hand 612, an air gesture, a mouse, and/or a stylus). Computer system 600 displays color options (e.g., via border color control 622b) for the visual border in response to computer system 600 detecting an input directed at border color control 622b. Border summary indicator 622c provides an explanation of changing the border color. As illustrated in FIG. 6D, each of border control 622a, sound control 616a, label control 616b, speech control 616c, and haptics control 616d, are active (e.g., turned “on”). At FIG. 6D, computer system 600 detects input 605d directed to over location setting 618b. In some examples, input 605d is a tap input, a long press, a swipe input, a voice command, and/or a hand input (e.g., a. air tap and/or an air swipe).

At FIG. 6E, in response to detecting input 605d, computer system 600 changes the location setting of the text detection mode to over location setting 618b. Accordingly, as illustrated in FIG. 6E, computer system 600 displays location selection indicator 618c within over location setting 618b, signifying that the current location setting of the text detection mode is set to “over”. While the location setting of the text detection mode is set to over, computer system 600 identifies respective text as targeted text based on a determination that hand 612 as positioned over (e.g., at, a pad of a finger being over, and/or a finger hovering over) as the respective text. At FIG. 6E, computer system 600 detects input 605e directed to return control 624. In some examples, input 605e is a tap input, a long press, a swipe input, a voice command, and/or a hand input (e.g., an air tap and/or an air swipe).

As illustrated in FIG. 6F, in response to detecting input 605e, computer system 600 displays viewer user interface 602, and ceases to display text detection settings user interface 614 (e.g., text detection settings user interface 614 of FIG. 6E is not displayed in FIG. 6F). As illustrated in FIG. 6F, hand 612 is positioned between text portion 610d (“CHAPTER 1”) and text portion 610e (e.g., “HARD WORK ETHIC”). At FIG. 6F, a determination is made that hand 612 is over (e.g., on top of) text portion 610e (e.g., “HARD WORK ETHIC”) (e.g., because the location setting of the text detection mode is set to “over”) (e.g., and a determination is not made that hand 612 is under text portion 610d (e.g., “CHAPTER 1”)). Because a determination is made that hand 612 is over (e.g., on top of) text portion 610e (e.g., HARD WORK ETHIC) while the location setting of the text detection mode is set to “over” (e.g., as indicated by over location setting 618b and location selection indicator 618c of FIG. 6E), computer system 600 identifies text portion 610e (e.g., “HARD WORK ETHIC”) as the targeted text. That is, though hand 612 is in the same position at FIG. 6F as it is in FIG. 6B, because the location setting of the text detection mode is set to “over” at FIG. 6F (e.g., as opposed to “under” at FIG. 6B) computer system 600 identifies text portion 610c (e.g., “HARD WORK ETHIC”) as the targeted text and not text portion 610d (e.g., “CHAPTER 1”).

At FIG. 6F, in response to computer system 600 identifying text portion 610c (e.g., “HARD WORK ETHIC”) as the targeted text, computer system 600 outputs a set of outputs that correspond to text portion 610e (e.g., “HARD WORK ETHIC”). For example, at FIG. 6F, computer system 600 outputs haptic output 636 and audio output 638. Further, as part of providing the set of outputs, computer system 600 displays border indicator 634 around text portion 610e (e.g., “HARD WORK ETHIC”) and computer system 600 displays text portion 610e (e.g., “HARD WORK ETHIC”) within current text indicator 626. Additionally, as part of outputting the set of outputs, computer system 600 outputs speech output 640. At FIG. 6F, speech output 640 corresponds to a reading (e.g., that is output by computer system 600) of text portion 610e (e.g., “HARD WORK ETHIC”). Accordingly, at FIG. 6F, speech output 640 includes a reading of “hard work ethic.” At FIG. 6F, hand 612 moves from being positioned over text portion 610e (e.g., “HARD WORK ETHIC”) to being positioned over text portion 610a.

As illustrated in FIG. 6G, hand 612 is positioned over (e.g., at) (e.g., at a location corresponding to) text portion 610a. At FIG. 6G, a determination is made that hand 612 is positioned over text portion 610a (e.g., because the location setting of the text detection mode is set to “over”). Because a determination is made that hand 612 is positioned over text portion 610a while the location setting of the text detection mode is set to “over,” computer system 600 identifies text portion 610a as the targeted text (e.g., and text portion 610e (e.g., “HARD WORK ETHIC”) ceases to be the targeted text). In some examples, a determination that hand 612 (or another input) being positioned “over” and/or “under” a portion of text is a determination that a portion of hand 612 (or other input), such as an index finger (e.g., a fingertip and/or finger pad), is positioned “over” and/or “under” a portion of text. At FIG. 6G, in response to identifying, relative to an input (e.g., hand 612, an air gesture, a mouse, and/or a stylus), text portion 610a as the targeted text, computer system 600 provides a set of outputs that correspond to text portion 610a.

As illustrated in FIG. 6G, as part of providing the set of outputs, computer system 600 displays border indicator 634 around text portion 610a and displays a portion of text portion 610a (e.g., “There once was a small boy named John. John loved to play soccer and”) within current text indicator 626. Further, as part of providing the set of outputs, computer system 600 outputs haptic output 636 and audio output 638. Additionally, as part of outputting the set of outputs, computer system 600 outputs speech output 640. At FIG. 6G, speech output 640 corresponds to a reading (e.g., that is output by computer system 600) of the first portion of text portion 610a. Accordingly, at FIG. 6G, speech output 640 includes a reading of “There once was a small boy named John” of text portion 610a. In some examples, in response to identifying a new portion of text as the targeted text relative to an input (e.g., hand 612, an air gesture, a mouse, and/or a stylus), computer system 600 finishes outputting audio of a previously targeted portion of text before computer system 600 begins to output audio of the newly targeted portion of text. In some examples, in response to identifying the new portion of text as the targeted text relative to an input (e.g., hand 612, an air gesture, a mouse, and/or a stylus), computer system 600 interrupts the output of a previously targeted portion of text with output of the newly targeted portion of text.

At FIG. 6H, text portion 610a remains the targeted text and hand 612 continues to be detected relative to text portion 610a. Accordingly, as illustrated in FIG. 6H, computer system 600 continues to display border indicator 634 around text portion 610a and computer system 600 displays a portion of text portion 610a (e.g., “There once was a small boy named John. John loved to play soccer and”) within current text indicator 626. Further, at FIG. 6H, computer system 600 continues to output speech output 640. At FIG. 6H, speech output 640 is a continuation of the reading of text portion 610a from FIG. 6G. Accordingly, at FIG. 6H, speech output 640 includes the portion of text portion 610a (e.g., “John loved to play soccer and was very good at it. He loved to kick”) that directly follows the portion of text portion 610 that computer system 600 output at FIG. 6G. At FIG. 6H, computer system 600 detects input 605h that corresponds to an upward swipe directed to current text indicator 626. In some examples, input 605h is a tap input, a long press, a swipe input, a voice command, and/or a hand input (e.g., an air tap and/or an air swipe).

At FIG. 6I, in response to detecting input 605h, computer system 600 scrolls current text indicator 626 in an upward (e.g., in an upward direction and/or towards text portion 610a). Because computer system 600 scrolls current text indicator 626 in the upward direction, computer system 600 displays a portion of text portion 610a within current text indicator 626 that directly follows the portion of text portion 610a that was previously displayed within current text indicator 626 (e.g., at FIG. 6H). As illustrated in FIG. 6I, computer system 600 displays “was very good at it. He loved to kick and run and go all over the place.” within current text indicator (e.g., and not “there once was a small boy named John. John loved to play soccer and” as shown in FIG. 6H).

Additionally, at FIG. 6I, computer system 600 continues to output speech output 640. At FIG. 6I, speech output 640 is a continuation of the reading of text portion 610a from FIG. 6H. Accordingly, at FIG. 6I, computer system 600 outputs speech output 640, which corresponds to a portion of text portion 610a (e.g., “and run and go all over the place. He had been playing for a long time, so he was”) that directly follows the portion of text portion 610a that computer system 600 output at FIG. 6H. In some examples, the direction that computer system 600 scrolls the text within current text indicator 626 is based on the detected direction of input 605h. In some examples, the amount that computer system 600 scrolls text within current text indicator 626 is based on a detected magnitude and/or speed of input 605h. In some examples, computer system 600 adjusts the output of speech output 640 based on detecting an input that corresponds to a request to scroll current text indicator 626 (e.g., output of speech output 640 advances ahead to the portion of targeted text that computer system 600 scrolls to within current text indicator 626). In some examples, computer system 600 does not adjust the output of speech output 640 based on detecting an input that corresponds to a request to scroll current text indicator 626. In some examples, in response to detecting a respective input that is in an opposite direction than input 605h (e.g., the respective input is a downward swipe), computer system scrolls current text indicator 626 such that computer system 600 displays text (e.g., text that is displayed within current text indicator 626 at FIG. 6H) that computer system 600 previously displayed within current text indicator 626. At FIG. 6I, the orientation of computer system 600 transitions from a portrait orientation to a landscape orientation.

As illustrated in FIG. 6J, computer system 600 is positioned in the landscape orientation. As illustrated in FIG. 6J, because computer system 600 is positioned in the landscape orientation, computer system 600 displays viewer user interface 602 in the landscape orientation. At FIG. 6J, text portion 610a continues to be the targeted text and hand 612 continues to be detected relative to text portion 610a. Because text portion 610a continues to be the targeted text, computer system 600 displays border indicator 634 around text portion 610a. Further, at FIG. 6J, because text portion 610 continues to be the targeted text, computer system 600 continues to output speech output 640. At FIG. 6J, speech output 640 is a continuation of the reading of text portion 610a from FIG. 6I. Accordingly, at FIG. 6J, computer system 600 outputs a portion of speech output 640 corresponding to the portion of text portion 610a (e.g., “getting pretty good. He”) that directly follows the portion of text portion 610a that computer system 600 output at FIG. 6I.

As illustrated in FIG. 6J, because text portion 610a is the targeted text and hand 612 has continued to be detected relative to portion 610a, computer system 600 displays a portion of text portion 610a (e.g., “He had been playing for a long time, so he”) within current text indicator 626. While computer system 600 is positioned in the landscape orientation, computer system 600 automatically (e.g., without intervening user input) scrolls text that is displayed within current text indicator 626 because a determination is made that computer system 600 is in the landscape orientation. Accordingly, at FIG. 6J, computer system 600 automatically displays a portion of text portion 610a within current text indicator that directly follows the portion of text portion 610a that computer system 600 displayed within current text indicator 626 at FIG. 6I. In some examples, computer system 600 automatically scrolls current text indicator 626 while computer system 600 is in portrait orientation and/or does not automatically scroll current text indicator 626 while computer system 600 is in landscape orientation.

At FIG. 6K, text portion 610a continues to be the targeted text while hand 612 continues to be detected relative to text portion 610a. Because text portion 610a continues to be the targeted text, computer system 600 displays border indicator 634 around text portion 610a, and computer system 600 displays a portion of text portion 610a (e.g., “so he was getting pretty good. He had even”) within current text indicator 626. Further, at FIG. 6K, computer system 600 continues to output speech output 640. At FIG. 6K, speech output 640 is a continuation of the reading of text portion 610a from FIG. 6J. Accordingly, at FIG. 6K, computer system 600 outputs a portion of speech output 640 corresponding to the portion of text portion 610a (e.g., “had even led”) that directly follows the portion of text portion 610a that computer system 600 output at FIG. 6J.

At FIG. 6K, computer system 600 remains positioned in the landscape orientation and a determination is made that computer system 600 is positioned in the landscape orientation. At FIG. 6K, because a determination is made that computer system 600 is positioned in the landscape orientation, computer system 600 continues to automatically (e.g., without intervening user input) scroll the text that is displayed within current text indicator 626. Accordingly, at FIG. 6K, computer system 600 displays the portion of text portion 610a that directly follows the portion of text portion 610a that computer system 600 displayed within current text indicator 626 at FIG. 6J. At FIG. 6K, the orientation of computer system 600 transitions from the landscape orientation to a portrait orientation.

As illustrated in FIG. 6L, computer system 600 is positioned in the portrait orientation. As illustrated in FIG. 6L, because computer system 600 is positioned in the portrait orientation, computer system 600 displays viewer user interface 602 in the portrait orientation. At FIG. 6L, text portion 610a continues to be the targeted text. As illustrated in FIG. 6L, because text portion 610a is the targeted text, computer system 600 displays border indicator 634 around text portion 610a. Further, at FIG. 6L, because text portion 610 continues to be the targeted text, computer system 600 continues to output speech output 640. At FIG. 6K, speech output 640 is a continuation of the reading of text portion 610a from FIG. 6K. Accordingly, at FIG. 6L, computer system 600 outputs a portion of speech output 640 corresponding to the portion of text portion 610a (e.g., “his team to the championships!”) that directly follows the portion of text portion 610a that computer system 600 output at FIG. 6K.

As illustrated in FIG. 6L, because text portion 610a is the targeted text while hand 612 continues to be detected relative to text portion 610a, computer system 600 displays a portion of text portion 610a within current text indicator 626. Because computer system 600 is not in the landscape orientation, computer system 600 does not automatically scroll the text included within current text indicator 626 (and/or stops automatically scrolling the text included within current text indicator 626). Accordingly, as illustrated in FIG. 6L, computer system 600 displays a portion of text portion 610a that was previously displayed within current text indicator 626 at FIG. 6K. In some examples, after computer system 600 transitions from the landscape orientation to the portrait orientation, computer system 600 displays the beginning of text portion 610a within current text indicator 626. In some examples, after computer system 600 transitions from the landscape orientation to the portrait orientation, computer system 600 displays a portion of text portion 610a that was not previously displayed within text indicator 626.

At FIG. 6M, a determination is made that hand 612 is positioned over text portion 610b (e.g., because the location setting of the text detection mode is set to “over”). At FIG. 6M, because a determination is made that hand 612 is positioned over text portion 610b while the location setting of the text detection mode is set to “over”, computer system 600 identifies text portion 610b as the targeted text (e.g., and text portion 610a ceases being the targeted text at FIG. 6M).

At FIG. 6M, in response to computer system 600 identifying text portion 610b as the targeted text, computer system 600 outputs a set of outputs that correspond to text portion 610b. As part of outputting the set of outputs, computer system 600 outputs haptic output 636 and audio output 638. Further, as part of providing the set of outputs, computer system 600 displays border indicator 634 around text portion 610b, and computer system 600 displays a portion of text portion 610b (e.g., “One day, John was practicing soccer by himself. He scored a goal and”) within current text indicator 626. Additionally, as part of providing the set of outputs, computer system 600 outputs speech output 640. At FIG. 6M, speech output 640 includes a reading (e.g., that is output by computer system 600) of the first portion of text portion 610b (“One day, John was practicing soccer by himself.”) of text portion 610b. At FIG. 6M, hand 612 moves from being over text portion 610b to being over text portion 610a.

As illustrated in FIG. 6N, hand 612 is positioned over text portion 610a, and a determination is made that hand 612 is positioned over text portion 610a (e.g., because the location setting of the detection mode is set to “over” as discussed above). Because a determination is made that hand 612 is positioned over text portion 610a while the location setting of the text detection mode is set to “over,” computer system 600 identifies text portion 610a as the targeted text (e.g., and text portion 610b is no longer the targeted text). In response to computer system 600 identifying text portion 610a as the targeted text, computer system 600 outputs a set of outputs that correspond to text portion 610a. As part of outputting the set of outputs, computer system 600 outputs haptic output 636 and audio output 638 and displays border indicator 634 around text portion 610a. Additionally, as part of outputting the set of outputs, computer system 600 displays a portion of text portion 610a (e.g., “There once was a small boy named John. John loved to play soccer”) within current text indicator 626.

Additionally, as part of outputting the set of outputs, computer system 600 outputs speech output 640. At FIG. 6N, speech output 640 corresponds to a reading of the first portion of text portion 610a (e.g., “There once was a small boy named John”). At FIG. 6N, computer system 600 detects input 605n on one or more surfaces of computer system 600. In some examples, computer system 600 does not detect input 605n on a surface of the computer system. In some examples, computer system 600 detects input 605n within the field of view of one or more cameras that are in communication with computer system 600. In some examples, input 605n is a different type of input than the other inputs detected throughout FIGS. 6A-6M. In some examples, input 605n is an input corresponding to a double tap input. In some examples, input 605n is a tap input, a long press, a swipe input, a voice command, and/or a hand input (e.g., an air tap and/or an air swipe).

At FIG. 6O, in response to detecting input 605n, computer system 600 continues to output speech 640 corresponding to text portion 610a and transitions to a locked-on text from a mode that is different from the locked-on text mode. The locked-on text mode is a mode at which computer system 600 will continue to output audio corresponding a respective portion of text, regardless of movement of hand 612 (e.g., from being positioned relative to the respective of text) occurring while outputting the audio. The mode different from the locked-on text mode is a mode at which computer system 600 will cease to output audio corresponding to the respective portion of text when a determination that movement of hand 612 occurred while outputting the audio. As illustrated in FIG. 6O, hand 612 is positioned over text portion 610c. In some examples, while computer system 600 operates in the locked-on text mode, computer system 600 does not identify text portion 610c as the targeted portion and/or does not output audio corresponding to text portion 610c. In some examples, computer system 600 detects the positioning of hand 612 relative to a respective portion of text while computer system 600 operates in the locked-on text mode. In some examples, computer system 600 identifies a targeted portion of text relative to an input (e.g., hand 612, an air gesture, a mouse, and/or a stylus) and does not provide any outputs that correspond to the targeted portion of text while computer system 600 is operating in the locked-on text mode. In some examples, computer system 600 continues to output audio corresponding to text portion 610a while operating in the locked-on text mode even when an object obstructs (e.g., partially obstructs or completely obstructs) a respective portion of text. In some examples, computer system 600 does not identify targeted portions of text while computer system is operating in the locked-on text mode. In some examples, while operating in the locked-on text mode, computer system 600 outputs text portion 610c after completely outputting audio corresponding to the entirety of text portion 610b.

At FIG. 6O, text portion 610a continues to be the targeted text. Because text portion 610 continues to be the targeted text, computer system 600 continues to display border indication 634 around text portion 610a and displays a portion of text portion 610a (e.g., “There once was a small boy named John. John loved to play soccer”) within current text indicator 626. Further, at FIG. 6O, speech output 640 is a continuation of the reading of text portion 610a from FIG. 6N. Accordingly, at FIG. 6O, computer system 600 outputs a portion of speech output 640 corresponding to the portion of text portion 610a (e.g., “John loved to play soccer”) (e.g., that directly follows the portion of text portion 610a that computer system 600 output at FIG. 6N) without outputting speech audio corresponding to text portion 610c (e.g., where hand 612 is positioned relative to at FIG. 6O) because computer system 600 is operating in the locked-on text mode. At FIG. 6O, computer system 600 detects voice command 605o (e.g., a voice command directed towards computer system 600). Voice command 605o directs a smart assistant of computer system 600 to read a next portion of text (e.g., “Smart assistant, read next portion of text”).

At FIG. 6P, computer system 600 does not perform a respective action in response to detecting voice command 605o because computer system 600 is operating in the locked-on text mode. In some examples, computer system 600 outputs text corresponding to the respective action (e.g., “the next portion of text,” which is different from text portion 610a) in response to detecting voice command 605o while operating in the mode that is not the locked-on text mode. At FIG. 6P, text portion 610a continues to be the targeted text. Accordingly, as illustrated in FIG. 6P, computer system 600 displays border indicator 634 around text portion 610a, and computer system 600 displays a portion of text portion 610a (e.g., “There once was a small boy named John. John loved to play soccer) within current text indicator 626.

Additionally, At FIG. 6P, because text portion 610a continues to be the targeted text, speech output 640 is a continuation of the reading of text portion 610a from FIG. 6O. Accordingly, at FIG. 6P, computer system 600 outputs a portion of speech output 640 corresponding to the portion of text portion 610a (e.g., “and was very good at it”) that directly follows the portion of text portion 610 that computer system 600 output at FIG. 6O. At FIG. 6P, computer system 600 detects input 605p directed to one or more surfaces of computer system 600. Input 605p is the same type of input as input 605n. In some examples, input 605p and input 605n are different types of inputs. In some examples, input 605n and input 605p are not a hand that is detected due to the hand being positioned relative to text and/or to which computer system is responsive due to the hand being positioned relative to text. In some examples, computer system 600 detects input 605p in the field of view of one or more cameras that are in communication with computer system 600. In some examples, input 605p is a tap input, a long press, a swipe input, a voice command, and/or a hand input (e.g., an air tap and/or an air swipe).

At FIG. 6Q, in response to detecting input 605p, computer system 600 transitions out of the locked-on text mode. That is, computer system 600 transitions out of the locked-on text mode in response to detecting the same type of input as the input that caused computer system 600 to go into the locked-on text mode at FIG. 6N. As illustrated in FIG. 6Q, hand 612 is positioned over text portion 610c. At FIG. 6Q, a determination is made that hand 612 is positioned over text portion 610c (e.g., because the location setting of the text detection mode is set to “over”). Because a determination is made that hand 612 is positioned over text portion 610c while the location setting of the text detection mode is set to “over,” computer system 600 identifies text portion 610c as the targeted text. In response to computer system 600 identifying that text portion 610c as the targeted text, computer system 600 outputs a set of outputs that corresponds to text portion 610c.

As part of outputting the set of outputs, computer system 600 outputs haptic output 636 and audio output 638. Further, as illustrated in FIG. 6Q, as part of outputting the set of outputs, computer system 600 displays border indicator 634 around text portion 610c, and computer system 600 displays a portion of text portion 610c (e.g., “The two played soccer for the rest of the day. They had never had so”) within current text indicator 626. Additionally, at FIG. 6Q, computer system 600 outputs speech output 640 as part of outputting the set of outputs. At FIG. 6Q, speech output corresponds to a reading (e.g., that is output by computer system 600) of the first portion of text portion 610c (e.g., “the two played soccer for the rest of the day”).

At FIG. 6R, a determination is made that a non-user hand 646 is within live feed 606 (and/or in the field of view of the one or more cameras). Non-user hand 646 is a hand belonging to a non-user (e.g., a user that does not correspond to computer system 600, a user that does not correspond to and/or is not associated with a user account that computer system 600 is logged into, and/or a user that is not authorized to use computer system 600) of computer system 600. As illustrated in FIG. 6R, non-user hand 646 is positioned over text portion 610a. However, because a determination is made that non-user hand 646 belongs to a non-user of computer system 600, computer system 600 does not identify text portion 610a as the targeted text and/or does not provide the set of outputs corresponding to text portion 610a. In some examples, computer system 600 identifies portions of text as targeted text based on the positioning of a primary user of computer system 600 (e.g., the user associated with hand 612), and computer system 600 does not identify portions of text as targeted text based on the positioning of hands of non-users of computer system. In some examples, the differences between hand 612 and non-user hand 646 is determined by analyzing the differences in size, distance from camera, and/or orientation between hand 612 and non-user hand 646. In some examples, computer system 600 identifies targeted text relative to an input (e.g., hand 612, an air gesture, a mouse, and/or a stylus) based on the hand positioning of a first user and/or the hand positioning of a second user. In some examples, a determination is made that a non-user hand 646 is within live feed 606 when a determination is made that the hand of the user is not within the field of view of the one or more cameras.

At FIG. 6R, text portion 610c remains the targeted portion of text. Accordingly, as illustrated in FIG. 6R, computer system 600 continues to display border indicator 634 around text portion 610c and displays a portion of text portion 610c (e.g., “The two played soccer for the rest of the day. They had never had so”) within current text indicator 626. Further, at FIG. 6R, computer system 600 continues to output speech output 640. At FIG. 6R, speech output 640 is a continuation of the reading of text portion 610c from FIG. 6Q. Accordingly, at FIG. 6R, computer system 600 output a portion of speech output 640 corresponding to the portion of text portion 610c (e.g., “They had never had so much fun!”) that directly follows the portion of text portion 610c that computer system 600 output at FIG. 6Q. At FIG. 6R, the positioning of hand 612 moves and the positional configuration of the fingers of hand 612 change.

As illustrated in FIG. 6S, hand 612 is positioned over text portion 610a and hand 612 is positioned in a manner such that the index finger of hand 612 is perpendicular to computer system 600 (e.g., the index finger of hand 612 is going in and out of the FIG. 6S). That is, between FIGS. 6R and 6S, the configuration of hand 612 has transitioned from a position where the index finger of hand 612 is parallel to computer system 600 to a position where the index finger of hand 612 is perpendicular to computer system 600.

At FIG. 6S, a determination is made that the index finger of hand 612 is positioned perpendicular to computer system 600. Because a determination is made that the index finger of hand 612 is positioned perpendicular to computer system 600, computer system 600 displays realignment notification indicator 632 within viewer user interface 602. As illustrated in FIG. 6S, realignment notification indicator 632 reads, “Hold hand and finger parallel to phone.” Realignment notification indicator 632 indicates that the positioning/orientation of hand 612 and/or fingers of hand 612 need to be realigned such that hand 612 and/or fingers of hand 612 are parallel to computer system 600 (e.g., in order for text be identified and/or audio corresponding to one or more portions of the text to be output). In some examples, realignment notification indicator 632 indicates that the positioning/orientation of hand 612 and/or fingers of hand 612 need to be realigned such that the fingers of hand 612 and/or hand 612 is parallel to a display of computer system 600.

The orientation of hand 612 at FIG. 6S is an illustration of one type of incorrect positioning and/or appearance of hand 612. Computer system 600 does not identify new targeted text while hand 612 is in an incorrect positioning. Accordingly, at FIG. 6S, though hand 612 is positioned over text portion 610a, because the positioning of hand 612 is incorrect, computer system 600 does not identify text portion 610a as targeted text and/or output audio corresponding to the target text.

FIG. 6S includes hand position schematic 644. Hand position schematic 644 is a visual aid (e.g., and not displayed by computer system 600) that includes various illustrations of various types of incorrect hand positions. As illustrated in FIG. 6S, hand position schematic 644 includes representation 644a of a hand in a fist, representation 644b of hand with three fingers pointing outwards, and representation 644c of a hand with all five fingers pointing outwards. Accordingly, while computer system 600 is in the text detection mode, computer system 600 does not identify targeted text in response to detection of hand 612 in one of the orientations included in hand position schematic 644.

At FIG. 6S, text portion 610c remains the targeted portion of text. Accordingly, as illustrated in FIG. 6S, computer system 600 displays border indicator 634 around text portion 610c, and computer system 600 displays a portion of text portion 610c (e.g., “The two played soccer for the rest of the day. They had never had so”) within current text indicator 626. At FIG. 6S, speech output 640 is a continuation of the reading of text portion 610c from FIG. 6R. Accordingly, at FIG. 6S, computer system 600 outputs a portion of speech output 640 corresponding to the portion of text portion 610c (e.g., “Jane was a natural goalie and let John practice”) that directly follows the portion of text portion 610c that computer system 600 output at FIG. 6R. At FIG. 6S, hand 612 transitions from a position where the index finger is perpendicular to computer system 600 to a position where the index finger of hand 612 is parallel to computer system 600.

As illustrated in FIG. 6T, hand 612 is in a position where the index finger of hand 612 is parallel to computer system 600 and is over text portion 610a. At FIG. 6T, a determination is made that hand 612 is positioned over text portion 610a (e.g., because the location setting of the text detection mode is set to “over.” Because a determination is made that hand 612 is positioned over text portion 610a while the location setting of the text detection mode is set to “over,” computer system 600 identifies text portion 610a as the targeted text and outputs speech audio corresponding to a portion of text portion 610a (e.g., “There once was a small boy named John. John loved to play soccer and”), using one or more techniques described above in relation to FIG. 6G.

FIG. 7 is a flow diagram illustrating a method (e.g., method 700) for managing a text detection mode in accordance with some examples. Some operations in method 700 are, optionally, combined, the orders of some operations are, optionally, changed, and some operations are, optionally, omitted.

As described below, method 700 provides an intuitive way for managing a text detection mode. Method 700 reduces the cognitive burden on a user for managing a text detection mode, thereby creating a more efficient human-machine interface. For battery-operated computing devices, enabling a user to manage a text detection mode faster and more efficiently conserves power and increases the time between battery charges.

In some examples, method 700 is performed at a computer system (e.g., 600) that is in communication with one or more output devices (e.g., a display generation component (e.g., a display screen and/or a touch-sensitive display), a speaker, eccentric rotating mass actuator, and/or a gyroscope). In some examples, the computer system is a watch, a phone, a tablet, a processor, a head-mounted display (HMD) device, and/or a personal computing device. In some examples, the computer system is in communication with one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button). In some examples, the computer system is in communication with a display generation component (e.g., a display screen and/or touch-sensitive display).

At 702, while detecting (e.g., capturing, obtaining, and/or acquiring) image data (e.g., previously captured image data and/or live image data from a field of view of one or more cameras that are in communication (e.g., wired communication and/or wireless communication (e.g., Bluetooth, Wi-Fi, and/or Ultra-Wideband) with the computer system)) that includes a first portion (e.g., 610a-610c) of text (e.g., one or more letters, symbols, sentences, paragraphs, and/or numbers) and a second portion (610a-610e) of text (e.g., one or more letters, symbols, sentences, paragraphs, and/or numbers) (e.g., the second portion of text is different and/or distinct from the first portion of text), the computer system detects a first input (e.g., 612) (e.g., a body part of a user (e.g., head, finger, toc, and/or arm), an object that is pointing at a respective location and/or at a location that corresponds to the respective location, a laser pointer, another type of pointer, and/or a gaze input) at a respective location (e.g., at a location in an environment that surrounds the computer system and/or an environment that is within the field of view of one or more cameras that are in communication with the computer system).

At 704, in response to detecting the first input (e.g., 612) at the respective location (and, in some examples, while the input is detected at the respective location) and in accordance with (e.g., at 706) a determination that the computer system (e.g., 600) is (e.g., and/or a user configurable setting, a setting of a computer system, and/or a setting for a mode (e.g., a point and speak mode and/or a point and output audio corresponding to text mode) in which the computer system is configured to be in is in a first state) (e.g., and/or a setting corresponding to the input being positioned in a first manner (e.g., above, below, underneath, and/or over a body part) relative to the first portion of text and/or the second portion of text) (and/or another computer system different from the computer system and/or that is in communication with the computer system is) in a first state (e.g., indicated by 618a-618c) (e.g., an active state or a non-active state) (e.g., above, below, underneath, and/or over a body part), the computer system provides, via the one or more output devices, first output (e.g., 640 and/or set of one or more inputs) (e.g., visual output, auditory output, and/or haptic output) corresponding to the first portion (610a-610c) of text without providing first output (e.g., 640 and/or set of one or more inputs) corresponding to the second portion (610a-610c) of text.

At 704, in response to detecting the first input (e.g., 612) at the respective location and in accordance with (at 708) a determination that the computer system (e.g., 600) is in a second state (e.g., indicated by 618a-618c) (e.g., above, below, underneath, and/or over a body part) different from the first state, the computer system provides, via the one or more output devices, the first output (e.g., 640 and/or set of one or more inputs) (e.g., visual output, auditory output, and/or haptic output) corresponding to the second portion (610a-610e) of text without providing the first output (e.g., 640 and/or set of one or more inputs) corresponding to the first portion (610a-610c) of text. In some examples, the first portion of text and the second portion of text include text from a first language and text from a second language. In some examples, the first portion of text and the second portion of text are in the same sentence, paragraph, and/or page. In some examples, the computer system is configured to operate in the second state or the first state. In some examples, the output includes multiple modalities (e.g., a haptic modality, a visual modality, and/or an audio modality). In some examples, the computer system detects a body part in the field of view of the one or more cameras. In some examples, the position of the body part is relative to a portion of text. In some examples, in response to detecting the body part in the field of view of the one or more cameras, the computer system displays a user interface that includes a representation of the text that was not previously displayed (e.g., before the body part was detected in the field of view of the one or more cameras). In some examples, displaying the user interface includes: in accordance with a determination that the user interface (and/or the computer system) is being displayed in a first orientation, automatically updating the representation of the text over a period of time, such that a first representation of the text is replaced with a second representation of the text over the period of time and in accordance with a determination that the user interface is being displayed in a second orientation different from the first orientation, the computer system does automatically update the representation of the text. In some examples, while the computer system in a first mode, the computer system detects a body part in the field of view of the one or more cameras. In some examples, the body part is positioned relative to a portion of text. In some examples, in response to detecting the body part in field of view of the one or more cameras: in accordance with a determination that the body part corresponds to a first user, the computer system provides output corresponding to the portion of text and in accordance with a determination that the body part does not correspond to the first user (and/or corresponds to a second user different from the first user), the computer system forgoes providing output corresponding to the portion of text. In some examples, while the computer system is in a first mode, the computer system detects an object (e.g., as described above in relation to methods 700 and/or 900) in the field of view of the one or more cameras. In some examples, in response to detecting the object in the field of view of the one or more cameras: in accordance with a determination that an appearance of the object is a first appearance (and, in some examples, while in the field of view of the one or more cameras), the computer system provides an output corresponding to the portion of text and in accordance with a determination that the appearance of the object is a second appearance different from the first appearance (and, in some examples, while in the field of view of the one or more cameras), the computer system displays an indication that includes instructions to adjust the appearance of the object (e.g., to the first appearance, another appearance, an appearance that has one or more characteristics of the first appearance, and/or an appearance that does not have one or more characteristics of the second appearance). Providing output that corresponds to a particular portion of text in response to detecting the first input allows the computer system to automatically indicate to a user whether the computer system is in the first state or the second state and/or the positioning of the first input relative to the first and/or second portion of text, thereby performing an operation when a set of conditions has been met without requiring further user input and providing improved feedback. Providing output that corresponds to a particular portion of text in response to detecting the first input allows the user more control over the computer system to determine what output is provided, thereby providing the user with one or more control options without cluttering the user interface. In some examples, in response to detecting the first input (e.g., 612) at the respective location: in accordance with a determination that the computer system (e.g., 600) is in the first state, the computer system displays a first indication (e.g., 634) (e.g., as part of providing output the first output corresponding to the first portion of text) (e.g., a bounding box, a set of one or more contiguous lines, and/or a set of one or more non-contiguous lines) (e.g., the indication is displayed based on a first respective setting of the computer system being active and the color of the indication is based on a second respective setting of the computer system) at one or more locations corresponding to the first portion (610a-610e) of text without displaying the indication at one or more locations corresponding to the second portion (610a-610e) of text. In some examples, the computer system is in communication with a display generation component (e.g., a display, a projector, a touch-sensitive display, and/or a screen). In some examples, displaying the indication at one or more locations corresponding to the first portion of text without displaying the indication at the indication at one or more locations corresponding to the second portion of text includes displaying the indication around (e.g., around the entirety of the first portion of text or around a portion of the first portion of text), next to (e.g., the second portion of text and/or another portion of text), closer to (e.g., than the second portion of text and/or another portion of text), nearer to (e.g., than the second portion of text and/or another portion of text), overlaid on, and/or on top of the first portion of text without displaying the indication around (e.g., around the entirety of the first portion of text or around a portion of the first portion of text), next to (e.g., than the first portion of text and/or another portion of text), closer to (e.g., than the first portion of text and/or another portion of text), nearer to (e.g., than the first portion of text and/or another portion of text), overlaid on, and/or on top of the first portion of text. In some examples, in accordance with a determination that the computer system (e.g., 600) is in the second state, the computer system displays the first indication at one or more locations corresponding to (e.g., as part of providing the first output corresponding to the second portion of text) (e.g., around the entirety of the second portion of text or around a portion of the second portion of text) the second portion of text without displaying the indication at one or more locations corresponding to the first portion of text. In some examples, the computer system displays the indication with a color that is different from the first portion of text and/or the second portion of text. In some examples, the computer system ceases to display the indication in response to the computer system ceasing to detect the first input. In some examples, the computer system continues to display the indication in response to the computer system ceasing to detect the first input. In some examples, the computer system displays the indication around and/or at one or more locations corresponding the first portion of text and the second portion of text. In some examples, in response to detecting the first input at the respective location, the computer system does not display (and/or forgoes displaying) the indication around the first portion of text or the second portion of text. In some examples, displaying the indication at one or more locations corresponding to the second portion of text without displaying the indication at one or more locations corresponding to the first portion of text includes displaying the indication around (e.g., around the entirety of the second portion of text or around a portion of the second portion of text), next to (e.g., than the first portion of text and/or another portion of text), closer to (e.g., than the first portion of text and/or another portion of text), nearer to (e.g., than the first portion of text and/or another portion of text), overlaid on, and/or on top of the first portion of text without displaying the indication around (e.g., around the entirety of the second portion of text or around a portion of the second portion of text), next to (e.g., than the second portion of text and/or another portion of text), closer to (e.g., than the portion of text and/or another portion of text), nearer to (e.g., than the second portion of text and/or another portion of text), overlaid on, and/or on top of the first portion of text. In some examples, in accordance with a determination that computer system is in another state (e.g., different from the first state and the second state), the computer system does not display the indication. Displaying the first indication at a particular location based on the state computer system allows the computer system to automatically perform a display operation that indicates to the user whether the computer system is in the first state or the second state and/or whether the first portion of text or the second portion of text is being targeted by the computer system, thereby performing an operation when a set of conditions has been met without requiring further user input and providing improving visual feedback to the user.

In some examples, providing the first output (e.g., 640 and/or set of one or more inputs) corresponding to the first portion (610a-610e) of text without providing the first output (e.g., 640 and/or set of one or more inputs) corresponding to the second portion (610a-610c) of text includes displaying a representation (e.g., 626) (e.g., a textual representation and/or a graphical representation) of the first portion of text (e.g., the representation of the first portion of text corresponds to one or more words and/or symbols that are included in the first portion of text) without displaying a representation (e.g., 626) of the second portion of text. In some examples, providing the first output corresponding to the second portion of text without providing the first output corresponding to the first portion of text includes displaying the representation (e.g., a textual representation and/or a graphical representation) of the second portion of text (e.g., the representation of the first portion of text corresponds to one or more words and/or symbols that are included in the first portion of text) without displaying the representation of the first portion of text. In some examples, the computer system does not display the representation of the first portion of text and/or the representation of the second portion of text as overlaid on top of the first input. In some examples, the computer system provides output (e.g., audible output and/or haptic output) corresponding to text without displaying the representation corresponding to text in accordance with a determination that the computer system is in the first state and/or the second state when a particular setting (e.g., a textual representation and/or text output setting) is inactive. Displaying a representation of a particular portion of text without displaying a representation of a another portion of text allows the computer system to automatically perform a display operation that indicates to the user whether computer system is in the first state or the second state and/or whether the computer system is targeting the first portion of text or the second portion of text, thereby performing an operation when a set of conditions has been met without requiring further user input.

In some examples, in accordance with a determination that the computer system (e.g., 600) (e.g., and/or a user interface that the computer system displays) is in a first orientation (e.g., as described in relation to FIGS. 6F-6G) (e.g., portrait orientation, landscape orientation, or diagonal orientation), displaying the representation of the first portion (610a-610e) of text includes automatically (e.g., without intervening user input) updating (e.g., vertically scrolling, diagonally scrolling, and/or horizontally scrolling) (e.g., changing the size of the first portion of text, changing the color of the first portion of text, changing the font of the first portion of text, long-scrolling the first portion of text, fixed long-scrolling the first portion of text, infinite scrolling the first portion of text, parallax scrolling the first portion of text, and/or marquee scrolling the first portion of text) the representation (e.g., 626) of the first portion of text over a period of time (e.g., 1-120 seconds). In some examples, automatically updating, without and/or irrespective of intervening input, the representation of the first portion of text over the period of time includes displaying a first subset of the first portion of text at a first instance in time and displaying a second subset of the first portion of text at a second instance in time, where the second subset was not displayed at the first instance in time. In some examples, in accordance with a determination that computer system (e.g., 600) is in a second orientation (e.g., as described in relation to FIGS. 6K-6J) (e.g., portrait orientation, landscape orientation, or diagonal orientation) different (and/or distinct) from the first orientation, displaying the representation of the first portion of text includes forgoing automatically updating the representation of the first portion of text over the period time. In some examples, while the computer system is in the second orientation, the computer system updates the representation of the first portion of text over the period of time in response to detecting an input corresponding to selection of the representation of the first portion of text. Updating the representation of the first portion of text over a period of time based on determining that the computer system is in a particular orientation allows the computer system to automatically present different portions of the first portion of text to the user such that at least some of the first portion of text is presented to the user over the period of time, thereby performing an operation when a set of conditions has been met without requiring further user input.

In some examples, after providing the first output corresponding to the first portion of the text (e.g., or while providing the first output corresponding to the first portion of the text) (and/or after providing the first output that corresponding to the second portion of text), the computer system detects a second input (e.g., 612) at a second respective location different from the respective location (and, in some examples, detecting movement of the first input from the respective location to a second respective location that is different (e.g., the second location is above, below, to the right, to the left, and/or under the respective location in a physical environment) from the respective location). In some examples, in response to detecting the second input (e.g., 612) at the second respective location: in accordance with a determination that the computer system (e.g., 600) is in the first state (e.g., indicated by 618a-618c), the computer system provides, via the one or more output devices, second output (e.g., audio, visual, and/or haptic output) corresponding to the second portion (610a-610e) of text without providing second output corresponding to the first portion (610a-610e) of text. In some examples, in accordance with a determination that the computer system is in the second state (e.g., indicated by 618a-618c) (e.g., and not the first state), the computer system provides, via the one or more output devices, the second output (e.g., audio, visual, and/or haptic output) corresponding to the first portion of text without providing the second output corresponding to the second portion of text. In some examples, detecting the second input at the second respective location includes detecting movement of a body part of a user (e.g., head, eye(s), finger(s), hand(s), and/or torso) from the respective location to the second respective location. In some examples, detecting the second input includes detecting movement of an object (e.g., a point, an inanimate object, a virtual object, and/or a physical object) (e.g., an object that is moved by a user and/or another computer system). In some examples, the computer system ceases providing the first output corresponding to the first portion of text or the first output corresponding to the second portion of text as a part of providing the second output corresponding to the second portion of text. In some examples, the first output corresponding to the first portion of text and the second output corresponding to the first portion of text are the same or different. In some examples, the second output that corresponding to the second portion of text and the first output corresponding to the first portion of text are the same or different. In some examples, the computer system detects movement of the first input from the respective location to the second location via one or more cameras and/or one or more sensors that are in communication (e.g., wireless communication and/or wired communication) with the computer system. Providing second output corresponding to a first particular portion of text without providing second output corresponding to a second particular portion of text allows the computer system to automatically provide an output that indicates both the state of the computer system and the positioning of the second input relative to the first portion of text and/or the second portion of text, thereby performing an operation when a set of conditions has been met without requiring further user input.

In some examples, in response to detecting the second input (e.g., 612) at the second respective location and in accordance with a determination that the computer system (e.g., 600) is in the first state, the computer system displays a second indication (e.g., 626 and/or 634) (e.g., that was not previously displayed) (e.g., a set of one or more contiguous lines or a set of one or more non-contiguous lines) at one or more locations (e.g., around the entire second portion of text or around a portion of the second portion of text) corresponding to (e.g., as part of providing the first output corresponding to the second portion of text) (e.g., around the entirety of the second portion of text or around a portion of the second portion of text) the second portion (610a-610c) of text without displaying the second indication at one or more locations corresponding to the first portion (610a-610c) of text. In some examples, in response to detecting the second input (e.g., 612) at the second respective location and in accordance with a determination that the computer system is in the second state, the computer system displays the second indication (e.g., as part of providing output the first output corresponding to the first portion of text) (e.g., a bounding box, a set of one or more contiguous lines, and/or a set of one or more non-contiguous lines) (e.g., the indication is displayed based on a first respective setting of the computer system being active and the color of the indication is based on a second respective setting of the computer system) at one or more locations (e.g., around the entire first portion of text or around a portion of the first portion of text) corresponding to the first portion of text without displaying the second indication at one or more locations corresponding to the second portion of text. In some examples, the computer system ceases to display the second indication in response to ceasing to detect the first input. In some examples, the computer system ceases to display the second indication in response to ceasing to detect the first input at the second location. In some examples, the computer system continues to display the second indication in response to ceasing to detect the first input. In some examples, the computer system displays the second indication with a color that is different and/or distinct from the color the second portion of text. Displaying the second indication at a particular location based on the state of the computer system allows the computer system to automatically perform a display operation that indicates to the user whether the computer system is in the first state or the second state and indicates to the user which portion of text the computer system is presently targeting, thereby performing an operation when a set of conditions has been met without requiring further user input and providing improved visual feedback.

In some examples, before detecting the second input at the second respective location (e.g., and in accordance with a determination that the computer system is in the first state and in response to detecting the first input), the computer system displays a third indication (e.g., 634) (e.g., as described above in relation to the first indication) at one or more locations corresponding to the first portion (610a-610e) of text. In some examples, in response to detecting the second input at the second respective location and in accordance with a determination that the computer system (e.g., 600) is in the second state (e.g., as indicated by 618a-618c), the computer system ceases to display the third indication. In some examples, before detecting the second input at the second respective location (e.g., and in accordance with a determination that the computer system is in the second state and in response to detecting the first input), displaying a fourth indication (e.g., as described above in relation to the first indication) at one or more locations corresponding to the first portion of text. In some examples, in response to detecting the second input at the second respective location and in accordance with a determination that the computer system is in the first state, ceasing to display the fourth indication. Ceasing to display the third indication in response to detecting the second input at the second respective location and based on a determination that the computer system is in the second state provides the user with the ability to control a display operation of the computer system without selecting a control and allows the computer system to automatically indicate the state of the computer system, thereby providing the user with one or more control options without cluttering the user interface and providing improved feedback.

In some examples, before detecting the second input at the second location, the computer system displays a representation (e.g., a textual representation and/or a graphical representation) of first text (e.g., 610a-610c) (e.g., the representation of text corresponds to the first portion of text and/or the second portion of text). In some examples, in response to detecting the second input at the second respective location, the computer system displays a representation (e.g., 626) of second text (e.g., 610a-610c) different from the representation of the first text. In some examples, the first text is different (e.g., includes different numbers, characters, symbols, sentences and/or paragraphs) from the second text. In some examples, in response to detecting the second input at the second respective location, the computer system changes the appearance (e.g., the content, size, font, and/or color) of the representation of text from a first appearance to a second appearance different (e.g., different content, different size, different font, and/or different color) from the first appearance. In some examples, the computer system displays the representation of the second text as part of providing the second output corresponding to the first portion of text and/or the second output corresponding to the second portion of text. In some examples, the computer system changes the appearance of the representation of text before or after providing output corresponding to the first portion of text and/or the second portion of text. In some examples, the computer system ceases to display the representation of the first text in response to detecting the second input. Displaying a representation of second text different from the representation of the first text provides the user with the ability to control a display operation of the computer system without requiring that the computer system display a respective control, thereby providing the user with one or more control options without cluttering the user interface.

In some examples, detecting the first input at the respective location includes detecting that the first portion (610a-610e) of text is positioned under (e.g., under a pad of a finger) (e.g., that the first portion of text is detected as being under the first input) the first input (e.g., all and/or most of the first portion of text is positioned over the first input or a portion of the first portion of text is positioned under the first input).

In some examples, detecting the first input at the respective location includes detecting that the second portion (610a-610e) of text is positioned above (e.g., above a fingertip and/or edge of finger) the first input (e.g., all and/or most of the second portion of text is positioned at the first input or a portion of the second portion of text is positioned above the first input).

In some examples, after providing the first output corresponding to the first portion of text without providing output corresponding to the second portion (610a-610e) of text, the computer system detects (e.g., via a microphone, one or more cameras and/or a touch-sensitive display) a request (e.g., a voice command, mouse click, tap input, double tap, swipe input, hand input (e.g., an air tap and/or an air swipe), and/or rotation of a rotatable input mechanism) to change the state of the computer system (e.g., 600) from the first state to the second state (e.g., as indicated by 618a-618c). In some examples, in response to detecting the request (e.g., 605d) to change the state of the computer system from the first state to the second state, the computer system changes the state of the computer system from the first state to the second state. In some examples, while the computer system is in the second state, the computer system detects a third input (e.g., 612) at the respective location (e.g., the third input and the first input are the same types of inputs or different types of inputs). In some examples, in response to detecting the third input at the respective location, the computer system provides, via the one or more output devices, a third output (e.g., 640) (e.g., visual, haptic, and/or audio output) (e.g., the third output is different and/or distinct from the first output corresponding to the second portion of text) corresponding to the second portion of text without providing a third output (e.g., 640) corresponding to the first portion of text. In some examples, after providing the third output corresponding to the second portion of text, the computer system detects a request to change the state of the computer system from the second state to the first state, and in response to detecting the request, the computer system changes the state of the computer system to the first state. In some examples, while the computer system is in the first state, the computer system detects a respective input at the respective location, and in response to detecting the respective input, the computer system provides output corresponding to the second portion of text. Providing a third output corresponding to the second portion of text without providing a third output corresponding to the first portion of text in response to detecting the third input at the respective location in response to detecting an input allows the user to control an output operation of the computer system without requiring that the computer system displaying a respective control and allows the computer system to indicate to the user the state of the computer system (e.g., that the computer system detected the third input), thereby providing the user with one or more control options without cluttering the user interface and providing improved sensory feedback.

In some examples, in response to detecting the first input (e.g., 612) at the respective location and in accordance with a determination that the computer system (e.g., 600) is in a third state (e.g., the third state corresponds to a detection setting (e.g., a text detection setting, a voice detection setting, a human detection setting and/or an inanimate object detection setting) of the computer system) (e.g., the third state is different and/or distinct from the second state and/or the first state) different from the first state and the second state, the computer system forgoes providing output corresponding to text (e.g., and/or output corresponding to the first portion of text or the second portion of text). In some examples, in response to detecting the first input at the respective location and in accordance with a determination that computer system is in the third state, the computer system provides a respective output that does not correspond to the first portion of text and/or the second portion of text.

In some examples, in response to detecting the first input (e.g., 612) at the respective location and in accordance with a determination that the computer system (e.g., 600) is in a fourth state (e.g., full screen reader mode (e.g., a mode where text occupies the majority of a display of the computer system) a text detection mode, and/or a voice over mode) (e.g., the fourth state is different and/or distinct from the first state and/or the second state), the computer system provides, via the one or more output devices, output (e.g., 640) (e.g., visual, haptic, and/or auditory) corresponding to the first portion (610a-610e) of text and the second portion (610a-610e) of text. In some examples, the output includes speech, a voice, an audible sound, and/or text corresponding to the first portion before or after the second portion. In some examples, the computer system provides a reading and/or a summary of the first portion of text and/or the second portion of text. Providing output corresponding to the first portion of text and the second portion of text in response to detecting the first input at the respective location and based on a determination that the computer system is in the fourth state allows the computer system to automatically perform an output operation that indicates to the user the state of the computer system (e.g., the computer system detected the first input) and whether the computer system is in the first state or the second state, thereby performing an operation when a set of conditions has been met without requiring further user input and providing improved feedback.

In some examples, the computer system (e.g., 600) is in communication with one or more speakers. In some examples, providing the first output corresponding to the first portion (610a-610c) of text without providing the first output (e.g., 640) corresponding to the second portion (610a-610e) of text includes causing the one or more speakers to output audio (e.g., 640) (e.g., a voice (e.g., a voice corresponding to a smart assistant and/or a voice corresponding to a user of the computer system), a discrete tone, a media item (e.g., a song and/or movie), and/or a repeating tone) corresponding to the first portion of text (e.g., the output reads the first portion of text, the output summarizes the first portion of text, the output indicates the source of the first portion of text, the output indicates an author of the first portion of text, and/or the output indicates a publication corresponding to the first portion of text). Outputting audio that corresponds to the first portion of text in response to detecting the first input at the respective location allows the computer system to deliver the content of the text to a user in a particular manner, thereby providing improved feedback.

In some examples, in accordance with a determination that a state of a language setting (e.g., the language setting indicates a default language setting of the computer system, a default accent of the output, a user selected accent of the output, and/or a user defined language setting) corresponds to a first language (e.g., English, American English, Spanish, Swahili, and/or British English), the output includes a translation of the first portion (610a-610c) of text into the first language (e.g., and not translating the second portion of text) (e.g., as described above in relation to FIGS. 6B-6C). In some examples, in accordance with a determination that the state of the language setting corresponds to a second language (e.g., English, American English, Spanish, Swahili, and/or British English) different from the first language, the output includes a translation of the first portion (610a-610e) of text into the second language (e.g., as described above in relation to FIGS. 6B-6C). In some examples, the output includes a translated version of the first portion of text and a non-translated version of the first portion of text. In some examples, the output includes a translation of the first portion of text into two or more languages. Translating the portion of text into a particular language allows the computer system to automatically deliver content to a user in a preferred language of the user, thereby performing an operation when a set of conditions has been met without requiring further user input.

In some examples, in accordance with a determination that the first portion (610a-610c) of text corresponds to a third language (e.g., English, Spanish, Portuguese, Russian, and/or Italian), the output is provided using a first voice corresponding to the third language (e.g., the computer system provides the first voice with a unique accent, language, articulation, inflection, tone, pronunciation, and/or diction corresponding to the third language) (e.g., as described above in relation to FIGS. 6B-6C). In some examples, in accordance with a determination that the first portion (610a-610e) of text corresponds to a fourth language (e.g., English, Spanish, Portuguese, Russian, and/or Italian) that is different from the third language, the output is provided using a second voice corresponding to the fourth language (e.g., the computer system provides the second voice with a unique accent, language, articulation, inflection, tone, pronunciation, and/or diction corresponding to the fourth language) (e.g., as described above in relation to FIGS. 6B-6C). In some examples, the second voice is different (e.g., and/or distinct) than the first voice. In some examples, the first portion of text corresponds to the third language and the fourth language. In some examples, the output has the first voice corresponding to the third language and the second voice corresponding to the fourth language. In some examples, the first portion of text corresponds to the language and does not correspond to the third language, or vice versa. In some examples, the output corresponds to the first voice and does not correspond to the second voice, or vice versa. Providing the output in a particular voice based on the language of the portion of text allows the computer system to automatically deliver content to a user in a voice that is adapted to a particular language, thereby performing an operation when a set of conditions has been met without requiring further user input.

In some examples, while the computer system (e.g., 600) is in the first state (e.g., as indicated by 618a-618c) (or in the second state) (and, in some examples, after providing output corresponding to the first portion of text without providing output corresponding to the second portion of text) (or, in some examples, while the computer system is in the second state and after providing output corresponding to the second portion of text without providing output corresponding to the first portion of text), the computer system detects (e.g., one or more cameras, a sensor, and/or touch sensitive display) a fourth input (e.g., 612) (e.g., a tap input, a double tap input, a swipe input, a hand input (air swipe and/or air tap), a rotation of a rotatable input mechanism, and/or a voice command) at the respective location. In some examples, in response to detecting the fourth input at the respective location: in accordance with a determination that the fourth input corresponds to a first user (e.g., a primary user of the computer system, the owner of the computer system, and/or a user corresponding to a user account that is associated with the computer system) (e.g., as described above in relation to FIGS. 6R-6S), the computer system provides, via the one or more output devices, a fourth output (e.g., 640) (e.g., audio, haptic, and/or visual output) (e.g., the fourth output is different and/or distinct from the first output or the fourth output and the first output are the same) (e.g., fourth output corresponding to the first portion of text without providing a fourth output corresponding to the second portion of text); in accordance with a determination that the fourth input corresponds to a second user (e.g., 646) (e.g., a non-user of the computer system, a non-owner of the computer system, and/or a user corresponding to a user account that is not associated with the computer system) that is different than the first user (e.g., as described above in relation to FIGS. 6R-6S), the computer system forgoes providing the fourth output. In some examples, in response to detecting the fourth input and in accordance with a determination that the fourth input corresponds to the second user, the computer system displays an indication that the computer system does not recognize the input. In some examples, the computer system detects the fourth input at the respective location while the computer system provides the first output corresponding to the first portion of text. In some examples, the computer system ceases to provide the first output corresponding to the first portion of text as a part of providing the output corresponding to the first portion of text. Providing a fourth output in response to detecting the fourth input based on whether the fourth input corresponds to a particular user allows the computer system to selectively perform an output operation for only authorized users, thereby providing improved security.

In some examples, while the computer system (e.g., 600) is in the first state (or in the second state) (and, in some examples, after providing output corresponding to the first portion of text without providing output corresponding to the second portion of text) (or, in some examples, while the computer system is in the second state and after providing output corresponding to the second portion of text without providing output corresponding to the first portion of text) (e.g., as described above in relation to FIGS. 6S-6T), the computer system detects a fifth input (e.g., 612 at FIG. 6S or FIG. 6T) (e.g., a body part of a user (e.g., head, finger, toe, and/or arm), an object that is pointing at a respective location and/or at a location that corresponds to the respective location, a laser pointer, another type of pointer, and/or a gaze input) at the respective location. In some examples, in response to detecting the fifth input at the respective location: in accordance with a determination that the fifth input has a first appearance (e.g., 612 in FIG. 6T) (and, in some examples, while in the field of view of the one or more cameras) (e.g., the input is positioned in a respective orientation, the input is positioned in a respective configuration, size, and/or color), the computer system provides, via the one or more output devices, a fifth output (e.g., audio, visual, and/or haptic output) (e.g., corresponding to the first portion of text without providing a fifth output corresponding to the second portion of text) (e.g., as described above in relation to FIGS. 6R-6S); in accordance with a determination that the fifth input has a second appearance (e.g., 612 in FIG. 6S) different from the first appearance (and, in some examples, while in the field of view of the one or more cameras), the computer system displays, via the one or more input devices, an indication (e.g., 632) that includes instructions to adjust the appearance of the input (e.g., to the first appearance, another appearance, an appearance that has one or more characteristics of the first appearance, and/or an appearance that does not have one or more characteristics of the second appearance) without providing the fifth output (e.g., as described above in relation to FIGS. 6R-6S). In some examples, the indication to adjust the appearance of the input includes an indication to make the input parallel to the computer system, a display generation component, and/or a display. In some examples, in response to detecting the fifth input at the respective location and in accordance with a determination that the fifth input has a first appearance, the computer system provides, via the one or more output devices, the fifth output without displaying the indication that includes instructions to adjust the appearance of the input. Providing an indication that includes instructions to adjust the appearance of the input based on the appearance of an input allows the computer system to automatically provide guidance to a user such that the user can correctly utilize a function of the computer system, thereby performing an operation when a set of conditions has been met without requiring further user input.

Note that details of the processes described above with respect to method 700 (e.g., FIG. 7) are also applicable in an analogous manner to other methods described herein. For example, methods 900 and 1000 optionally include one or more of the characteristics of the various methods described above with reference to method 700. For example, automatically scrolling text based on the orientation of the computer system can be integrated into method 900 and/or method 1000. For brevity, these details are not repeated below.

FIGS. 8A-8R illustrate exemplary user interfaces for detecting targeted text in accordance with some examples. The user interfaces in these figures are used to illustrate the processes described below, including the processes in FIG. 9.

As illustrated in FIG. 8A, computer system 600 displays live feed 606 within viewer user interface 602. Live feed 606 is a representation of the field of view of one or more cameras that are in communication (e.g., wired communication and/or wireless communication) with computer system 600. At FIG. 8A, a hand of a user and a book are within the field of view of the one or more cameras. Accordingly, as illustrated in FIG. 8A, computer system 600 displays book 842 and hand 612 within live feed 606.

Computer system 600 activates (e.g., such that computer system 600 is configured to operate in and/or perform one or more actions associated with) a text detection mode at FIG. 8A (e.g., in response to computer system 600 detecting an input at a previous point in time, such as input 605a discussed above in relation to FIG. 6A). As illustrated in FIG. 8A, because computer system 600 activates the text detection mode, computer system 600 displays text detection mode notification 628 within viewer user interface 602. Further, at FIG. 8A, a determination is made that hand 612 is within the field of view of the one or more cameras that are in communication with computer system 600. Because a determination is made that hand 612 is within the field of view of the one or more cameras, as illustrated in FIG. 8A, computer system 600 displays hand detected notification 630 within viewer user interface 602. In some examples, computer system 600 displays hand detected notification 630 in response to detecting a respective hand in the field of view of the one or more cameras and based on whether the respective hand satisfies a set of one or more criteria (e.g., the respective hands correspond to a primary user (e.g., an owner of computer system 600 and/or an authorized user of computer system 600), the respective hand is within a predetermined distance (e.g., 0.1-15 feet) from computer system 600, the respective hand has a certain appearance and/or is in a certain hand position and/or pose, and/or the respective hand is centered within the field of view of the one or more cameras).

FIG. 8B illustrates a detailed view of viewer user interface 602 and the portions of text included in book 842. As illustrated in FIG. 8B, book 842 includes text portion 810a, text portion 810b, and text portion 810c (e.g., “DOG BONES MAGAZINE”). At FIG. 8B, the one or more cameras are capturing text portion 810a, text portion 810b, and text portion 810c. Each of text portion 810a, text portion 810b, and text portion 810c are portions of text included in a book (e.g., book 842) being captured by the one or more cameras. Accordingly, both the book and the respective text portions are positioned at a location within an environment that is within in the field of view of the one or more cameras. At FIG. 8B a location setting of the text detection mode of computer system 600 is set to “over.” As discussed above (e.g., in relation to FIGS. 6A-6T), while the location setting of the text detection mode is set to “over,” computer system 600 identifies text that hand 612 is positioned over (e.g., at and/or hovering over) as targeted text. As illustrated in FIG. 8B, hand 612 is positioned over text portion 810c (e.g., “DOG BONES MAGAZINE”). At FIG. 8B, a determination is made that hand 612 (e.g., the index finger of hand 612) is positioned over text portion 810c (e.g., “DOG BONES MAGAZINE”) (and, in some examples, because the location setting of the text detection mode is set to “over”). Because a determination is made that hand 612 is positioned over text portion 810c (e.g., “DOG BONES MAGAZINE”) while the location setting of the text detection mode is set to “over,” computer system 600 identifies text portion 810c (e.g., “DOG BONES MAGAZINE”) as targeted text. In response to computer system 600 identifying text portion 810c (e.g., “DOG BONES MAGAZINE”) as the targeted text, computer system 600 outputs a set of outputs. At FIG. 8B, the set of outputs, including at least the portion of speech output 640 that corresponds to text portion 810c (e.g., “DOG BONES MAGAZINE”) (e.g., as discussed above in relation to FIGS. 6B and 6C). In some examples, computer system 600 identifies text portion 810c (e.g., “DOG BONES MAGAZINE”) as targeted text because a determination is made that hand 612c is over text portion 810c. In some examples, the text portions discussed throughout FIGS. 8A-8R are text portions captured by the one or more cameras, where a representation is displayed via computer system 600. In some examples, the one or more text portions are physical portions of text. In some examples, the one or more text portions are virtual text.

At FIG. 8B, as part of outputting the set of outputs, computer system 600 outputs haptic output 636 and audio output 638. Further, at FIG. 8B, as part of outputting the set of outputs, computer system 600 displays border indicator 634 around text portion 810c (e.g., “DOG BONES MAGAZINE”), and computer system 600 displays text portion 810c (e.g., “DOG BONES MAGAZINE”) within current text indicator 626. As discussed above, as part of outputting the set of outputs, computer system 600 outputs speech output 640. At FIG. 8B, speech output 640 corresponds to a reading (e.g., that is output by computer system 600) of text portion 810c (e.g., “DOG BONES MAGAZINE”). At FIG. 8B, hand 612 moves from being located over text portion 810c to under text portion 810c. In some examples, computer system 600 concurrently outputs each output of the set of outputs. In some examples, computer system 600 outputs two or more outputs of the set of outputs in a sequential manner.

As illustrated in FIG. 8C, hand 612 is positioned under text portion 810c (e.g., “DOG BONES MAGAZINE”). At FIG. 8C, a determination is made that hand 612 is positioned under text portion 810c (e.g., “DOG BONES MAGAZINE”) while the location setting of the text detection mode is set to “over.” At FIG. 8C, because a determination is made that hand 612 is positioned under text portion 810c (e.g., “DOG BONES MAGAZINE”) while the location setting of the text detection mode is set to “over,” computer system 600 does not identify text portion 810c (e.g., “DOG BONES MAGAZINE”) as targeted text. As illustrated in FIG. 8C, because of this determination, computer system 600 does not output a set of outputs that correspond to text portion 810c (e.g., “DOG BONES MAGAZINE”) (e.g., as indicated by speech output 640 not being present in FIG. 8C). In some examples, computer system 600 continues to output the set of outputs that correspond to targeted text in response to detecting that the positioning of hand 612 changes. At FIG. 8C, computer system 600 detects input 805c, which is directed to settings control 604a. In some examples, an input described herein, such as input 805c and/or another input, is a tap input, a long press, a swipe input, a voice command, and/or a hand input (e.g., an air tap and/or an air swipe). In some examples, an input described herein can be replaced with and/or added with another type of input than the type of input described herein with respect to the input.

As illustrated in FIG. 8D, in response to detecting input 805c, computer system 600 displays text detection settings user interface 614 (e.g., and ceases to display viewer user interface 602). As illustrated in FIG. 8D, because the location setting of the text detection mode is set to “over,” computer system 600 displays location selection indicator 618c within over location setting 618b. At FIG. 8D, computer system 600 detects input 805d directed to under location setting 618a.

At FIG. 8E, in response to detecting input 805d, computer system 600 changes the location setting of the text detection mode from “over” to “under.” Accordingly, as illustrated in FIG. 8E, computer system 600 displays location selection indicator 618c within (e.g., in a location corresponding to) under location setting 618a to indicate the change in the location setting. At FIG. 8E, computer system 600 detects input 805e directed to return control 624.

As illustrated in FIG. 8F, in response to detecting input 805e, computer system 600 displays viewer user interface 602 (e.g., and ceases to display text detection settings user interface 614). As illustrated in FIG. 8F, hand 612 is positioned under text portion 810c (e.g., “DOG BONES MAGAZINE”) (e.g., the same position that hand 612 was positioned in at FIG. 8C). At FIG. 8F, a determination is made that hand 612 is positioned under text portion 810c (e.g., “DOG BONES MAGAZINE”) (and, in some examples, because the location setting of the text detection mode is set to “under”). Because a determination is made that hand 612 is positioned under text portion 810c (e.g., “DOG BONES MAGAZINE”) while the location setting of the text detection mode is set to “under,” computer system 600 identifies text portion 810c (e.g., “DOG BONES MAGAZINE”) as targeted text. That is, computer system 600 identifies targeted text based on the position of hand 612 and the location setting of the text detection mode. More specifically, at FIG. 8C, hand 612 was positioned under text portion 810c (e.g., “DOG BONES MAGAZINE”). However, because the location setting of the text detection mode was set to “over” at FIG. 8C, computer system 600 did not identify text portion 810c (e.g., “DOG BONES MAGAZINE”) as targeted text at FIG. 8C and did not output a set of outputs that corresponds to identifying text portion 810c. To the contrary, at FIG. 8F, when a determination is made that hand 612 is detected under text portion 810c while the location setting of the text detection setting is set to “under,” computer system 600 identifies text portion 810c (e.g., “DOG BONES MAGAZINE”) as the targeted text and/or outputs the set of outputs that corresponds to identifying text portion 810c.

At FIG. 8F, in response to computer system 600 identifying text portion 810c (e.g., “DOG BONES MAGAZINE”) as targeted text, computer system 600 outputs a set of outputs that corresponds to identifying text portion 810c (e.g., “DOG BONES MAGAZINE”). At FIG. 8F, as part of outputting the set of outputs, computer system 600 outputs haptic output 636 and audio output 638. Further, at FIG. 8F, as part of outputting the set of outputs, computer system 600 displays border indicator 634 around text portion 810c (e.g., “DOG BONES MAGAZINE”) and displays text portion 810c within current text indicator 626. Additionally, as part of outputting the set of outputs, computer system 600 outputs speech output 640. At FIG. 8F, speech output 640 corresponds to a reading (e.g., that is output by computer system 600) of text portion 810c (e.g., “DOG BONES MAGAZINE”). Accordingly, at FIG. 8F, speech output 640 includes a reading of “Dog bones magazine.” At FIG. 8F, the position of hand 612 moves from being positioned under text portion 810c to being positioned over text portion 810c.

As illustrated in FIG. 8G, hand 612 is positioned over text portion 810c (e.g., “DOG BONES MAGAZINE”) (e.g., the same position that hand 612 was positioned in at FIG. 8B). At FIG. 8G, a determination is made that that hand 612 is positioned over text portion 810c (e.g., “DOG BONES MAGAZINE”). At FIG. 8G, because a determination is made that hand 612 is positioned over text portion 810c (e.g., “DOG BONES MAGAZINE”) while the location setting of the text detection mode is set to “under,” computer system 600 does not identify text portion 810c (e.g., “DOG BONES MAGAZINE”) as targeted text, and computer system 600 does not output a set of outputs that correspond to text portion 810c (e.g., “DOG BONES MAGAZINE”). As discussed above, computer system 600 identifies targeted text and/or outputs audio corresponding to text based on the positioning of hand 612 and the location setting of the text detection mode of computer system 600. At FIG. 8B, hand 612 was positioned over text portion 810c (e.g., “DOG BONES MAGAZINE”). However, because the location setting of the text detection mode was set to “over” at FIG. 8B, computer system 600 identified text portion 810c (e.g., “DOG BONES MAGAZINE”) as targeted text at FIG. 8B. To the contrary, at FIG. 8G, when a determination is made that hand 612 is detected over text portion 810c while the location setting of the text detection mode is set to “under,” computer system 600 does not identify text portion 810c (e.g., “DOG BONES MAGAZINE”) as targeted text and/or does not output the set of outputs corresponding to text portion 810c.

At FIG. 8G, the position of hand 612 moves from being over text portion 810c to being under text portion 810a. In some examples, based on a determination that hand 612 is not positioned over or under text portion 810c (e.g., “DOG BONES MAGAZINE”) (e.g., hand 612 is removed from text portion 810c), computer system 600 does not identify text portion 810c (e.g., “DOG BONES MAGAZINE”) as targeted text (e.g., and computer system 600 does not output a set of outputs that correspond to text portion 810c) and does not output the set of outputs corresponding to text portion 810c. In some examples, while the text detection mode is inactive, computer system 600 does not identify text portion 810c (e.g., “DOG BONES MAGAZINE”) as targeted text and does not output the set of outputs corresponding to text portion 810c based on a determination that hand 612 is positioned over or under text portion 810c (e.g., “DOG BONES MAGAZINE”).

As illustrated in FIG. 8H, hand 612 is positioned under a first segment of text portion 810a (e.g., because the location setting of the text detection mode is set to “under”). At FIG. 8H a determination is made that hand 612 is positioned under the first segment of text portion 810a (and, in some examples, because the location setting of the text detection mode is set to “under”). At FIG. 8H, because a determination is made that hand 612 is positioned under the first segment of text portion 810a while the location setting of the text detection mode is set to “under,” computer system 600 identifies text portion 810a as targeted text. At FIG. 8H, computer system 600 outputs a set of outputs in response to identifying text portion 810a as targeted text relative to an input (e.g., hand 612, an air gesture, a mouse, and/or a stylus). At FIG. 8H, computer system 600 outputs haptic output 636 and audio output 638 as part of outputting the set of outputs. Further, as illustrated in FIG. 8H, as part of outputting the set of outputs, computer system 600 displays border indicator 634 around text portion 810a, and computer system 600 displays a portion of text portion 810a (e.g., “Moose was a brown and white spotted dog who loved nothing more than going on walks. Every morning he would wake up with his tail wagging, ready to hit the pavement with his owner. He knew the exact route they would take and he”) within current text indicator 626. Furthermore, as part as outputting the set of outputs, computer system 600 outputs a portion of speech output 640 that includes a reading of text portion 810a. At FIG. 8H, hand 612 is moves to the left.

As illustrated in FIG. 8I, after hand 612 moves the left, hand 612 is positioned under a second segment of text (e.g., in comparison to the first segment of text hand 612 is under at FIG. 8H) of text portion 810a. Because the second segment of text is a part of the targeted text (e.g., text portion 810a), the second segment of text does not satisfy a set of one or more text criteria. At FIG. 8I, a determination is made that the second segment of text portion 810a does not satisfy the set of one or more text criteria with respect to the first segment of text portion 810a that hand 612 was positioned under (e.g., at FIG. 8H). At FIG. 8I, because a determination is made that the second segment of text portion 810a does not satisfy the set of one or more text criteria, computer system 600 continues to identify text portion 810a as the targeted text. In some examples, a respective segment of text satisfies the set of one or more text criteria when a determination is made that the respective segment of text is sufficiently different (e.g., different amount of characters, words, sentences, paragraphs, and/or symbols) from another segment of text. In some examples, the determination of whether the respective segment of text is sufficiently different from another segment of text is based on the context of text and whether there is a certain amount of character distance between at least two portions of text. Thus, in examples where the amount of text in live feed is in a first context (e.g., a list of items, a bulleted and/or non-bulleted list, a grocery list, and/or a calendar of items), the amount of character difference to identify that two portions of text are sufficiently different from each other than the amount of character difference that would be needed to identify that two portions of text are sufficiently different from each other in a different content (e.g., paragraphs of text in a book, magazine, and/or in a research paper). In some examples, the respective segment of text satisfies the set of one or more text criteria when a determination is made that the distance between the respective segment of text and another segment of text (e.g., a segment of text for which the computer system is concurrently providing output and/or previously provided output) is greater than a distance threshold (e.g., 0.1-100 cm). In some examples, based on a determination that the second segment of text satisfies the set of text criteria, computer system 600 provides a set of outputs that correspond to the second text segment.

At FIG. 8I, text portion 810a remains the targeted text because the determination was made that the second segment of text of that hand 612 does not satisfy the set of one or more text criteria. Accordingly, as illustrated in FIG. 8I, computer system 600 displays border indicator 634 around text portion 810a. Further, at FIG. 8I, because text portion 810 remains the targeted text, speech output 640 is a continuation of the reading of text portion 810a from FIG. 8H. At FIG. 8I, computer system 600 outputs speech output 640, which corresponds to a portion of text portion 810a (e.g., morning, he would wake up with his tail wagging, ready to hit the pavement with his owner. He knew the exact”) that directly follows the portion of text portion 810a that computer system 600 output at FIG. 8H. At FIG. 8I, hand 612 moves downward.

As illustrated in FIG. 8J, after hand 612 is moved downward, hand 612 is positioned under text portion 810b. At FIG. 8J, a determination is made that text portion 810b satisfies the set of one or more text criteria as described above (e.g., and/or a determination is made that hand 612 is positioned under text portion 810b) (e.g., a determination is made that text portion 810b is sufficiently different and/or spaced apart from the previous portion of targeted text) (e.g., and/or that hand 612 is positioned under text portion 810b) (e.g., while the location setting of the text detection mode is set to “under”). Because a determination is made that text portion 810b satisfies the set of one or more text criteria (e.g., and/or because a determination is made that hand 612 is positioned under text portion 810b while the location setting of the text detection mode is set to “under”), computer system 600 identifies text portion 810b as targeted text (e.g., and text portion 810a is no longer the targeted text). In some examples, a determination is made that text portion 810b satisfies the set of one or more text criteria as part of making the determination that hand 612 is positioned under text portion 810b. In some examples, computer system 600 identifies text portion 810b as the targeted text because a determination is made that text portion 810b satisfies the set of one or more text criteria.

At FIG. 8J, in response to identifying text portion 810b as the targeted text relative to an input (e.g., hand 612, an air gesture, a mouse and/or a stylus), computer system 600 outputs a set of outputs that correspond to text portion 810b. At FIG. 8J, as part of outputting the set of outputs, computer system 600 outputs haptic output 636 and audio output 638. In addition, as part of outputting the set of outputs, computer system 600 displays border indicator 634 around text portion 810b and computer system 600 displays a portion of text portion 810b (“Gracie was a dog who hated to go on walks. Every time her owner would try to take her outside, she would resist with all her might. Her tail would tuck between her legs, and she would whine and bark until her owner gave up. It was a strange”) within current text indicator 626. Further, as part of outputting the set of outputs, computer system 600 outputs speech output 640. At FIG. 8J, speech output 640 corresponds to a reading (e.g., that is output by computer system 600) of the first portion of text portion 810a. At FIG. 8J, computer system 600 detects input 605j directed at settings control 604a.

As illustrated in FIG. 8K, in response to detecting input 605j, computer system 600 displays point and speak settings user interface 614. As illustrated in FIG. 8K, sound control 616a, label control 616b, speech control 616c, and haptics control 616d are all active and automatic flashlight control 620a is inactive. At FIG. 8K, computer system 600 detects input 805kl directed to sound control 616a, input 805k2 directed to label control 616b, input 805k3 directed to haptics control 616d, input 805k4 directed to automatic flashlight control 620a, and input 805k5 directed at border control 622a. In some examples, computer system 600 detects a single input that is directed at sound control 616a, label control 616b, haptics control 616d and/or automatic flashlight control 620a.

At FIG. 8L, in response to detecting input 805kl, computer system 600 deactivates (e.g., turns off) sound control 616a. At FIG. 8L, in response to detecting input 805k2, computer system 600 deactivates label control 616b. At FIG. 8L, in response to detecting input 805k3, computer system 600 deactivates haptics control 616d. At FIG. 8L, in response to detecting input 805k5, computer system 600 deactivates border control 622a. Additionally, at FIG. 8L, in response to detecting input 805k4, computer system 600 activates (e.g., turns “on”) automatic flashlight control 620a. At FIG. 8L, as part of computer system 600 deactivating sound control 616a, label control 616b, haptics control 616d, and border control 622a, computer system 600 changes the appearance of each of sound control 616a, label control 616b, haptics control 616d, and border control 622a (e.g., each of sound control 616a, label control 616b, haptics control 616d, and border control 622a are not filled with hatching). At FIG. 8L, computer system 600 detects input 805l directed to return control 624.

As illustrated in FIG. 8M, in response to detecting input 805l, computer system 600 displays viewer user interface 602 and ceases to display text detection settings user interface 614. As illustrated in FIG. 8M, hand 612 is positioned under text portion 810b. At FIG. 8M, a determination is made that hand 612 is positioned under text portion 810b (and, in some examples, because the location setting of the text detection mode is set to “under”). Because a determination is made that hand 612 is positioned under text portion 810b while the location setting of the text detection mode is set to “under,” computer system 600 identifies text portion 810b as the targeted text. In response to identifying text portion 810b as the targeted text relative to an input (e.g., hand 612, an air gesture, a mouse and/or a stylus), computer system 600 outputs speech output 640. At FIG. 8M, speech output 640 corresponds to a reading (e.g., that is output by computer system 600) of a portion of text portion 810b. Accordingly, at FIG. 8M, speech output 640 includes a reading, “Gracie was a dog who hated to go on walks. Every time her owner would try to take her outside” At FIG. 8M, because sound control 616a is deactivated, computer system 600 does not output audio output 638; because label control 616b is deactivated, computer system 600 does not display current text indicator 626; because haptics control 616d is deactivated, computer system 600 does not output haptic output 636; and because border control 622a is deactivated, computer system 600 does not display border indicator 634 around text portion 810b.

As illustrated in FIG. 8M, computer system 600 displays flashlight control 604b within viewer user interface 602. At FIG. 8M, a determination is made that automatic flash control 620a is active. Because a determination is made that automatic flash control 620a is active, computer system 600 displays flashlight control 604b within viewer user interface 602. At FIG. 8M, computer system 600 displays flashlight control 604b with an appearance (e.g., flashlight control 604b is filled in with hatching) that indicates that a light source (e.g., a light source that is in communication with computer system 600) is off.

At FIG. 8N, a determination is made that the brightness of the environment that surrounds computer system 600 is below a brightness threshold (e.g., below 10-20 lux) (e.g., as indicated by the hatching over live feed 606 in FIG. 8N). As illustrated in FIG. 8N, because a determination is made that the brightness of the environment is below the brightness threshold, computer system 600 displays light required notification 804 (e.g., “More light required”) within viewer user interface 602. Light required notification 804 is an indication that additional light is requested. In some examples, computer system 600 displays light required notification 804 so that targeted text can be identified relative to an input (e.g., hand 612, an air gesture, a mouse, and/or a stylus) in poorly lit environments.

At FIG. 8N, though the brightness in the environment is below the brightness threshold, text portion 810b continues to be the targeted text. Accordingly, at FIG. 8N, computer system 600 continues to provide speech output 640 that corresponds to text portion 810b. At FIG. 8N, speech output 640 is a continuation of the reading of text portion 810b from FIG. 8M. Accordingly, at FIG. 8N, speech output 640, includes a portion of text portion 810b (e.g., “She would resist with all her might”) that directly follows the portion of text portion 810b computer system 600 output at FIG. 8M.

At FIG. 8O, because a determination was made that the brightness in the environment is below the brightness threshold at FIG. 8N, computer system 600 automatically (e.g., without intervening user input) powers on the light source. FIG. 8O includes timer schematic 808. Timer schematic 808 is a visual aid (e.g., is not displayed by computer system 600) that corresponds to a countdown from ten seconds to zero seconds. The light source remains powered on for a period of ten seconds before computer system 600 powers off the light source. In some examples, a timer is displayed via computer system 600.

At FIG. 8O, in response to computer system 600 powering on the light source, computer system 600 ceases to display light required notification 804 within viewer user interface 602, and computer system 600 displays flashlight notification indication 806. Flashlight notification indication 806 indicates that the light source transitions from a powered off state to a powered-on state. As illustrated in FIG. 8O, in response to computer system 600 powering on the light source, computer system 600 changes the appearance of flashlight control 604b (e.g., in comparison to the appearance of flashlight control 604b at FIG. 8N). In some examples, computer system 600 displays light required notification 804 for a period of time (e.g., 1-10 seconds) while the light source is active. In some examples, while automatic flash control 620a is active, computer system 600 does not activate the light source because a determination is made that the brightness of the environment is above the threshold.

At FIG. 8P, as indicated by timer schematic 808, nine seconds have elapsed since computer system 600 initially powered on the light source (e.g., as indicated by timer schematic 808 being at 00:01) (and, in some examples, without a determination being made that the brightness in the environment is below the brightness threshold). As discussed above, computer system 600 automatically powers off the light source after the light source has been active for a period of 10 seconds. At FIG. 8P, because the light source has not been active for ten seconds (and, in some examples, without a determination being made that the brightness in the environment is below the brightness threshold), the light source remains active. In some examples, the period is longer and/or shorter than 10 seconds.

At FIG. 8Q, as indicated by timer schematic 808, ten seconds have elapsed since computer system 600 initially powered on the light source (e.g., as indicated by timer schematic 808 being at 00:00). At FIG. 8Q, a determination is made that ten seconds have elapsed since computer system 600 initially powered on the light source (and, in some examples, without a determination being made that the brightness in the environment is below the brightness threshold). At FIG. 6Q, because a determination is made that ten seconds have elapsed since computer system 600 initially powered on the light source, computer system 600 powers off the light source (and, in some examples, without a determination being made that the brightness in the environment is below the brightness threshold). At FIG. 8Q, as part of powering off the light source, computer system 600 updates the appearance of flashlight control 604b (e.g., in comparison to the appearance of flashlight control 604b at FIG. 8P) to indicate that the light source is powered off. In some examples, computer system 600 displays an indication (e.g., a text and/or symbols) that the light source is powered off. At FIG. 8Q, computer system 600 detects input 805q directed to flashlight control 604b.

At FIG. 8R, in response to detecting input 805q, computer system 600 activates flashlight control 604b in response to detecting an input that corresponds to selection of flashlight control 604b (and/or, in some examples, because a determination is made that the brightness in an environment is below a brightness threshold). As illustrated in FIG. 8R, as part of activating the light source, computer system 600 displays flashlight notification indication 806 within viewer user interface 602. Further, at FIG. 8R, as part of activating the light source, computer system 600 changes the appearance of flashlight control 604b (e.g., in comparison to the appearance of flashlight control 604b at FIG. 8Q). FIG. 8R includes timer schematic 808 to illustrate that after computer system 600 powers on the light source in response to detecting an input, the ten second timer for the light source is initiated. As discussed above, after the light source is active for 10 seconds (and, in some examples, without a determination being made that the brightness in the environment is below the brightness threshold), computer system 600 automatically (e.g., without intervening user input) powers off the light source. In some examples, while the light source is active and irrespective of whether the light source has been active for more or less than a predetermined period of time, computer system 600 deactivates the light source when a determination is made that the environment has gone from having an amount of brightness below the threshold to having an amount above the threshold (e.g., without consideration of the light provided in the environment by the light source). In some examples, after deactivating the light source, computer system 600 automatically activates the light source when a determination is made that the environment has below the threshold level of brightness and does not automatically activate the light source when a determination is made that the environment has above the threshold level of brightness. In some examples, after deactivating the light source, computer system 600 activates the light source in response to an input being directed to flashlight control 604b, irrespective of the current brightness detected in the environment. In some examples, after navigating to a different application and/or restarting computer system 600, computer system 600 displays flashlight control 604b in the visual state that flashlight control 604b was in before computer system 600 navigated to the different application and/or restarted.

FIG. 9 is a flow diagram illustrating a method (e.g., method 900) for identifying targeted text in accordance with some examples. Some operations in method 900 are, optionally, combined, the orders of some operations are, optionally, changed, and some operations are, optionally, omitted.

As described below, method 900 provides an intuitive way for identifying targeted text. Method 900 reduces the cognitive burden on a user for identifying targeted text, thereby creating a more efficient human-machine interface. For battery-operated computing devices, enabling a user to identify targeted text faster and more efficiently conserves power and increases the time between battery charges.

In some examples, method 900 is performed at a computer system (e.g., 600) that is in communication with one or more output devices (e.g., a display generation component (e.g., a display screen and/or a touch-sensitive display), a speaker, eccentric rotating mass actuator, and/or a gyroscope). In some examples, the computer system (e.g., 600) is a watch, a phone, a tablet, a processor, a head-mounted display (HMD) device, and/or a personal computing device. In some examples, the computer system is in communication with one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button). In some examples, the computer system is in communication with a display generation component (e.g., a display screen and/or touch-sensitive display).

At 902, while detecting (e.g., capturing, obtaining, and/or acquiring) image data (e.g., previously captured image data and/or live image data from a field of view of one or more cameras that are in communication (e.g., wired communication and/or wireless communication (e.g., Bluetooth, Wi-Fi, and/or Ultra-Wideband) with the computer system)) that includes text, the computer system detects an object (e.g., 612) (e.g., an input object, an object used to provide an input, a body part of a user (e.g., head, finger, toc, and/or arm), an object that is pointing at a respective location and/or at a location that corresponding the respective location, a laser pointer, another type of pointer, and/or a gaze input) relative to the text (e.g., the object is above, below, over, under and/or to the side of the text). In some examples, the object is detected in the image data.

At 904, in response to detecting the object (e.g., 612) relative to text and in accordance with (at 906) a determination that that the object (e.g., 612) is in a first position relative to the text (e.g., below the text, above the text, under and/or on top of the text) and the computer system (e.g., 600) (e.g., as described above in relation to method 700) is in a first state (e.g., as described in relation to FIGS. 6A-6T and FIGS. 8A-8R) (e.g., as described above in relation to method 700), the computer system provides, via the one or more output devices, an output (e.g., 636, 638, and/or 640) (e.g., a haptic, visual, and/or audio output) corresponding to the text (e.g., 610a-610e and/or 810a-810c) (e.g., as described above in relation to 700).

At 904, in response to detecting the object relative to text and in accordance with a determination (at 908) that the object is in a second position (e.g., different and/or distinct from the first position) relative to the text (e.g., 610a-610e and/or 810a-810c) (e.g., below the text, above the text, and/or on top of the text) and the computer system is in the first state (e.g., as described above in relation to 700) (e.g., as described in relation to FIGS. 6A-6T and FIGS. 8A-8M), the computer system forgoes providing, via the one or more output devices, the output (e.g., 636, 638, and/or 640) corresponding to the text.

At 904, in response to detecting the object relative to text and in accordance with (at 910) a determination that the object is in the second position relative to the text (e.g., below the text, above the text, or on top of the text) and the computer system (e.g., 600) is in a second state different from the first state (e.g., and the computer system is not in the first state) (e.g., as described in relation to FIGS. 6A-6T and FIGS. 8A-8M), the computer system provides, via the one or more output devices, the output (e.g., 636, 638, and/or 640) corresponding to the text (e.g., 610a-610c and/or 810a-810c). In some examples, while the object is in the first position, the computer system ceases to provide the output in accordance with a determination that the computer system transitions from the first state to the second state. In some examples, the output includes multiple modalities (e.g., a haptic modality, a visual modality, and/or an audio modality). In some examples, when the object is in the second position and the computer system is in the first state, the computer system outputs a respective output. In some examples, the computer system is in the first state and not the second state. In some examples, the computer system is in the second state and not the first state. In some examples, while the computer system provides the output while the object is in the first position relative to the text and the computer system is in the first state, the computer system ceases to provide the output in accordance with a determination that the object moves from the first position to the second position. In some examples, while the computer system provides the output while the object is in the first position relative to the text and the computer system is in the first state, the computer system continues to provide the output in accordance with a determination that the object moves from the first position to the second position. Providing an output that corresponds to the text based on a state of the computer system and the positioning of the object allows the computer system to automatically provide an output that indicates to a user whether the computer system is in the first state or the second state and/or indicates to a user the positioning of the object relative to the text, thereby performing an operation when a set of conditions has been met without requiring further user input and providing improved feedback.

In some examples, the object is a body part (e.g., 612) (e.g., one or more fingers, arms, eyes, toes and/or legs) of a user (e.g., a user of the computer system, the owner of the computer system, a user corresponding to a user account associated with the computer system). Providing an output that corresponds to text in response to detecting a body part of the user relative to the text allows a user to control the output operations of the computer system without requiring that the computer system display a respective user interface, thereby providing the user with one or more control options without cluttering the user interface.

In some examples, in response to detecting the object (e.g., 612) relative to text (e.g., 610a-610c and/or 810a-810c) and in accordance with a determination that the object is in the first position relative to the text (e.g., 610a-610e and/or 810a-810c) (e.g., and not the second position relative to the text) and the computer system (e.g., 600) is in the second state (e.g., and not the first state) (e.g., as indicated by 618a-618c), the computer system forgoes providing the output corresponding to the text (e.g., as described in relation to FIGS. 6A-6T and FIGS. 8A-8M). In some examples, in response to detecting the object relative to text and in accordance with a determination that the object is in the first position relative to the text, the computer system provides a respective output (e.g., a haptic output, a visual output, and/or an audio output) Forgoing providing an output that corresponds to the text based on the positioning of the object allows the user to control the output of the computer system by controlling the positioning of the input, thereby providing the user with one or more control options without cluttering the user interface.

In some examples, in response to detecting the object (e.g., 612) relative to text: in accordance with a determination that the object is in a third position different from the first position and the second position (e.g., and not the first position or the second position) (e.g., the third position is different and/or distinct from the first and second position) (e.g., the third position is removed from the text (e.g., the object is not above or under the text while the object is in the third position)) relative to the text and the computer system (e.g., 600) is in the first state (e.g., as described in relation to 618a-618c) (e.g., 610a-610e and/or 810a-810c), the computer system forgoes providing the output corresponding to the text; and in accordance with a determination that the object is in the third position (e.g., and not the first position or the second position) relative to the text and the computer system is in the second state (e.g., 618a-618c), the computer system forgoes providing the output corresponding to the text. In some examples, the computer system ceases to provide the output corresponding to the text in accordance with a determination that the object moves from the first position or second position to the third position and/or in accordance with a determination that the object is at the third position. In some examples, the computer system continues to provide the output corresponding to the text in accordance with a determination that the object moves from the first or second position to the third position. In some examples, the third position is relative to a respective portion of text. In some examples, the third position is not relative to a respective portion of text. In some examples, the computer system provides a respective output in response to detecting the object relative to the text and in accordance with a determination that the object is in the third position. In some examples, the computer system provides the output corresponding to the text in response to detecting that the object moves from the third position to the first position or second position. Forgoing providing the output corresponding to the text while the input is at the third position allows the user to control the output of the computer system by controlling the positioning of the input, thereby providing the user with one or more control options without cluttering the user interface.

In some examples, in response to detecting the object relative to text: in accordance with a determination that the object is in the first position relative to the text and the computer system (e.g., 600) is in a third state (e.g., as indicated by 606c) (e.g., a text detection setting of the computer system is active or inactive, an object detection setting of the computer system is active or inactive, a person detection setting of the computer system is active or inactive, and/or an inactive camera setting of the computer system is active or inactive) (e.g., that is different and/or distinct from the first state and/or the second state) (e.g., a state where object detection capabilities of the computer system are in an inactive state and/or limited), the computer system forgoes providing the output corresponding to the text; and in accordance with a determination that the object is in the second position relative to the text and the computer system is in the third state, the computer system forgoes providing the output corresponding to the text. In some examples, the computer system provides output corresponding to text while the object is at the first position or the second position in accordance with a determination that the computer system transitions from the third state to a respective state (e.g., a state where the object detection capabilities of the computer system are active and/or not limited). In some examples, the computer system ceases to provide output corresponding to text in accordance with a determination that the computer system transitions from a respective state to the third state. In some examples, the computer system continues to provide output corresponding to text in accordance with a determination that the computer system transitions from a respective state to the third state. Forgoing providing the output corresponding to the text while the input is at the third position allows the user to control the output of the computer system by changing the state of the computer system, thereby providing the user with one or more control options without cluttering the user interface.

In some examples, while the computer system (e.g., 600) is in the third state, the computer system detects a request (e.g., an input similar to 605a) (e.g., a tap input, a swipe input, a voice command, a rotation of a rotatable input mechanism, a selection of a user interface object, and/or a hand air input (air tap and/or air swipe)) to transition the computer system to a respective state (e.g., the respective state is different and/or distinct from the third state) (e.g., the first state, the second state, and/or another state). In some examples, in response to detecting the request to transition the computer system to the respective state, the computer system transitions the computer system from the third state to the respective state. In some examples, the computer system does not detect the object while the computer system is in the third state and/or a respective state. In some examples, the computer system detects the object while the computer system is in the third state and/or a respective state. In some examples, the computer system does not display a digital viewfinder while the computer system is in the third state and/or a respective state. In some examples, the computer system does not provide output corresponding to detected text while the computer system is in the third state and/or a respective state. In some examples, the computer system remains in the respective state until the computer system detects an input corresponding to a request to transition the computer system from the respective state. In some examples, the computer system remains in the respective state while a respective application is operating in the background and/or operating in the foreground of the computer system. In some examples, the computer system continues to be in the respective state, even after the application is exited and/or reopened. Transitioning the computer system from the third state to the respective state in response to detecting the request to transition the computer system to the respective state provides the user with feedback regarding the state of the computer system (e.g., the computer system detected the request), thereby providing improved feedback.

In some examples, detecting the request to transition the computer system (e.g., 600) to the respective state includes detecting an input (e.g., 605a) (e.g., tap input, swipe input, double tap, long press (e.g., press and hold), hand input (e.g., an air tap and/or an air swipe) and/or depression of a rotatable input mechanism) directed to selection of a respective control (e.g., 606c) (e.g., a text detection control, a point and/or gesture and output control, and/or an audio output of text control).

In response to detecting the object (e.g., 612) relative to text: in accordance with a determination that a first set of one or more criteria is satisfied (and, in some examples, the first set of one or more criteria includes a criterion that is satisfied when a determination is made that the object corresponds to a primary user of the computer system, the object is centered within a field of view of one or more cameras of the computer system, the object is within a predetermined distance (e.g., 0.1-15 feet) of the computer system, and/or the object has a particular appearance (e.g., the size, color, and/or configuration)), the computer system displays, via the one or more output devices, an indication (e.g., 634 and/or 630) (e.g., a textual indication and/or a graphical indication) that the object is detected within a field of view of one or more cameras (e.g., one or more cameras that are in communication (e.g., wireless communication and/or wired communication) with the computer system); and in accordance with a determination that the first set of one or more criteria is not satisfied, the computer system forgoes displaying the indication that the object is detected within a field of view of the one or more cameras. In some examples, the computer system displays the indication for a predetermined period of time (e.g., 1-120 seconds). In some examples, the computer system ceases to display the indicator in response to ceasing to detect the object. In some examples, the computer system displays the indication in response to detecting the object. In some examples, the computer system concurrently displays the indication and a respective indication (e.g., the respective indication is different and/or distinct from the indication). Displaying an indication that the object is detected within a field of view of one or more cameras based on whether a first set of one or more criteria is satisfied allows the computer system to automatically indicate to a user the positioning of the user's input relative to the one or more cameras, thereby performing an operation when a set of conditions has been met without requiring further user input.

In some examples, the computer system (e.g., 600) is in communication (e.g., wireless communication and/or wired communication) with an illumination source (e.g., a light that is integrated into the computer system and/or a light that is external to the computer system) (e.g., as discussed in relation to 8N-8R). In some examples, in accordance with a determination that a second set of one or more criteria (e.g., the brightness within a physical environment (e.g., a physical environment that surrounds the computer system and/or a physical environment that does not surround the computer system) is below a brightness threshold, the brightness within the physical environment is below a brightness threshold for greater than a predetermined amount of time (e.g., 0-120 seconds), and/or the computer system detects an input corresponding to the illumination source) is satisfied, the computer system activates (e.g., turning on the illumination source and/or increasing the brightness of the illumination source) the illumination source (e.g., as discussed above in relation to FIGS. 8M-8R). In some examples, the illumination source is activated (e.g., before, after, and/or while) the computer system provides that output corresponding to the portion of text. In some examples, in accordance with a determination that the second set of one or more criteria is not satisfied, the computer system forgoes activating the illumination source (e.g., as discussed above in relation to FIGS. 8M-8R). In some examples, the computer system deactivates the illumination source after a predetermined period of time (e.g., 1-120 seconds) since the illumination source was activated. In some examples, the computer system deactivates the illumination source in response to detecting an input. Activating the illumination source based on whether a set of one or more criteria is met allows the computer system to automatically control the operation of the illumination source at a point in time where additional light is required by the computer system to perform one or more operations, thereby performing an operation when a set of conditions has been met without requiring further user input.

In some examples, after the illumination source is active for a predetermined amount of time (e.g., 1-360 seconds) and in accordance with a determination that a third set of one or more criteria (the brightness within the environment is greater than a brightness threshold, the brightness in the environment is greater than a brightness threshold for a predetermined period of time, the computer system detects an input corresponding to the illumination source) (e.g., the third set of one or more criteria is different and/or distinct from the second set of one or more criteria) is satisfied with respect to an environment (e.g., the physical environment and/or the environment in the field of view of one or more cameras), the computer system deactivates the illumination source (e.g., as discussed above in relation to FIGS. 8M-8R) (e.g., transition (e.g., automatically (e.g., without intervening user input)) the illumination source from the active state to the inactive state). In some examples, after deactivating the illumination source, the computer system does not activate the illumination source until a respective group of one or more settings is in a respective state. Deactivating the illumination source based on whether a set of one or more criteria is satisfied allows the computer system to automatically deactivate the illumination source at a point in time where additional light in the environment is not required by the computer system and/or the user, thereby performing an operation when a set of conditions has been met without requiring further user input.

In some examples, in accordance with a determination that the computer system is in a fourth state (e.g., an illumination source setting is active based on determining that the computer system is in the fourth state) (e.g., while detecting image data that includes text and/or before, after, and/or while providing output corresponding to the text), the computer system displays, via the one or more output devices, an illumination source control (e.g., 604b). In some examples, in accordance with a determination that the computer system (e.g., 600) is not in the fourth state, the computer system forgoes displaying the illumination source user interface object (e.g., as discussed above in relation to FIGS. 8M-8R). Selectively displaying the illumination source based on the state of the computer system allows the computer system to automatically perform a display operation that indicates the state of the computer system, thereby performing an operation when a set of conditions has been met without requiring further user input and providing improved feedback.

In some examples, while displaying, via the one or more output devices, the illumination source control (e.g., 604b), the computer system detects an input (e.g., 850q) (e.g., a tap input, a double tap input, a swipe input, a rotation of a rotatable input mechanism, a voice command, and/or a hand air input (air swipe and/or air tap)) corresponding to selection of the illumination source control (e.g., as discussed above in relation to FIGS. 8M-8R); In some examples, in response to detecting the input corresponding to selection of the illumination source control: in accordance with a determination that the illumination source was activated (e.g., powered on, emitting light, and/or emitting flashes of light) while the input corresponding to selection of the illumination source control was detected, the computer system deactivates (e.g., power off and/or cease emitting light) the illumination source (e.g., as discussed above in relation to FIGS. 8M-8R); and in accordance with a determination that the illumination source was deactivated while the input corresponding to selection of the illumination source control was detected, the computer system activates the illumination source (e.g., as discussed above in relation to FIGS. 8M-8R). In some examples, after activating the illumination source, the computer system automatically (e.g., without intervening user input) deactivates the illumination source after a predetermined amount of time has elapsed. In some examples, after activating the illumination source, the computer system deactivates the illumination source in response to detecting an input. Changing the operation state of the illumination source based on the operation state of the illumination source at the time the computer system detects the input corresponding to the illumination source control allows the computer system to automatically adjust the brightness (e.g., more bright or less bright) in an environment based on a user's preference, thereby performing an operation when a set of conditions has been met without requiring further user input and providing improved feedback. In some examples, in response to detecting the object (e.g., 612): in accordance with a determination that that the object is in the first position relative to the text (e.g., below the text, above the text, under and/or on top of the text), the computer system (e.g., 600) (e.g., as described above in relation to 700) is in the first state (e.g., as described above in relation to 700), and a text indication setting (e.g., 622a and/or 622b) is active, the computer system displays an indication (e.g., 634) (e.g., a set of contiguous lines or a set of non-contiguous lines) of (e.g., the indication is displayed around the entirety of the text or around a portion of the text) the text (e.g., as part of providing output corresponding to the text or not as part of providing output corresponding to the text) (e.g., as described in relation to FIGS. 8J-8M); in accordance with a determination that that the object is in the first position relative to the text (e.g., below the text, above the text, under and/or on top of the text), the computer system (e.g., as described above in relation to 700) is in the first state (e.g., as described above in relation to 700), and the text indication setting is not active, the computer system forgoes displaying the indication (e.g., 634) of the text (e.g., as described in relation to FIGS. 8J-8M); in accordance with a determination that that the object is in the first position relative to the text (e.g., below the text, above the text, under and/or on top of the text), the computer system (e.g., as described above in relation to 700) is in the second state (e.g., as described above in relation to 700), and the text indication setting is active, the computer system forgoes displaying the indication (e.g., 634) of the text (e.g., as described in relation to FIGS. 8J-8M); and in accordance with a determination that the object is in the second position relative to the text (e.g., below the text, above the text, under and/or on top of the text), the computer system (e.g., as described above in relation to 700) is in the first state (e.g., as described above in relation to 700), and the text indication setting is active, the computer system forgoes displaying the indication (e.g., 634) of the text (e.g., as described in relation to FIGS. 8J-8M). In some examples, in response to detecting the object and in accordance with a determination that the computer system is in a respective state, the text indication setting is active, and the object is in the second position, the computer system displays the indication of the text. In some examples, the computer system displays the indication of the text for a period of time (e.g., 1-120 seconds). In some examples, the computer system ceases to display the indication of the text in response to detecting an input. In some examples, the computer system ceases to display the indication of the text in response to ceasing to detect the text. Selectively displaying the indication of the text based on the state of the computer system, the position of the object, and the state of text indication setting allows the computer system to automatically indicate to the user the state of various settings of the computer system and the positioning of the object relative to the text and allows the user to control the display of the indication by moving the object, thereby performing an operation when a set of conditions has been met without requiring further user input, providing improved feedback, and providing the user with one or more control options without cluttering the user interface.

In some examples, in response to detecting the object (e.g., 612): in accordance with a determination that that the object is in the first position relative to the text (e.g., below the text, above the text, under and/or on top of the text), the computer system (e.g., 600) (e.g., as described above in relation to 700) is in the first state (e.g., as described above in relation to 700), and a display representation setting (e.g., 616b) is active, the computer system displays a representation (e.g., a graphical representation and/or a textual representation) of (e.g., the representation summarizes the text and/or duplicates all of the text or a portion of the text) the text (e.g., as part of providing output corresponding to the text or not as part of providing output corresponding to the text) (e.g., as described in relation to FIGS. 8J-8M); in accordance with a determination that the object is in the first position relative to the text (e.g., below the text, above the text, under and/or on top of the text), the computer system (e.g., as described above in relation to 700) is in the first state (e.g., as described above in relation to 700), and the display representation setting is not active, the computer system forgoes displaying the representation of the text (e.g., as part of providing output corresponding to the text or not as part of providing output corresponding to the text) (e.g., as described in relation to FIGS. 8J-8M); in accordance with a determination that that the object is in the first position relative to the text (e.g., below the text, above the text, under and/or on top of the text), the computer system (e.g., as described above in relation to 700) is in the second state (e.g., as described above in relation to 700), and the display representation setting is active, the computer system forgoes displaying the representation of the text (e.g., as part of providing output corresponding to the text or not as part of providing output corresponding to the text) (e.g., as described in relation to FIGS. 8J-8M); and in accordance with a determination that the object is in the second position relative to the text (e.g., below the text, above the text, under and/or on top of the text), the computer system (e.g., as described above in relation to 700) is in the first state (e.g., as described above in relation to 700), and a display representation setting is active, the computer system forgoes displaying the representation (e.g., a graphical representation and/or a textual representation) of (e.g., the representation summarizes the text and/or duplicates all of the text or a portion of the text) the text (e.g., as part of providing output corresponding to the text or not as part of providing output corresponding to the text) (e.g., as described in relation to FIGS. 8J-8M). In some examples, in response to detecting the object and in accordance with a determination that the computer system is in a respective state, the display representation setting is active, and the object is in the second position, the computer system displays the representation of the text. In some examples, the computer system displays the representation of the text for a period of time (e.g., 1-120 seconds). In some examples, the computer system ceases to display the representation of the text in response to detecting an input. In some examples, the computer system ceases to display the representation of the text in response to ceasing to detect the text. Selectively displaying the representation of the text based on the state of the computer system, the position of the object, and the state of display representation settings allows the computer system to automatically indicate to the user the state of various settings of the computer system and the positioning of the object relative to the text and allows the user to control the display of the representation of the text by moving the object, thereby performing an operation when a set of conditions has been met without requiring further user input, providing improved feedback and providing the user with one or more control options without cluttering the user interface.

In some examples, as part of providing the output (e.g., 640) corresponding to the text: in accordance with a determination that a first setting (e.g., 616a) (e.g., a tone setting, an audible setting, and/or a voice setting) of the computer system (e.g., 600) is active (e.g., turned on, functional, and/or operational) the computer system provides a first audible alert (e.g., a single discrete audible alert or a repeating audible alert) (e.g., as described in relation to FIGS. 8J-8M); and in accordance with a determination that the first setting of the computer system is inactive (e.g., turned off, not functional, and/or inoperable), the computer system forgoes providing a first audible alert (e.g., as described in relation to FIGS. 8J-8M). In some examples, the computer system outputs a respective audible alert based on determining that the first setting is inactive as part of providing the output corresponding to the text. Providing the first audible alert based on the first setting of the computer system being active automatically allows the computer system to indicate to the user the state of at least one set of the computer system and provides the user with a combination of auditory and visual feedback regarding in response to detecting the object, thereby performing an operation when a set of conditions has been met without requiring further user input and providing improved feedback.

In some examples, in response to detecting the object (e.g., 612): in accordance with a determination that that the object is in the first position relative to the text (e.g., below the text, above the text, under and/or on top of the text), the computer system (e.g., 600) (e.g., as described above in relation to 700) is in the first state (e.g., as described above in relation to 700), and an audible alert setting is active (e.g., 616a), the computer system provides a second audible alert (e.g., a single discrete audible alert or a repeating audible alert) (e.g., as described in relation to FIGS. 8J-8M); in accordance with a determination that that the object is in the first position relative to the text (e.g., below the text, above the text, under and/or on top of the text), the computer system (e.g., as described above in relation to 700) is in the first state (e.g., as described above in relation to 700), and the audible alert setting is not active, the computer system forgoes providing the second audible alert (e.g., as described in relation to FIGS. 8J-8M); in accordance with a determination that the object is in the first position relative to the text (e.g., below the text, above the text, under and/or on top of the text), the computer system (e.g., as described above in relation to 700) is in the second state (e.g., as described above in relation to 700), and the audible alert setting is active, the computer system forgoes providing the second audible alert (e.g., as described in relation to FIGS. 8J-8M); and in accordance with a determination that that the object is in the second position relative to the text (e.g., below the text, above the text, under and/or on top of the text), computer system (e.g., as described above in relation to 700) is in the first state (e.g., as described above in relation to 700), and the audible alert setting is active, the computer system forgoes providing the second audible alert (e.g., as described in relation to FIGS. 8J-8M). In some examples, in accordance with a determination that that the object is in the second position relative to the text (e.g., below the text, above the text, under and/or on top of the text), the computer system (e.g., as described above in relation to 700) is in the second state (e.g., as described above in relation to 700), and the audible alert setting is active, the computer system provides the second audible alert. Selectively providing the second audible alert based on the state of the computer system, the position of the object, and the state of the audible alert setting allows the computer system to automatically indicate to the user the state of various settings of the computer system and the positioning of the object relative to the text and allows the user to control the output of the second audible alert by moving the object, thereby performing an operation when a set of conditions has been met without requiring further user input, providing improved feedback and providing the user with one or more control options without cluttering the user interface.

In some examples, as part of providing the output that corresponds to the text, in accordance with a determination that a second setting (e.g., 616d) (e.g., a haptic setting, a tone setting, a discrete haptic setting, and/or a continuous haptic setting) of the computer system (e.g., 600) is active (e.g., turned on, functional, and/or operational), the computer system provides a first haptic alert (e.g., as described in relation to FIGS. 8J-8M); and in accordance with a determination that the second setting of the computer system is inactive (e.g., turned off, not functional, and/or inoperable), the computer system forgoes providing the first haptic alert (e.g., as described in relation to FIGS. 8J-8M). Providing the first haptic alert while the second setting of the computer system is active automatically allows the computer system to indicate to the user the state of at least one setting of the computer system and provides the user with a combination of auditory and visual feedback in response to detecting the object, thereby providing improved feedback and performing an operation when a set of conditions has been met without requiring further user input.

In some examples, in response to detecting the object: in accordance with a determination that the object is in the first position relative to the text (e.g., below the text, above the text, under and/or on top of the text), the computer system (e.g., 600) (e.g., as described above in relation to method 700) is in the first state (e.g., as described above in relation to method 700), and a haptic output setting (e.g., 616d) is active, providing a second haptic alert (e.g., a single discrete haptic alert or a repeating haptic alert) (e.g., as described in relation to FIGS. 8J-8M). In some examples, in accordance with a determination that the object is in the first position relative to the text (e.g., below the text, above the text, under and/or on top of the text), the computer system (e.g., as described above in relation to method 700) is in the first state (e.g., as described above in relation to method 700), and the haptic output setting is not active, forgoing providing the second haptic alert (e.g., as described in relation to FIGS. 8J-8M). In some examples, in accordance with a determination that the object is in the first position relative to the text (e.g., below the text, above the text, under and/or on top of the text), the computer system (e.g., as described above in relation to method 700) is in the second state (e.g., as described above in relation to method 700), and the haptic output setting is active, forgoing providing the second haptic alert (e.g., as described in relation to FIGS. 8J-8M). In some examples, in accordance with a determination that that the object is in the second position relative to the text (e.g., below the text, above the text, under and/or on top of the text), the computer system (e.g., as described above in relation to method 700) is in the first state (e.g., as described above in relation to method 700), and the haptic output setting is active, forgoing providing the second haptic alert (e.g., as described in relation to FIGS. 8J-8M) (e.g., a single discrete audible alert or a repeating audible alert). In some examples, in accordance with a determination that that the object is in the second position relative to the text (e.g., below the text, above the text, under and/or on top of the text), the computer system (e.g., as described above in relation to method 700) is in the second state (e.g., as described above in relation to method 700), and the haptic output setting is active, the computer system provides the second haptic alert. Selectively providing the second haptic alert based on the state of the computer system, the position of the object, and the state of display representation settings allows the computer system to automatically indicate to the user the state of at least one setting of the computer system and the positioning of the object relative to the text and allows the user to control the output of the second haptic alert by moving the object, thereby performing an operation when a set of conditions has been met without requiring further user input, providing improved feedback and providing the user with one or more control options without cluttering the user interface.

In some examples, the computer system (e.g., 600) is in communication with one or more speakers. In some examples, providing the output corresponding to the text includes causing the one or more speakers to output audio (e.g., a voice (e.g., a voice corresponding to a smart assistant and/or a voice corresponding to a user of the computer system), a discrete tone, a media item (e.g., a song and/or movie), and/or a repeating tone) corresponding to the text (e.g., the output reads the first portion of text, the output summarizes the first portion of text, the output indicates the source of the first portion of text, the output indicates an author of the first portion of text, and/or the output indicates a publication corresponding to the first portion of text). Outputting audio that corresponds to the text allows the computer system to deliver the content of the text to a user in a manner such that the user does not have to rely on a non-dominant sensory of the user to comprehend the text, thereby providing improved feedback.

Note that details of the processes described above with respect to method 900 (e.g., FIG. 9) are also applicable in an analogous manner to other methods described herein. For example, methods 700 and 1000 optionally include one or more of the characteristics of the various methods described above with reference to method 900. For example, the automatic activation and/or deactivation of the light source discussed above with reference to method 900 can be applied to methods 700 and 1000. For brevity, these details are not repeated below.

FIG. 10 is a flow diagram illustrating a method (e.g., method 1000) for managing modes of a computer system in accordance with some examples. Some operations in method 1000 are, optionally, combined, the orders of some operations are, optionally, changed, and some operations are, optionally, omitted.

As described below, method 1000 provides an intuitive way for managing modes of a computer system. Method 1000 reduces the cognitive burden on a user for managing modes of the computer system, thereby creating a more efficient human-machine interface. For battery-operated computing devices, enabling a user to manage modes of the computer system faster and more efficiently conserves power and increases the time between battery charges.

In some examples, method 1000 is performed at a computer system (e.g., 600) that is in communication with one or more cameras and one or more output devices (e.g., as described above in relation to methods 700 and/or 900). In some examples, the computer system is a watch, a phone, a tablet, a processor, a head-mounted display (HMD) device, and/or a personal computing device. In some examples, the computer system is in communication with one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button). In some examples, the computer system is in communication with a display generation component (e.g., a display screen and/or a touch-sensitive display).

At 1002, the computer system detects, via the one or more output devices, a first input (e.g., 612 in FIG. 6N and/or 605o in FIG. 6O) (e.g., as described above in relation to methods 700 and/or 900) relative to a first portion (610a-610e) of text (e.g., the input is above, below, on top of and/or to the side of the portion of text) in the field of view of the one or more cameras.

At 1004, in response to detecting the first input relative to the portion (610a-610c) of text in the field of view of the one or more cameras, the computer system provides, via the one or more output devices, an output (e.g., 640) corresponding to the first portion (610a-610e) of text (e.g., audio (e.g., the computer system outputs speech corresponding to the text and/or the computer system outputs a respective tone that corresponding the text), visual, and/or haptic output).

At 1006, while providing the output corresponding to the first portion (610a-610c) of text, the computer system detects (e.g., relative to a second portion of text and/or the first portion of text), via the one or more output devices, a second input (e.g., 612 and/or 605o) (e.g., relative to a different portion of text than the portion of text) (e.g., movement of a body part of a user from a first location to a second location, a body part of the user at a location, a gaze, and/or a head movement and/or direction) (e.g., the second input is different and/or distinct from the first input).

At 1008, in response to detecting the second input (e.g., 612 and/or 605o) and in accordance with (at 1010) a determination that a set of one or more lock criteria (e.g., the text is centered within the field of view of the one or more cameras, the computer system detects an input corresponding to selection of the text, a respective application is active on the computer system, the text is within the field of view of the one or more cameras, and/or the text is within a predetermined distance from the computer system) was satisfied before (e.g., immediately before or within a predetermined amount of time before (e.g., 0-360 seconds)) detecting the second input and after (e.g., immediately after or within a predetermined amount of time after (e.g.,0-360 seconds)) detecting the first input, the computer system continues to provide the output (e.g., 640 at FIG. 6O).

At 1008, in response to detecting the second input and in accordance with a determination (at 1012) that the set of one or more lock criteria was not satisfied before (e.g., immediately before or within a predetermined amount of time before (e.g., 0-360 seconds)) detecting the second input (e.g., 612) and after (e.g., immediately after or within a predetermined amount of time after time (e.g.,0-360 seconds)) detecting the first input (e.g., 612), the computer system ceases to provide the output (e.g., as described above in relation to FIGS. 6P-6R). In some examples, the first input and the second input are the same type of input. In some examples, the first input and the second input are different types of inputs. In some examples, the computer system outputs a respective output (e.g., visual, audio, and/or haptic output) corresponding to the second input as part of ceasing to provide the output. In some examples, the first input and the second output are detected via the one or more cameras. In some examples, the first input and the second input correspond to the same user. In some examples, the first input and the second input correspond to different users. In some examples, the second input is detected relative to a respective portion of text that is different than the portion of text that the first input is detected relative to. In some examples, the second input is not detected relative to a respective portion of text. In some examples, the second input is detected relative to the portion of text. In some examples, while the computer system detects (e.g., capturing, obtaining, and/or acquiring) image data (e.g., previously captured image data and/or live image data from a field of view of one or more cameras that are in communication (e.g., wired communication and/or wireless communication (e.g., Bluetooth, Wi-Fi, and/or Ultra-Wideband) with the computer system)) that includes text, the computer system detects an object (e.g., an input object, an object used to provide an input, a body part of a user (e.g., head, finger, toc, and/or arm), an object that is pointing at a respective location and/or at a location corresponding to the respective location, a laser pointer, another type of pointer, and/or a gaze input) at a first location corresponding to a first portion of the text; in response to detecting the object relative to the first portion of text, the computer system provides output corresponding to the first portion of the text; in conjunction with (e.g., after and/or while) providing the output corresponding to the first portion of text, the computer system detects movement of the object from the first location corresponding to the first portion of the text to a second location corresponding to a second portion of text; in response to detecting the object at the second location corresponding to the second portion of the text: in accordance with a determination that the second portion of the text satisfies a set of one or more criteria with respect to the first portion of text, the computer system provides, via the one or more output devices, output corresponding to the second portion of text and in accordance with a determination that the second portion of text does not satisfy the set of one or more criteria with respect to the first portion of text, the computer system forgoes providing the output corresponding to the second portion of text. Depending on whether the set of one or more lock criteria is satisfied, either continuing to provide or ceasing the output allows the computer system to automatically provide the user with feedback about the state of the computer system, thereby performing an operation when a set of conditions has been met without requiring further user input and providing improved auditory feedback to the user.

In some examples, the set of one or more lock criteria includes a criterion that is satisfied when a determination is made that a first particular type of input (e.g., 605n and/or 605p) (e.g., a double tap input, a long press (e.g., tap and hold), a tap input, a swipe input, a rotation of a rotatable input mechanism, a voice command and/or a hand input (e.g., air swipe and/or air tap)) is detected. In some examples, the first particular type of input is detected via one or more input devices (e.g., a physical input mechanism (e.g., a hardware input mechanism, a rotatable input mechanism, a crown, a knob, a dial, a physical slider, and/or a hardware button), a touch-sensitive display, a microphone, and/or a button) and/or via one or more cameras. Having set of one or more lock criteria include a criterion that is satisfied when a determination is made that a first particular type of input is detected allows the user to control based on determining that the set of one or more lock criteria is satisfied using the first particular type of input, thereby reducing the number of inputs needed to perform an operation and performing an operation when a set of conditions has been met without requiring further user input.

In some examples, the first particular type of input (e.g., 605n and/or 605p) is detected via (e.g., on and/or at) one or more surfaces (e.g., a front surface, a side surface, and/or a back surface) (e.g., a touch sensitive display and/or a touch sensitive non-display surface) of the computer system (e.g., 600). In some examples, the first particular type of input is not detected via one or more surfaces of the computer system. Having the first particular type of input be detected via one or more surfaces of the computer system allows the user to control the state of the computer system with inputs directed to surfaces of the computer system instead of inputs directed to other locations, thereby reducing the number of inputs needed to perform an operation, performing an operation when a set of conditions has been met without requiring further user input, and providing controls where the user expects them.

In some examples, the first particular type of input includes a plurality of (e.g., two or more) tap inputs (e.g., 605n and/or 605p) (e.g., the computer system detects the second tap input of the plurality of tap inputs within a predetermined time period (e.g., 0.1 seconds-2 seconds) of detecting the first tap input of the plurality of tap inputs). In some examples, the computer system does not detect the particular type of input in the field of view of the computer system (e.g., field of view of one or more cameras that are in communication with the computer system). Having the first particular type of input include the plurality of tap inputs allows the user to better disambiguate based on determining that the user wants to change the state of the computer system from other inputs, thereby providing additional control options without cluttering the user interface with additional displayed controls (e.g., number of inputs corresponds to the different types of inputs instead of what is displayed) and performing an operation when a set of conditions has been met without requiring further user input.

In some examples, the computer system (e.g., 600) is in communication with a first set of one or more cameras. In some examples, the first particular type of input (e.g., as described above in relation to FIGS. 6N-6R) is detected within the field of view of the first set of one or more cameras (and/or the computer system). In some examples, the computer system does not detect the first particular type of input within the field of view of the first set of one or more cameras. Having the first particular type of input be detected within the field of view of the first set of one or more cameras allows the user to provide input without needing to locate and/or perform an operation directly on a device, thereby providing improved feedback to the user, reducing the number of inputs needed to perform an operation, and providing additional control options without cluttering the user interface with additional displayed controls.

In some examples, the second input is detected relative to a second portion of text (e.g., 610a-610c) (e.g., the first portion of text is different (e.g., different and/or distinct from) the first portion of text) (e.g., the computer system detects the second input above, below, to the side, and/or around the second portion of text). In some examples, in response to detecting the second input (e.g., 612) and in accordance with a determination that the set of one or more lock criteria was not satisfied before detecting the second input and after detecting the first input, the computer system provides, via the one or more output devices, an output (e.g., 640) (e.g., audio, haptic, and/or visual output) corresponding to the second portion of text (e.g., the second portion of text is different (e.g. includes different sentences, characters, different paragraphs and/or different symbols) and/or distinct from the first portion of text) (e.g., and not the first portion of text). In some examples, the computer system provides output corresponding to the second portion of text and the first portion of text in response to detecting the second input. In some examples, the first portion of text is a subset of the second portion of text. In some examples, the second portion of text is a subset of text included in the first portion of text. In some examples, the output corresponding to the second portion of text and the output corresponding to the first portion of text are the same type of output. Providing the output corresponding to the second portion of text when detecting the second input and in accordance with the determination that the set of one or more lock criteria was not satisfied before detecting the second input provides the user with feedback about the state of the computer system and control for how to interact with different portions of text based on different criteria, thereby providing improved auditory feedback to the user and providing improved visual feedback to the user.

In some examples, detecting the second input includes detecting (e.g., via one or more microphones that are in communication with the computer system) a voice command (e.g., 605o) (e.g., a voice command from a primary user (e.g., an owner of the computer system and/or a user who is associated with a user account of the computer system) of the computer system and/or a voice command from a non-primary user of the computer system). In some examples, detecting the second input includes detecting (e.g., via one or more cameras and/or via one or more sensors) that the computer system is moved and/or is moving. Detecting the second input including detecting a voice command provides the user with control of the computer system without needing to detect physical interactions with the computer system, thereby providing improved feedback to the user, reducing the number of inputs needed to perform an operation, and providing additional control options without cluttering the user interface with additional displayed controls.

In some examples, the computer system (e.g., 600) is in communication (e.g., wired communication and/or wireless communication) with a second set of one or more cameras. In some examples, detecting the second input includes detecting the second input within the field of view of the second set of one or more cameras. In some examples, detecting the second input includes detecting the second input within the field of view of the computer system. In some examples, detecting the second input includes detecting the second input within the field of view of a user. Detecting the second input including detecting the second input within the field of view of the second set of one or more cameras allows the user to provide input without needing to locate and/or perform an operation directly on a device, thereby providing improved feedback to the user, reducing the number of inputs needed to perform an operation, and providing additional control options without cluttering the user interface with additional displayed controls.

In some examples, the second input (e.g., 612) is a hand input (e.g., a finger pointing input, a thumbs up input, a clenched first input, an unclenched hand input, and/or a hand swipe input) corresponding to a request to provide output (e.g., 640) (e.g., audio output, visual output, and/or visual output) corresponding to a third portion of text different from the first portion of text and the second portion of text (e.g., the third portion of text is different (e.g., includes different sentences, characters, different paragraphs and/or different symbols) and/or distinct from the first portion of text) (e.g., and not the first portion of text) (e.g., the third portion of text is different and/or distinct from the first portion of text). In some examples, the second input corresponds to a request to provide output corresponding to the first portion of text and the third portion of text. The second input being a hand input corresponding to a request to provide output corresponding to a third portion of text allows for the user to utilize their hand to indicate different portions of text, thereby reducing the number of inputs needed to perform an operation and providing additional control options without cluttering the user interface with additional displayed controls.

In some examples, the computer system (e.g., 600) is in communication with a third set of one or more cameras. In some examples, detecting the second input includes detecting an obstruction (partial obstruction or complete obstruction) (e.g., covers, conceals, blocks out) to a fourth portion of text (e.g., the fourth portion of text is the same or different from the first portion of text) that is in the field of view of the third set of one or more cameras (e.g., as described in relation to FIGS. 6M-6R). Detecting the second input including detecting the obstruction to the fourth portion of text that is in the field of view of the third set of one or more cameras allows the computer system to react to different conditions and continue to provide output that the user expects, thereby providing improved feedback to the user and reducing the number of inputs needed to perform an operation.

In some examples, after continuing to provide the output (e.g., 640) and in accordance with a determination that a first set of one or more criteria is satisfied, wherein the first set of one or more criteria includes a criterion is satisfied when the set of one or more lock criteria continue to be satisfied while providing the output, the computer system continues to provide the output (e.g., 640). In some examples, after continuing to provide the output (e.g., 640) and in accordance with a determination that the first set of one or more criteria is not satisfied, the computer system forgoes continuing providing the output (e.g., 640). In some examples, the first set of one or more criteria includes a criterion is satisfied when the set of one or more lock criteria (e.g., 605n and/or 605p) continue to be satisfied while providing the output. Selectively ceasing providing the output depending on whether the first set of one or more criteria is satisfied provides the user with feedback about the state of the computer system and allows the user to better control what is output, thereby providing improved feedback to the user, providing additional control options without cluttering the user interface with additional displayed controls, and performing an operation when a set of conditions has been met without requiring further user input.

In some examples, the set of one or more lock criteria includes a criterion that is satisfied when a determination that a second particular type of input (e.g., 605n and/or 605p) has not been detected while providing the output (e.g., 640). Selectively ceasing providing the output depending on whether the first set of one or more criteria is satisfied provides the user with feedback about the state of the computer system and allows the user to better control what is output, thereby providing improved feedback to the user, providing additional control options without cluttering the user interface with additional displayed controls, and performing an operation when a set of conditions has been met without requiring further user input.

In some examples, in conjunction with (e.g., after and/or while) providing the output corresponding to the first portion of text, the computer system detects a third input (e.g., 610) relative to a fifth portion (e.g., 610a-610e) of text (e.g., the second location is above, to the side, under, and/or at the fifth portion of text) (e.g., the fifth portion of text is different and/or distinct from the first portion of text). In some examples, in response to detecting the third input relative to the fifth portion of text: in accordance with a determination that the fifth portion of the text satisfies a second set of one or more criteria with respect to the first portion of text (e.g., the fifth portion of text and the second portion of text have a number of similar characters, words, numbers and/or symbols that is greater than a predetermined threshold, the distance between the first portion of text and the fifth portion of text is less than a distance threshold (e.g., 0.1-24 inches), the subject of the first portion of text and the fifth portion of text are the same, and/or the fifth portion of text is a subset of text included in the first portion of text), the computer system provides, via the one or more output devices, output (e.g., 640) corresponding to the fifth portion of text; and in accordance with a determination that the fifth portion of text does not satisfy the second set of one or more criteria with respect to the first portion of text (e.g., the fifth portion of text and the second portion of text have a number of similar characters, words, numbers and/or symbols that is less than a predetermined threshold, the distance between the first portion of text and the fifth portion of text is greater than a distance threshold (e.g., 0.1-24 inches), the subject of the first portion of text and the fifth portion of text are not the same, and/or the fifth portion of text is not a subset of text included in the first portion of text), the computer system forgoes providing the output (e.g., 640) corresponding to the fifth portion of text (e.g., and continuing to providing output corresponding to the first portion of text). In some examples, providing output corresponding to the fifth portion of text includes ceasing to provide the output corresponding to the first portion of text. In some examples, the computer system concurrently provides output corresponding to the fifth portion of text and the first portion of text. In some examples, providing output corresponding to the fifth portion of text includes ceasing to provide output corresponding to the first portion of text.

Note that details of the processes described above with respect to method 1000 (e.g., FIG. 10) are also applicable in an analogous manner to the methods described herein. For example, methods 700 and 900 optionally include one or more of the characteristics of the various methods described above with reference to method 1000. For example, the text lock feature discussed above can be integrated into methods 700 and 900. For brevity, these details are not repeated below.

The foregoing description, for purpose of explanation, has been described with reference to specific examples. However, the illustrative discussions above are not intended to be exhaustive or to limit the invention to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the delivery to users of textual content that is of interest to the user. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to allow the user to indicate which portions of text are of greater interest to the user. Accordingly, use of such personal information data enables users to have calculated control of output that corresponds to targeted text. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of delivering output that corresponds to text owned and/or controlled by a third-party, the present technology can be configured to allow users to select to “opt in” or “opt out” of participation in the collection of personal information data during registration for services or anytime thereafter. In another example, users can select not to provide biometric and/or user body data for targeted text detection processes. In yet another example, users can select to limit the length of time biometric and/or user body data is maintained or entirely prohibit the development of a user profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by detecting inanimate objects based on non-personal information data or a bare minimum amount of personal information, such as the content being requested by the device associated with a user, other non-personal information available to the computer system, or publicly available information.

What is claimed is:

1. A method, comprising:
at a computer system that is in communication with one or more output devices:
while detecting image data that includes text, detecting an object relative to the text; and
in response to detecting the object relative to text:
in accordance with a determination that that the object is in a first position relative to the text and the computer system is in a first state, providing, via the one or more output devices, an output corresponding to the text;
in accordance with a determination that the object is in a second position relative to the text and the computer system is in the first state, forgoing providing, via the one or more output devices, the output corresponding to the text; and
in accordance with a determination that the object is in the second position relative to the text and the computer system is in a second state different from the first state, providing, via the one or more output devices, the output corresponding to the text.

2. The method of claim 1, wherein the object is a body part of a user.

3. The method of claim 1, further comprising:
in response to detecting the object relative to text and in accordance with a determination that the object is in the first position relative to the text and the computer system is in the second state, forgoing providing the output corresponding to the text.

4. The method of claim 1, further comprising:
in response to detecting the object relative to text:
in accordance with a determination that the object is in a third position different from the first position and the second position relative to the text and the computer system is in the first state, forgoing providing the output corresponding to the text; and
in accordance with a determination that the object is in the third position relative to the text and the computer system is in the second state, forgoing providing the output corresponding to the text.

5. The method of claim 1, further comprising:
in response to detecting the object relative to text:
in accordance with a determination that the object is in the first position relative to the text and the computer system is in a third state, forgoing providing the output corresponding to the text; and
in accordance with a determination that the object is in the second position relative to the text and the computer system is in the third state, forgoing providing the output corresponding to the text.

6. The method of claim 5, further comprising:
while the computer system is in the third state, detecting a request to transition the computer system to a respective state; and
in response to detecting the request to transition the computer system to the respective state, transitioning the computer system from the third state to the respective state.

7. The method of claim 6, wherein detecting the request to transition the computer system to the respective state includes detecting an input directed to selection of a respective control.

8. The method of claim 6, further comprising:
in response to detecting the object relative to text:
in accordance with a determination that a first set of one or more criteria is satisfied, displaying, via the one or more output devices, an indication that the object is detected within a field of view of one or more cameras; and
in accordance with a determination that the first set of one or more criteria is not satisfied, forgoing displaying the indication that the object is detected within a field of view of the one or more cameras.

9. The method of claim 1, wherein the computer system is in communication with an illumination source, the method further comprising:
in accordance with a determination that a second set of one or more criteria is satisfied, activating the illumination source; and
in accordance with a determination that the second set of one or more criteria is not satisfied, forgoing activating the illumination source.

10. The method of claim 9, further comprising:
after the illumination source is active for a predetermined amount of time and in accordance with a determination that a third set of one or more criteria is satisfied with respect to an environment, deactivating the illumination source.

11. The method of claim 10, further comprising:
in accordance with a determination that the computer system is in a fourth state, displaying, via the one or more output devices, an illumination source control; and
in accordance with a determination that the computer system is not in the fourth state, forgoing displaying the illumination source control.

12. The method of claim 11, further comprising:
while displaying, via the one or more output devices, the illumination source control, detecting an input corresponding to selection of the illumination source control; and
in response to detecting the input corresponding to selection of the illumination source control:
in accordance with a determination that the illumination source was activated while the input corresponding to selection of the illumination source control was detected, deactivating the illumination source; and
in accordance with a determination that the illumination source was deactivated while the input corresponding to selection of the illumination source control was detected, activate the illumination source.

13. The method of claim 1, further comprising:
in response to detecting the object:
in accordance with a determination that that the object is in the first position relative to the text, the computer system is in the first state, and a text indication setting is active, displaying an indication of the text;
in accordance with a determination that that the object is in the first position relative to the text, the computer system is in the first state, and the text indication setting is not active, forgoing displaying the indication of the text;
in accordance with a determination that that the object is in the first position relative to the text, the computer system is in the second state, and the text indication setting is active, forgoing displaying the indication of the text; and
in accordance with a determination that that the object is in the second position relative to the text, the computer system is in the first state, and the text indication setting is active, forgoing displaying the indication of the text.

14. The method of claim 1, further comprising:
in response to detecting the object:
in accordance with a determination that that the object is in the first position relative to the text, the computer system is in the first state, and a display representation setting is active, displaying a representation of the text;
in accordance with a determination that that the object is in the first position relative to the text, the computer system is in the first state, and the display representation setting is not active, forgoing displaying the representation of the text;
in accordance with a determination that that the object is in the first position relative to the text, the computer system is in the second state, and the display representation setting is active, forgoing displaying the representation of the text; and
in accordance with a determination that that the object is in the second position relative to the text, the computer system is in the first state, and a display representation setting is active, forgoing displaying the representation of the text.

15. The method of claim 1, wherein providing the output corresponding to the text includes:
in accordance with a determination that a first setting of the computer system is active providing a first audible alert; and
in accordance with a determination that the first setting of the computer system is inactive, forgoing providing a first audible alert.

16. The method of claim 1, further comprising:
in response to detecting the object:
in accordance with a determination that that the object is in the first position relative to the text, the computer system is in the first state, and an audible alert setting is active, providing a second audible alert;
in accordance with a determination that that the object is in the first position relative to the text, the computer system is in the first state, and the audible alert setting is not active, forgoing providing the second audible alert;
in accordance with a determination that that the object is in the first position relative to the text, the computer system is in the second state, and the audible alert setting is active, forgoing providing the second audible alert; and
in accordance with a determination that that the object is in the second position relative to the text, computer system is in the first state, and the audible alert setting is active, forgoing providing the second audible alert.

17. The method of claim 1, wherein providing the output corresponding to the text includes:
in accordance with a determination that a second setting of the computer system is active, providing a first haptic alert; and
in accordance with a determination that the second setting of the computer system is inactive, forgoing providing the first haptic alert.

18. The method of claim 1, wherein:
in response to detecting the object:
in accordance with a determination that that the object is in the first position relative to the text, the computer system is in the first state, and a haptic output setting is active, providing a second haptic alert;
in accordance with a determination that that the object is in the first position relative to the text, the computer system is in the first state, and the haptic output setting is not active, forgoing providing the second haptic alert;
in accordance with a determination that that the object is in the first position relative to the text, the computer system is in the second state, and the haptic output setting is active, forgoing providing the second haptic alert; and
in accordance with a determination that that the object is in the second position relative to the text, the computer system is in the first state, and the haptic output setting is active, forgoing providing the second haptic alert.

19. The method of claim 1, wherein the computer system is in communication with one or more speakers, and wherein providing the output corresponding to the text includes causing the one or more speakers to output audio corresponding to the text.

20. A non-transitory computer-readable storage medium storing one or more programs configured to be executed by one or more processors of a computer system that is in communication with one or more output devices, the one or more programs including instructions for:
while detecting image data that includes text, detecting an object relative to the text; and
in response to detecting the object relative to text:
in accordance with a determination that that the object is in a first position relative to the text and the computer system is in a first state, providing, via the one or more output devices, an output corresponding to the text;
in accordance with a determination that the object is in a second position relative to the text and the computer system is in the first state, forgoing providing, via the one or more output devices, the output corresponding to the text; and
in accordance with a determination that the object is in the second position relative to the text and the computer system is in a second state different from the first state, providing, via the one or more output devices, the output corresponding to the text.

21. A computer system that is in communication with one or more output devices, comprising:
one or more processors; and
memory storing one or more programs configured to be executed by the one or more processors, the one or more programs including instructions for:
while detecting image data that includes text, detecting an object relative to the text; and
in response to detecting the object relative to text:
in accordance with a determination that that the object is in a first position relative to the text and the computer system is in a first state, providing, via the one or more output devices, an output corresponding to the text;
in accordance with a determination that the object is in a second position relative to the text and the computer system is in the first state, forgoing providing, via the one or more output devices, the output corresponding to the text; and
in accordance with a determination that the object is in the second position relative to the text and the computer system is in a second state different from the first state, providing, via the one or more output devices, the output corresponding to the text.
